(19) United States
(12) Patent Application Publication
(10) Pub. No.: US 2019/0160979 A1
(43) Pub. Date: May 30, 2019

(54) CONVERTIBLE PASSENGER SEAT FOR A VEHICLE

(71) Applicants: Ze'ev Yuval MARESKY, Efrat, Jerusalem (IL); Rafi Yaacov MARESKY, Jerusalem (IL)

(72) Inventors: Ze'ev Yuval MARESKY, Efrat, Jerusalem (IL); Rafi Yaacov MARESKY, Jerusalem (IL)

(21) Appl. No.: 15/822,665

(22) Filed: Nov. 27, 2017

(51) Int. Cl. B60N 2/26; B60N 2/30

(52) U.S. Cl. CPC B60N 2/26; B60N 2/224; B60N 2/3086

(57) ABSTRACT

A convertible passenger seat for a vehicle including a back seat portion and a bottom seat portion, the bottom seat portion incorporating a baby seat assembly, the baby seat assembly having at least one baby seat support surface and the baby seat assembly being movable from a non-baby seat usable operative orientation, in which a first surface of the bottom seat portion defines a non baby seat surface, to a baby seat usable operative orientation in which at least one second surface of the bottom seat portion, different from the first surface, defines the at least one baby seat support surface.

### FIELD OF THE INVENTION

The present invention relates generally to child protective seat apparatus in vehicles.

### BACKGROUND OF THE INVENTION

Various types of child protective seat apparatus for use in vehicles are known.

### SUMMARY OF THE INVENTION

The present invention seeks to provide improved child protective seat apparatus for use in and with vehicles.

There is thus provided in accordance with a preferred embodiment of the present invention a convertible passenger seat for a vehicle including a back seat portion and a bottom seat portion, the bottom seat portion incorporating a baby seat assembly, the baby seat assembly having at least one baby seat support surface and the baby seat assembly being movable from a non-baby seat usable operative orientation, in which a first surface of the bottom seat portion defines a non baby seat surface, to a baby seat usable operative orientation in which at least one second surface of the bottom seat portion, different from the first surface, defines the at least one baby seat support surface.

In accordance with a preferred embodiment of the present invention the baby seat assembly is movable from the non-baby seat usable operative orientation to the baby seat usable operative orientation by at least rotation. Preferably, the baby seat assembly also includes a controllable rotation locking assembly for preventing undesired rotation of the baby seat assembly from the baby seat usable operative orientation.

Preferably, the baby seat assembly is movable from the non-baby seat usable operative orientation to the baby seat usable operative orientation by rotation about a rotation axis and translation perpendicular to the rotation axis. Additionally, the baby seat assembly also includes a controllable translation braking assembly for preventing undesired translation of the baby seat assembly from the baby seat usable operative orientation and a controllable rotation locking assembly for preventing undesired rotation of the baby seat assembly from the baby seat usable operative orientation. Additionally or alternatively, the convertible passenger seat for a vehicle also includes a common control switch enabling a user to control the operation of both the controllable translation braking assembly and the controllable rotation locking assembly, the baby seat assembly being movable from the non-baby seat usable operative orientation to the baby seat usable operative orientation by rotation about a rotation axis and translation perpendicular to the rotation axis.

In accordance with a preferred embodiment of the present invention the convertible passenger seat for a vehicle also includes an electronically controllable actuator operative to selectably lock the baby seat assembly in the baby seat usable operative orientation.

Preferably, the baby seat assembly also includes axial impact force damping functionality. In accordance with a preferred embodiment of the present invention the baby seat assembly is also movable to a child seat operative orientation, in which the at least one second surface of the bottom seat portion defines at least one child seat support surface.

In accordance with a preferred embodiment of the present invention the baby seat assembly includes a static frame assembly including a pair of generally horizontal fixed rail elements, which are fixed to the bottom seat portion and extend along an axis and a slidable and rotatable frame assembly, which is slidable and rotatable relative to the pair of generally horizontal fixed rail elements. Additionally, the baby seat assembly also includes a controllable rotation locking assembly for preventing undesired rotation of the baby seat assembly from the baby seat usable operative orientation, the controllable rotation locking assembly including a rotation-lockable toothed wheel fixedly associated with the slidable and rotatable frame assembly, such that locking thereof against rotation prevents rotation of the slidable and rotatable frame assembly.

In accordance with a preferred embodiment of the present invention, the baby seat assembly also includes a controllable translation braking assembly for preventing undesired translation of the baby seat assembly from the baby seat usable operative orientation, the controllable translation braking assembly including a toothed track fixedly associated with at least one of the generally horizontal fixed rail elements and a selectable braking sub-assembly fixed to the slidable and rotatable frame assembly and having associated therewith a toothed wheel, which operatively engages the toothed track and controls engagement thereof with the toothed track and thus controls translation of the slidable and rotatable frame assembly along the at least one of the generally horizontal fixed rail elements. Alternatively, the baby seat assembly also includes a controllable translation braking assembly for preventing undesired translation of the baby seat assembly from the baby seat usable operative orientation, the controllable translation braking assembly including a selectable braking sub-assembly fixed to the slidable and rotatable frame assembly and having associated therewith at least one brake pad, which selectably and operatively engages at least one of the pair of generally horizontal fixed rail elements thus controls translation of the slidable and rotatable frame assembly along the at least one of the pair of generally horizontal fixed rail elements.

Preferably, the baby seat assembly is selectably lockable in the baby seat usable operative orientation.

In accordance with a preferred embodiment of the present invention the baby seat assembly includes a static frame assembly including a pair of generally horizontal fixed rail elements, which are fixed to the bottom seat portion and extend along an axis and a rotatable support assembly, which is rotatable relative to the pair of generally horizontal fixed rail elements. Additionally, the baby seat assembly also includes a controllable rotation locking assembly including a rotation-lockable toothed wheel fixedly associated with the static frame assembly, such that locking thereof against rotation prevents rotation of the rotatable support assembly.

In accordance with a preferred embodiment of the present invention the baby seat assembly is also movable to a child seat operative orientation, in which the at least one second surface of the bottom seat portion defines at least one child seat support surface.

Preferably, the baby seat assembly includes at least one extension flap for selectably providing at least one extended child seat support surface. Additionally, the baby seat assembly includes a pair of pivotable extension flaps for selectably providing an extended child back seat portion and an extended child bottom seat portion. Preferably, the at least one extension flap is selectably lockable in at least one of a flap extended operative orientation and a flap non-extended operative orientation.

### BRIEF DESCRIPTION OF THE DRAWINGS

The present invention will be understood more fully from the following detailed description, taken in conjunction with the drawings in which:

FIGS. 1A, 1B, 1C and 1D are simplified pictorial illustrations of a vehicle including a convertible passenger seat constructed and operative in accordance with a preferred embodiment of the present invention, wherein a baby seat is shown in a non-baby seat usable operative orientation, first and second intermediate operative orientations and a baby seat usable operative orientation, respectively;

FIGS. 2A, 2B and 2C are, respectively, a simplified assembled view and simplified partial exploded view illustrations of a convertible passenger seat constructed and operative in accordance with a preferred embodiment of the present invention;

FIGS. 3A, 3B and 3C are, respectively, first and second simplified pictorial illustrations and a simplified sectional illustration of one of two fixed rail elements forming part of the apparatus of FIGS. 2A-2C, FIG. 3C being taken along line 3C-3C in FIG. 3A;

FIGS. 4A, 4B and 4C are, respectively, first and second simplified pictorial illustrations and a simplified sectional illustration of one of two rail riding elements forming part of the apparatus of FIGS. 2A-2C, FIG. 4C being taken along line 4C-4C in FIG. 4B;

FIGS. 5A and 5B are, respectively, a simplified pictorial illustration and a simplified planar illustration of one of two lockable toothed wheels forming part of the apparatus of FIGS. 2A-2C;

FIGS. 6A, 6B and 6C are, respectively, a simplified pictorial illustration, a simplified partial sectional illustration and a simplified partial exploded view illustration of one of two rotation locking assemblies, forming part of the apparatus of FIGS. 2A-2C, FIG. 6B being taken along line 6B-6B in FIG. 6A;

FIGS. 7A, 7B, 7C and 7D are, respectively, first and second simplified pictorial illustrations and first and second simplified side view illustrations of a mounting element forming part of the rotation locking assembly of FIGS. 6A-6C, FIGS. 7C and 7D being taken along respective directions indicated by arrows 7C and 7D in FIG. 7A;

FIGS. 8A, 8B, 8C and 8D are, respectively, first and second simplified pictorial illustrations and first and second simplified side view illustrations of a latch element forming part of the rotation locking assembly of FIGS. 6A-6C, FIGS. 8C and 8D being taken along respective directions indicated by arrows 8C and 8D in FIG. 8A;

FIGS. 9A and 9B are simplified pictorial illustrations which show a rotation locking assembly, such as that illustrated in FIGS. 6A-6C, mounted in operative engagement with a corresponding rail riding element, such as that illustrated in FIGS. 4A-4C, in respective locking and non-locking engagement with a lockable toothed wheel, such as that illustrated in FIGS. 5A and 5B;

FIGS. 10A, 10B and 10C are, respectively, first and second simplified pictorial illustrations and a simplified exploded view illustration of a translation braking assembly, forming part of the apparatus of FIGS. 2A-2C;

FIGS. 11A, 11B, 11C and 11D are, respectively, first and second simplified pictorial illustrations and first and second simplified side view illustrations of a mounting element forming part of the translation braking assembly of FIGS. 10A-10C, FIGS. 11C and 11D being taken along respective directions indicated by arrows 11C and 11D in FIG. 11A;

FIGS. 12A, 12B, 12C and 12D are, respectively, first and second simplified pictorial illustrations and first and second simplified side view illustrations of a latch positioning element forming part of the translation braking assembly of FIGS. 10A-10C, FIGS. 12C and 12D being taken in respective directions indicated by arrows 12C and 12D in FIG. 12A;

FIGS. 13A and 13B show a translation braking assembly, such as that illustrated in FIGS. 10A-10C, mounted in operative engagement with a corresponding rail riding element, such as that illustrated in FIGS. 4A-4C, in respective braking and non-braking engagement with a gear strip of a fixed rail element, such as that illustrated in FIGS. 3A-3C;

FIGS. 14A, 14B, 14C, 14D, 14E and 14F are simplified illustrations of six stages in the operation of the convertible passenger seat of FIGS. 2A-2C;

FIGS. 15A, 15B, 15C and 15D are simplified pictorial illustrations of a vehicle including a convertible passenger seat constructed and operative in accordance with another embodiment of the present invention wherein a baby seat is shown in a non-baby seat usable operative orientation, first and second intermediate operative orientations and a baby seat usable operative orientation, respectively;

FIGS. 16A, 16B and 16C are, respectively, a simplified assembled view and simplified partial exploded view illustrations of a convertible passenger seat constructed and operative in accordance with this embodiment of the present invention;

FIGS. 17A, 17B and 17C are, respectively, first and second simplified pictorial illustrations and a simplified sectional illustration of one of two fixed rail elements forming part of the apparatus of FIGS. 16A-16C, FIG. 17C being taken along line 17C-17C in FIG. 17A;

FIGS. 18A, 18B and 18C are, respectively, first and second simplified pictorial illustrations and a simplified sectional illustration of one of two rail mounting elements forming part of the apparatus of FIGS. 16A-16C, FIG. 18C being taken along line 18C-18C in FIG. 18B;

FIGS. 19A and 19B are, respectively, a simplified pictorial illustration and a simplified planar illustration of one of two lockable toothed wheel elements forming part of the apparatus of FIGS. 16A-16C;

FIGS. 20A, 20B and 20C are, respectively, a simplified pictorial illustration, a simplified sectional illustration and a simplified exploded view illustration of a rotation locking assembly, forming part of the apparatus of FIGS. 16A-16C, FIG. 20B being taken along line 20B-20B in FIG. 20A;

FIGS. 21A, 21B, 21C and 21D are, respectively, first and second simplified pictorial illustrations and first and second simplified side view illustrations of mounting element forming part of the rotation locking assembly of FIGS. 20A-20C, FIGS. 21C and 21D being taken along respective directions indicated by arrows 21C and 21D in FIG. 21A;

FIGS. 22A, 22B, 22C and 22D are, respectively, first and second simplified pictorial illustrations and first and second simplified side view illustrations of a slidable latch element forming part of the rotation locking assembly of FIGS. 20A-20C, FIGS. 22C and 22D being taken along respective directions indicated by arrows 22C and 22D in FIG. 22A;

FIGS. 23A and 23B are simplified pictorial illustrations which show a rotation locking assembly, such as that illustrated in FIGS. 20A-20C mounted in operative engagement with a corresponding rail riding element, such as that illustrated in FIGS. 18A-18C, in respective locking and non-locking engagement with a lockable toothed wheel, such as that illustrated in FIGS. 19A and 19B;

FIGS. 24A, 24B, 24C, 24D, 24E and 24F are simplified illustrations of six stages in the operation of the convertible passenger seat of FIGS. 16A-16C;

FIGS. 25A, 25B, 25C and 25D are simplified pictorial illustrations of a vehicle including a convertible passenger seat constructed and operative in accordance with yet another embodiment of the present invention wherein a baby seat is shown in a non-baby seat usable operative orientation, first and second intermediate operative orientations and a baby seat usable operative orientation, respectively;

FIGS. 26A, 26B and 26C are, respectively, a simplified assembled view and simplified partial exploded view illustrations of a convertible passenger seat constructed and operative in accordance with this embodiment of the present invention;

FIGS. 27A, 27B and 27C are, respectively, first and second simplified pictorial illustrations and a simplified sectional illustration of one of two fixed rail elements forming part of the apparatus of FIGS. 26A-26C, FIG. 27C being taken along line 27C-27C in FIG. 27A;

FIGS. 28A, 28B and 28C are, respectively, first and second simplified pictorial illustrations and a simplified sectional illustration of one of two rail riding elements forming part of the apparatus of FIGS. 26A-26C, FIG. 28C being taken along line 28C-28C in FIG. 26B;

FIGS. 29A and 29B are, respectively, a simplified pictorial illustration and a simplified planar illustration of one of two lockable toothed wheels forming part of the apparatus of FIGS. 26A-26C;

FIGS. 30A, 30B and 30C are, respectively, a first and second simplified pictorial illustration and a simplified exploded view illustration of one of two rotation locking assemblies, forming part of the apparatus of FIGS. 26A-26C;

FIGS. 31A, 31B, 31C and 31D are, respectively, first and second simplified pictorial illustrations and first and second simplified side view illustrations of a mounting element forming part of the rotation locking assembly of FIGS. 30A-30C, FIGS. 31C and 31D being taken along respective directions indicated by arrows 31C and 31D in FIG. 31A;

FIGS. 32A, 32B, 32C and 32D are, respectively, first and second simplified pictorial illustrations and first and second simplified side view illustrations of a latch element forming part of the rotation locking assembly of FIGS. 30A-30C, FIGS. 32C and 32D being taken along respective directions indicated by arrows 32C and 32D in FIG. 32A;

FIGS. 33A and 33B are simplified pictorial illustrations showing a rotation locking assembly, such as that illustrated in FIGS. 30A-30C, mounted in operative engagement with a corresponding rail riding element, such as that illustrated in FIGS. 28A-28C, in respective locking and non-locking engagement with a lockable toothed wheel, such as that illustrated in FIGS. 29A and 29B;

FIGS. 34A, 34B and 34C are, respectively, a pictorial and partially cut away pictorial illustration and a simplified exploded view illustration of a translation braking assembly, forming part of the apparatus of FIGS. 26A-26C;

FIGS. 35A, 35B, 35C and 35D are, respectively, first and second simplified pictorial illustrations, a simplified pictorial sectional illustration and a simplified planar top view illustration of a brake pad element forming part of the translation braking assembly of FIGS. 34A-34C, FIG. 35C being taken along line 35C-35C in FIG. 35A;

FIG. 36 is a simplified pictorial illustration of a housing element and set screws forming part of the translation braking assembly of FIGS. 34A-34C;

FIG. 37 is a simplified planar illustration of a screw rotating element forming part of the translation braking assembly of FIGS. 34A-34C;

FIGS. 38A and 38B are simplified partially cut away side view illustrations of the apparatus shown in FIG. 34B in respective braking and non-braking engagement with a fixed rail element such as that illustrated in FIGS. 27A-27C;

FIGS. 39A, 39B, 39C, 39D, 39E, 39F and 39G are simplified illustrations of seven typical stages in the operation of the convertible passenger seat of FIGS. 26A-26C;

FIGS. 40A, 40B and 40C are simplified pictorial illustrations of a vehicle including a convertible passenger seat constructed and operative in accordance with another preferred embodiment of the present invention having pivotable extension flaps, wherein a baby seat is shown in a non-baby seat usable operative orientation, a baby seat usable operative orientation with extension flaps not extended and a baby seat usable operative orientation with extension flaps extended, respectively;

FIG. 41 is a simplified partial exploded view illustration of a rotatable cushion assembly having pivotable extension flaps, forming part of the convertible passenger seat of FIGS. 40A-40C;

FIGS. 42A and 42B are simplified partial pictorial illustrations of the rotatable cushion assembly having pivotable extension flaps of FIG. 41, forming part of the convertible passenger seat of FIGS. 40A-40C, in respective flap non-extended and flap extended operative orientations; and

FIGS. 43A and 43B are simplified sectional illustrations taken along lines 43A-43A and 43B-43B in respective FIGS. 42A & 42B.

### DETAILED DESCRIPTION OF PREFERRED EMBODIMENTS

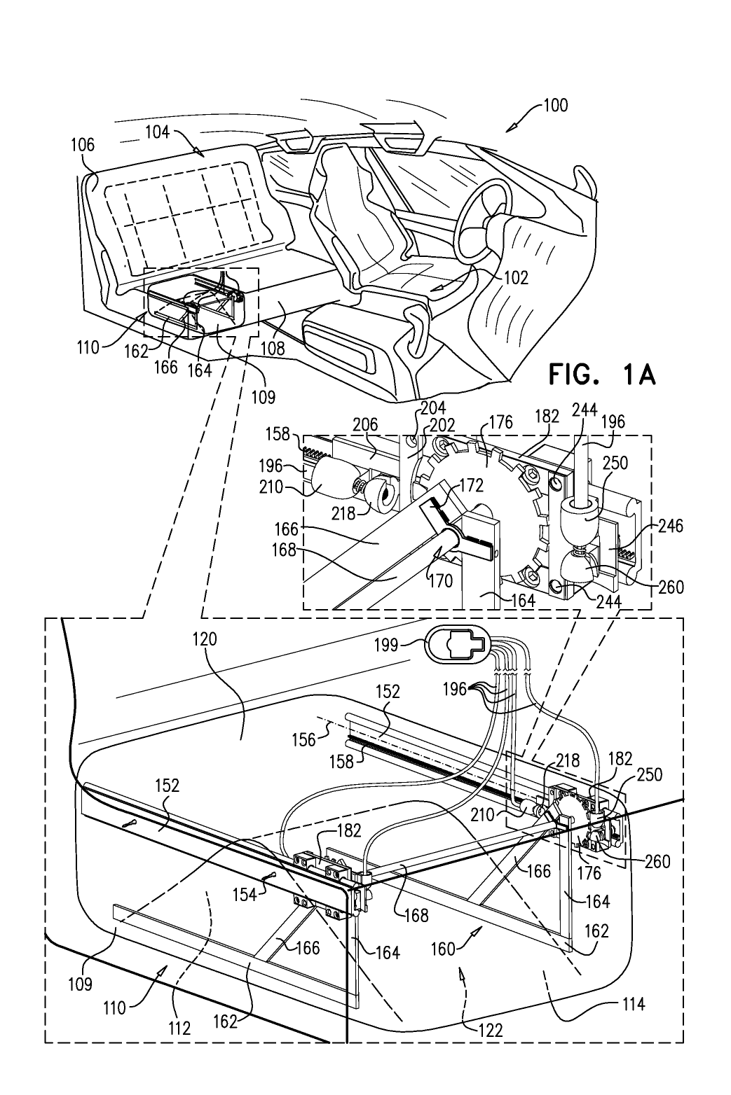

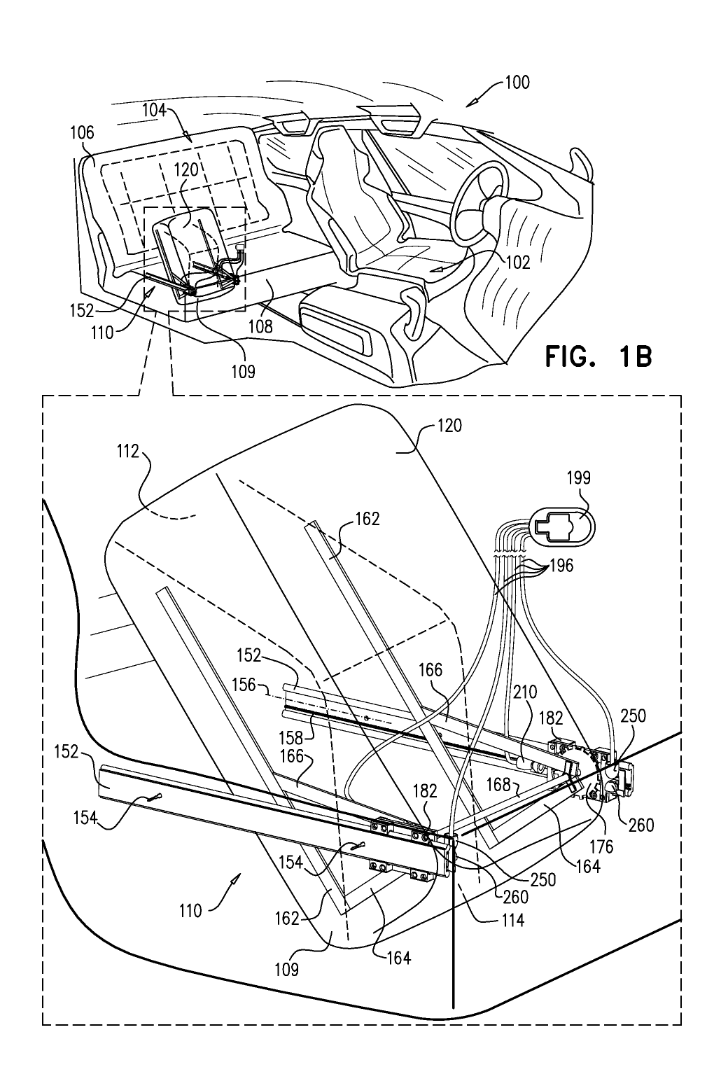

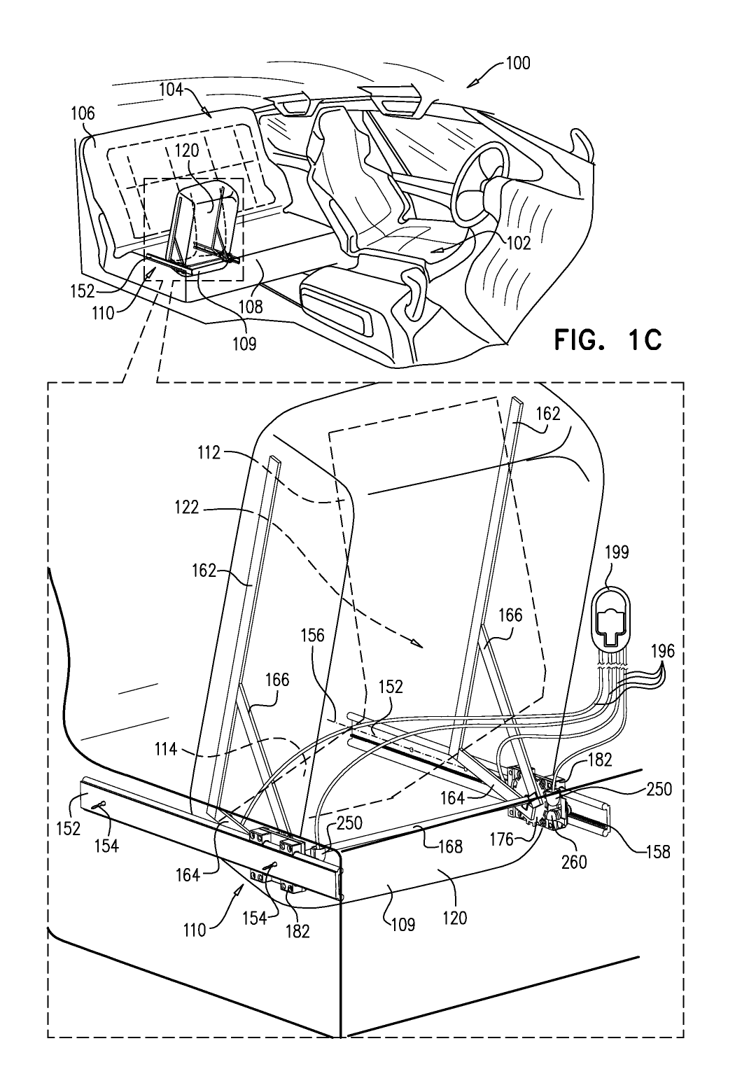

Reference is now made to FIGS. 1A, 1B, 1C and 1D, which are simplified pictorial illustrations of a vehicle including a convertible passenger seat constructed and operative in accordance with a preferred embodiment of the present invention wherein a baby seat is shown in a non-baby seat usable operative orientation, first and second intermediate operative orientations and a baby seat usable operative orientation, respectively. It is appreciated that although various embodiments of the invention are described hereinbelow with respect to an automobile, these embodiments are applicable to other types of vehicles, such as buses, trains and airplanes, as well. It is also appreciated that although various embodiments of the invention are described hereinbelow in either rearward-facing or forward-facing baby seat orientations, each of the embodiments can be realized in either rearward-facing or forward-facing baby seat orientations.

As seen in FIGS. 1A-1D, there is provided a vehicle 100, such as a passenger car, having passenger seats, including at least one front seat 102 and at least one back seat 104. In the illustrated embodiment, at least one back seat 104 is configured as a convertible passenger seat including a back seat portion 106 and a bottom seat portion 108 having a rotatable cushion 109.

In accordance with a preferred embodiment of the present invention, the bottom seat portion 108 incorporates a baby seat assembly 110, wherein rotatable cushion 109 defines a baby support surface, preferably including a baby back seat portion 112 and a baby bottom seat portion 114. In accordance with a preferred embodiment of the present invention, the baby seat assembly 110 is movable from a non-baby seat usable mode, shown in FIG. 1A, in which a first surface 120 of rotatable cushion 109 of the baby seat assembly defines a non-baby seat surface upon which an adult passenger may sit, to a baby seat usable mode, shown in FIG. 1D, in which at least one second surface 122 of the rotatable cushion 109, different from the first surface 120, defines a baby support surface, preferably including baby back seat portion 112 and baby bottom seat portion 114. It is appreciated that, alternatively, the convertible passenger seat may be incorporated into a front seat of a vehicle.

FIGS. 1B and 1C show intermediate stages in a transformation of the convertible passenger seat from the non-baby seat usable operative orientation shown in FIG. 1A to the baby seat usable operative orientation shown in FIG. 1D.

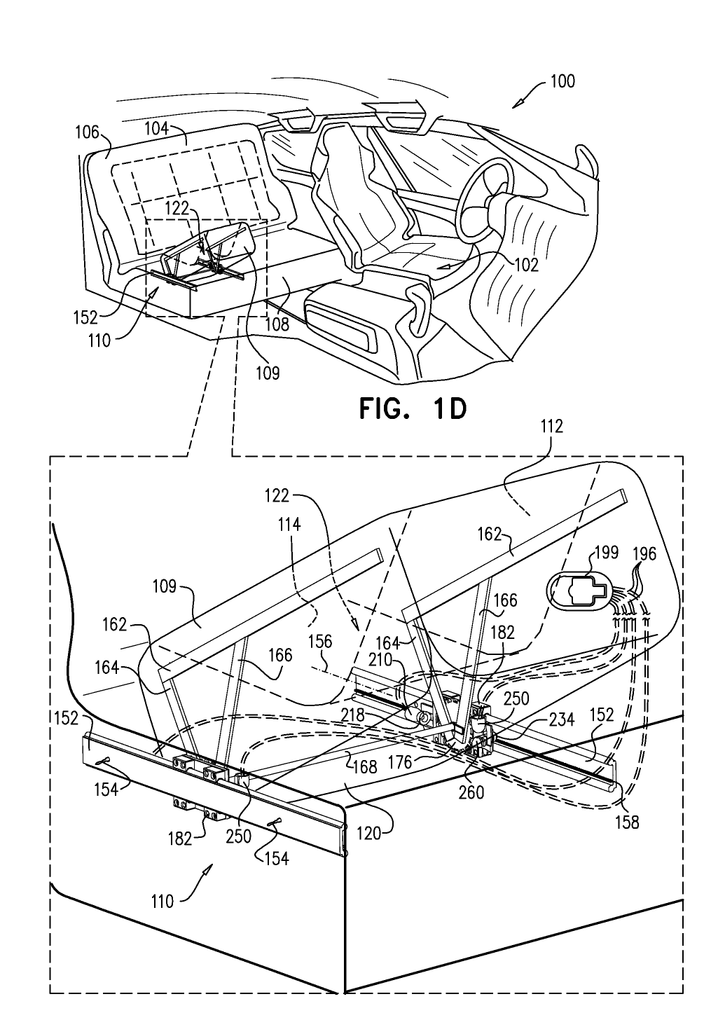

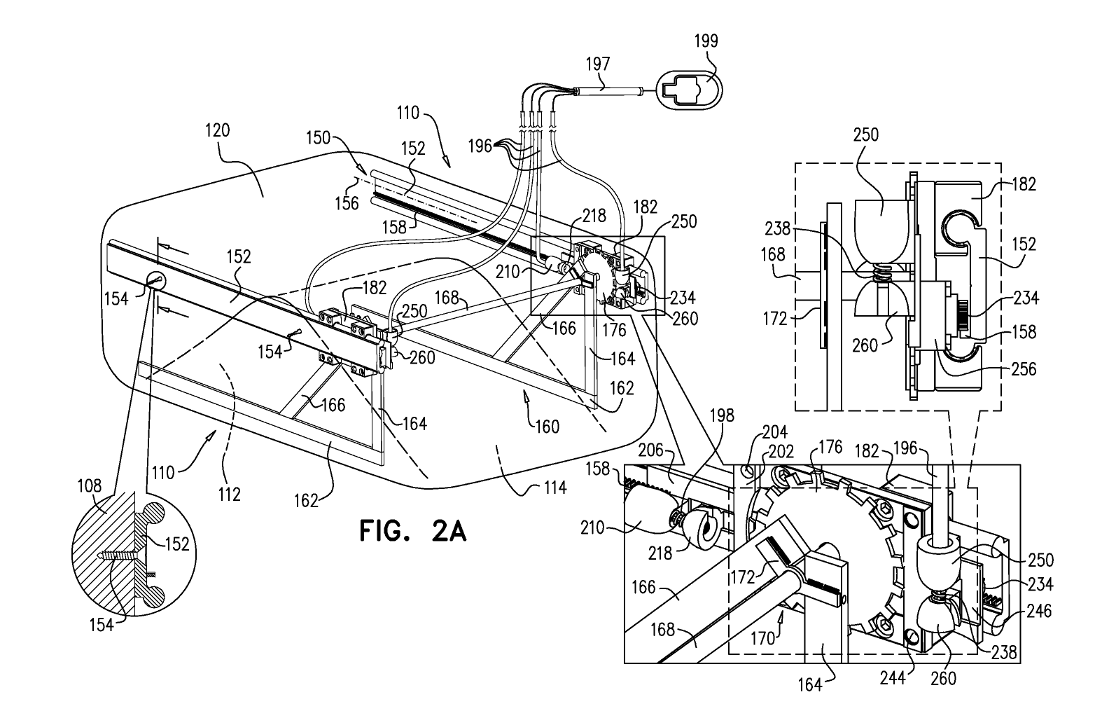

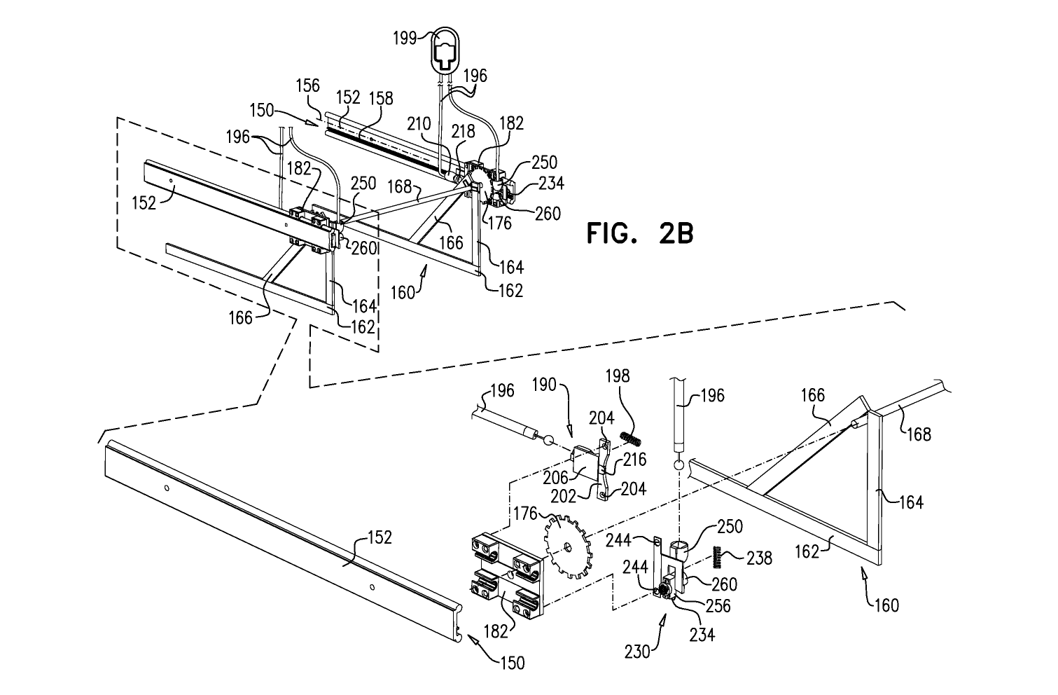

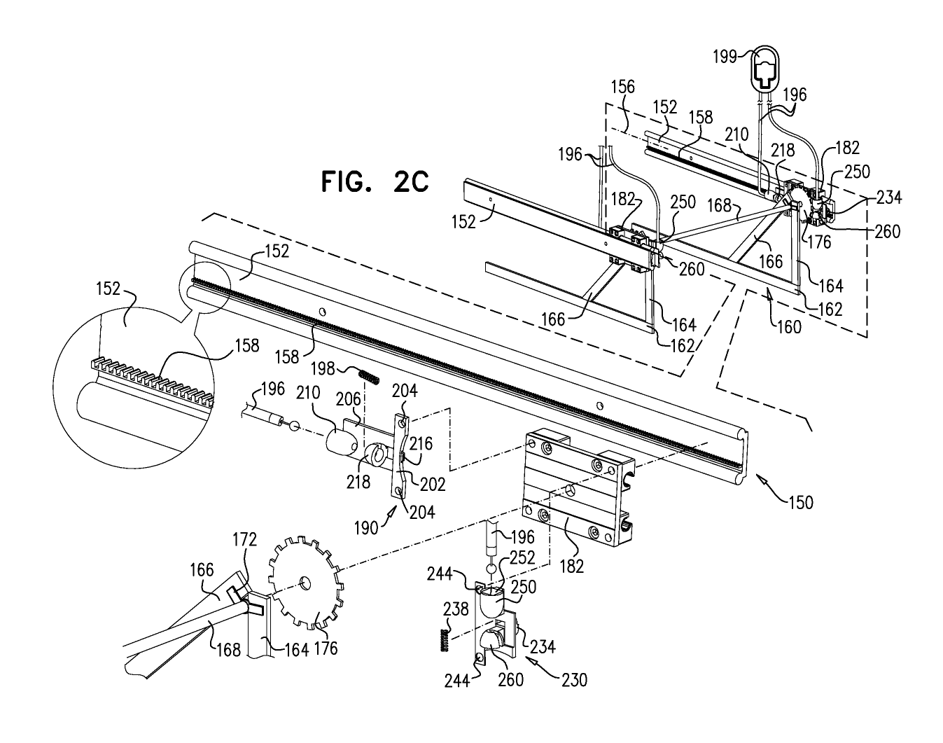

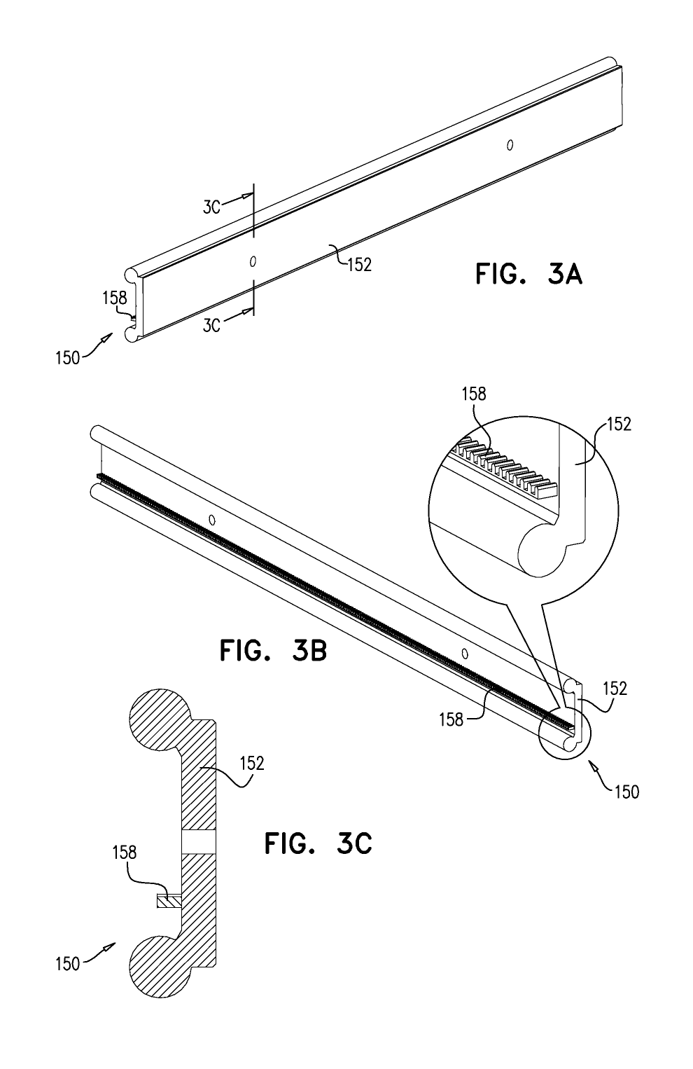

Reference is now made to FIGS. 2A, 2B and 2C, which are, respectively, a simplified assembled view and simplified exploded view illustrations of two sides of the baby seat assembly 110. Reference is also made to FIGS. 3A, 3B and 3C, which are, respectively, first and second simplified pictorial illustrations and a simplified sectional illustration of one of two fixed rail elements forming part of the apparatus of FIGS. 2A-2C.

As seen in FIGS. 2A-2C, the baby seat assembly 110 preferably includes a static frame assembly 150 including a pair of generally horizontal fixed rail elements 152, which are fixed to bottom seat portion 108 as by screws 154 and extend along an axis 156. Generally horizontal fixed rail elements 152 are preferably commercially available rail elements, such as a model IGUS Drylin WS10-40 commercially available from Igus Inc. of Providence, R.I., USA. A toothed track 158 is preferably fixed to or integrally formed with horizontal fixed rail elements 152, as seen particularly in FIG. 2C and FIGS. 3A-3C.

Baby seat assembly 110 also comprises a slidable and rotatable frame assembly 160, which is slidable and rotatable relative to fixed rail elements 152. Slidable and rotatable frame assembly 160 preferably comprises a pair of elongate base elements 162. An upstanding base element 164 and a diagonal base element 166 are fixedly attached to a forward end of each of elongate base element 162 and extend generally coplanar therewith. Preferably, an axle 168 extends perpendicularly to the planes of elongate base elements 162 of rotatable frame assemblies 160 and is fixedly joined to upstanding base element 164 and diagonal base element 166 at a junction 170 thereof, as by an axle mounting element 172.

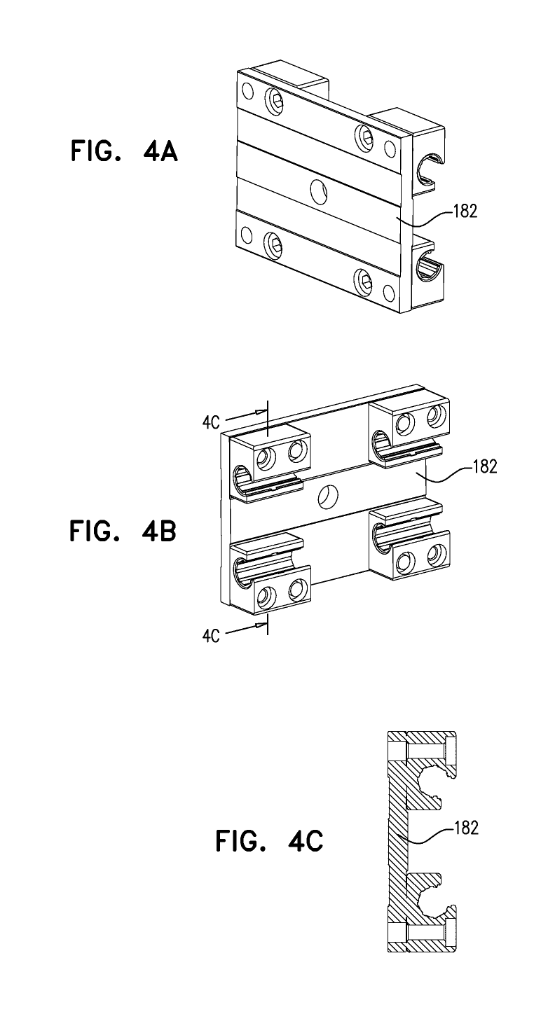

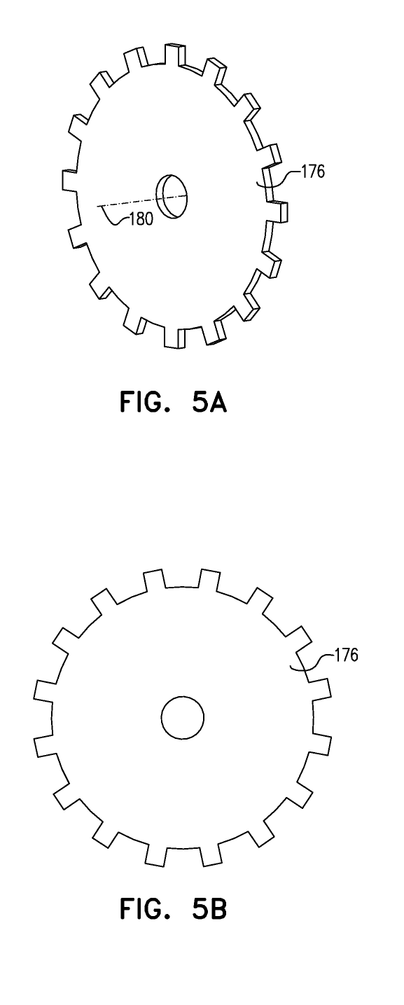

Reference is now additionally made to FIGS. 4A, 4B and 4C, which are, respectively, first and second simplified pictorial illustrations and a simplified sectional illustration of one of two rail riding elements forming part of the apparatus of FIGS. 2A-2C. Reference is also made to FIGS. 5A and 5B, which are, respectively, a simplified pictorial illustration and a simplified planar illustration of one of two lockable toothed wheels forming part of the apparatus of FIGS. 2A-2C.

Fixed to axle 168, at adjacent opposite ends thereof, are a pair of lockable toothed wheels 176, illustrated in FIGS. 5A and 5B, which translate and rotate together with axle 168 and base elements 162, 164 and 166. Lockable toothed wheels 176 rotate about an axis 180, which is the axis of axle 168 and is fixed with respect to a pair of rail riding elements 182, such as a model IGUS Drylin WW 10-40-10 commercially available from Igus Inc. of Providence, R.I., USA and shown in FIGS. 4A-4C. Rail riding elements 182 are slidable along axis 156 on fixed rail elements 152, preferably such that a slidable braking sub-assembly 234 operatively engages toothed track 158. Rotation of lockable toothed wheels 176 results from manual lifting of the slidable and rotatable frame assembly 160 from its orientation shown in FIG. 1A to its orientation shown in FIG. 1B and further via its orientation shown in FIG. 1C to its baby seat usable operative orientation shown in FIG. 1D.

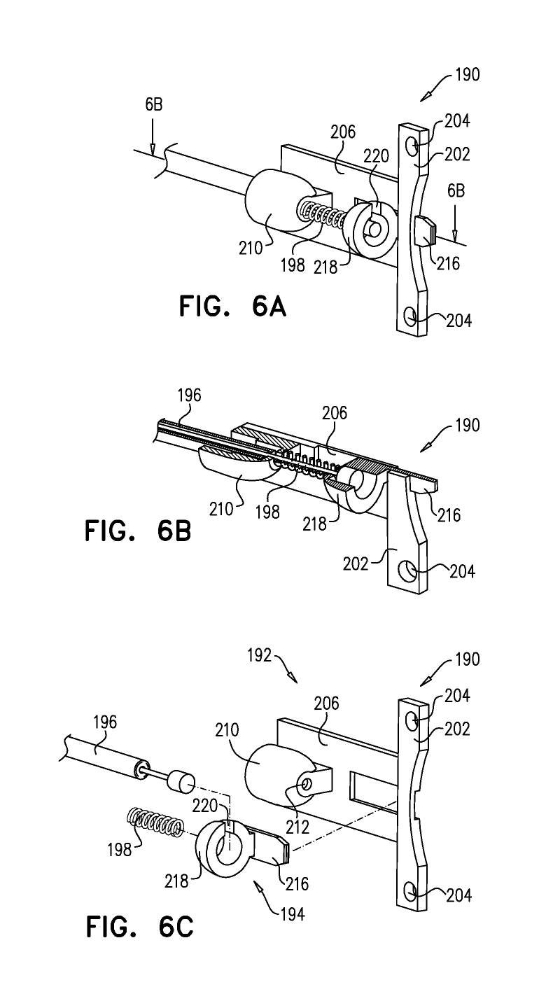

Reference is now additionally made to FIGS. 6A, 6B and 6C, which are, respectively, a simplified pictorial, a simplified sectional illustration and a simplified exploded view illustration of one of two rotation locking assemblies, forming part of the apparatus of FIGS. 2A-2C.

A rotation locking assembly 190 is preferably provided for locking engagement with each of lockable toothed wheels 176 against rotary motion about axis 180 and is illustrated in FIGS. 6A-6C. Rotation locking assembly 190 preferably comprises a mounting element 192, which is fixedly mounted onto each rail riding element 182, and a slidable latch element 194 which is displaced into and out of locking engagement with teeth of a corresponding lockable toothed wheel 176 by a conventional cable drive 196, such as a part of a FOLAI Recliner Handle with Cable, commercially available from Amazon under ASIN No. B01KXIUX2S. Cable drives 196 are all combined into one bundle via a splitter housing 197 such as model SPLHSG commercially available from http://www.ultralightnews.ca/cables_uslk/cableaccessories.htm This bundle is then preferably connected to a single operation lever 199 such that unlocking of rotation locking assembly 190 can be achieved by engaging operation lever 199 such as a part of a FOLAI Recliner Handle with Cable commercially available from Amazon under ASIN No. B01KXIUX2S. Alternatively, multiple levers may be employed. A conventional coil spring 198 normally urges slidable latch element 194 into locking engagement with lockable toothed wheel 176 and cable drive 196 is operative to selectably draw slidable latch element 194 out of locking engagement with lockable toothed wheel 176 against the urging of spring 198.

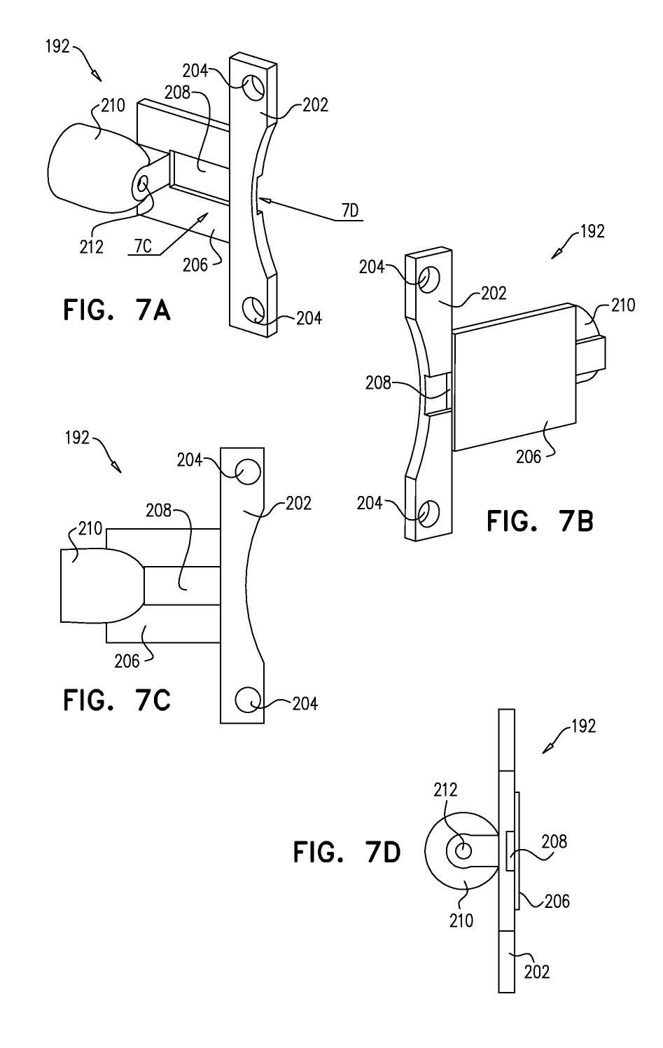

Reference is now made to FIGS. 7A, 7B, 7C and 7D, which are, respectively, first and second simplified pictorial illustrations and first and second simplified side view illustrations of a mounting element forming part of the rotation locking assembly of FIGS. 6A-6C. Mounting element 192 is illustrated in FIGS. 7A-7D and preferably is integrally formed as one piece and includes a mounting portion 202 having mounting apertures 204, a planar portion 206 defining a latch sliding aperture 208 and a cable drive engagement portion 210 having a cable passage aperture 212 at an end thereof.

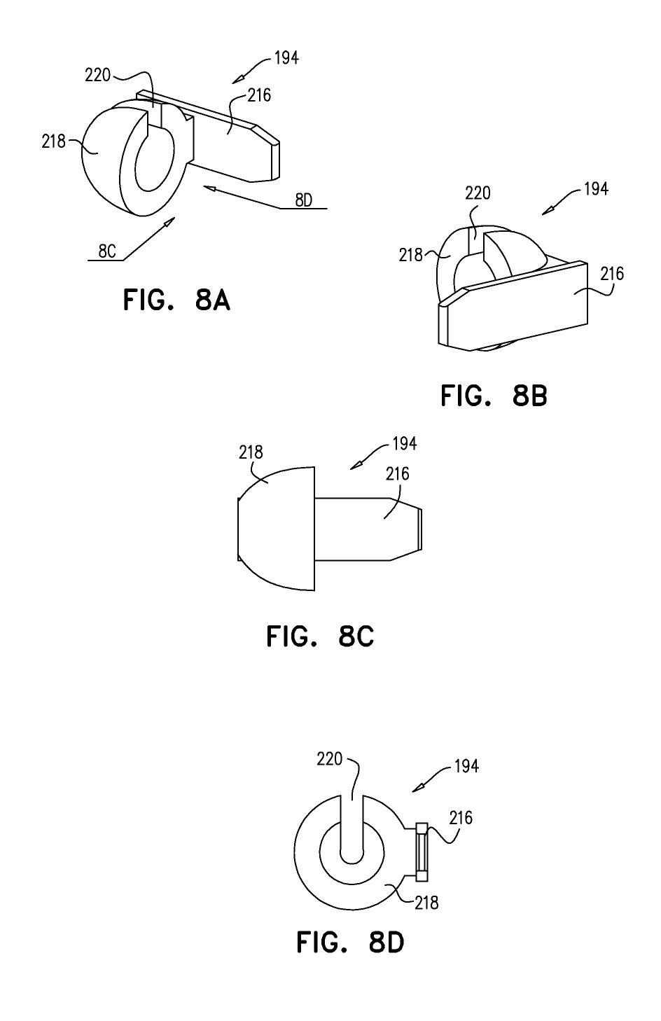

Reference is now made to FIGS. 8A, 8B, 8C and 8D, which are, respectively, first and second simplified pictorial illustrations and first and second simplified side view illustrations of a latch element forming part of the rotation locking assembly of FIGS. 6A-6C. Latch element 194 is illustrated in FIGS. 8A-8D and preferably is integrally formed as one piece and includes a generally planar latch portion 216 and a cable end engagement portion 218 having a cable passage slot 220 at an end thereof.

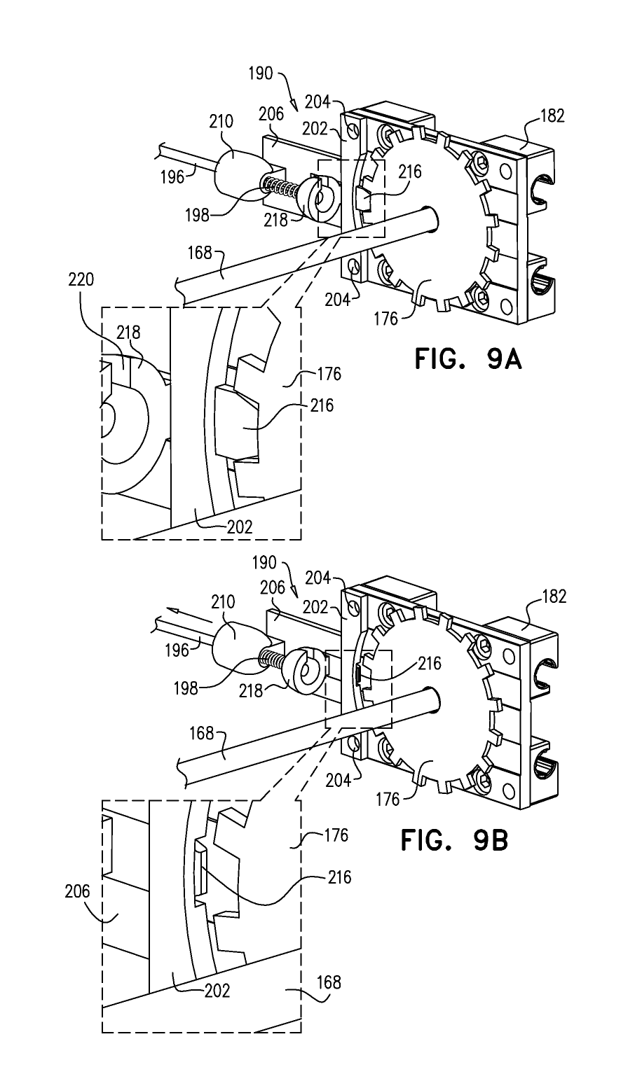

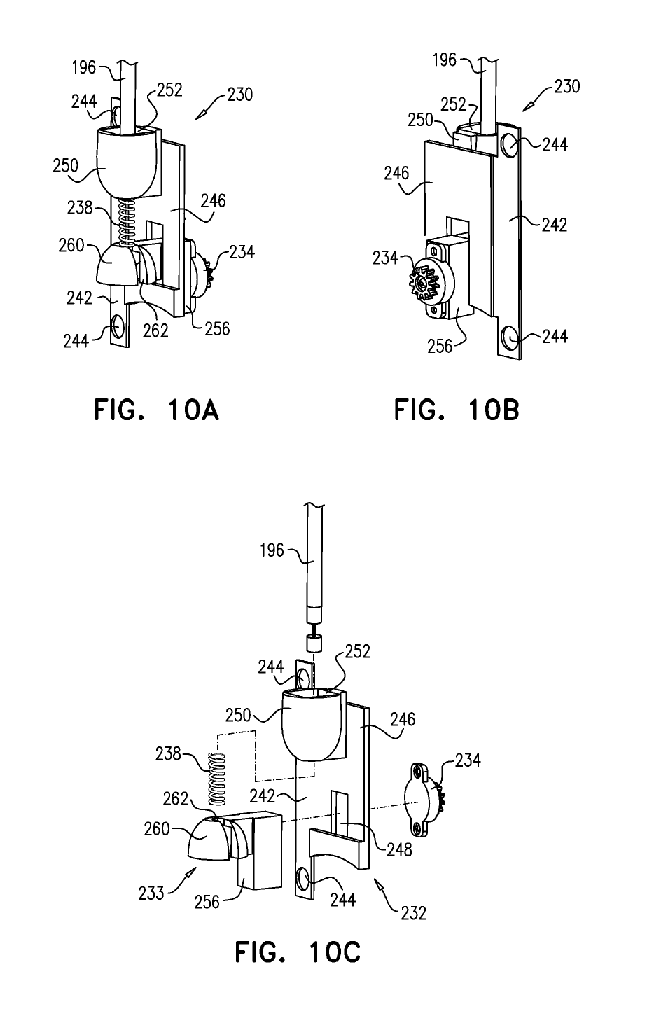

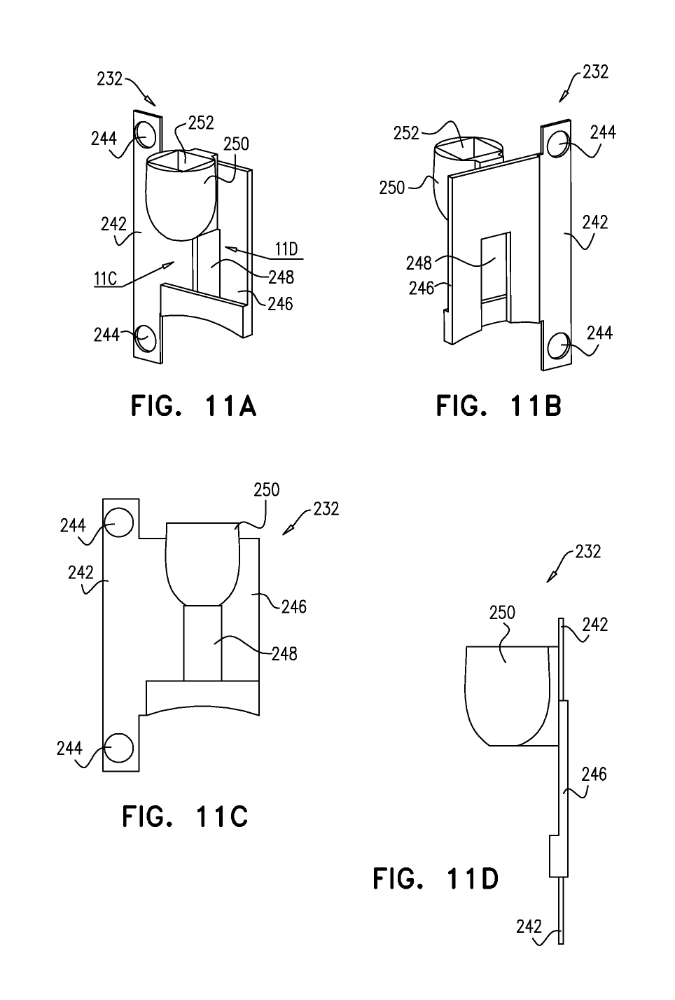

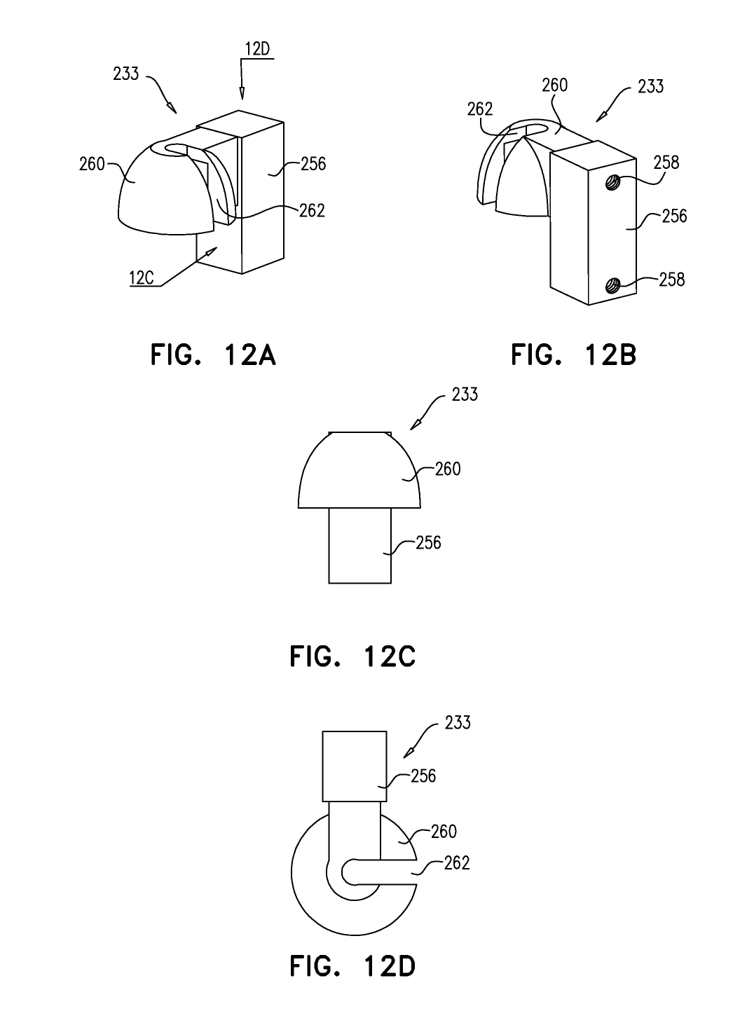

Reference is now made to FIGS. 9A and 9B, which are simplified pictorial illustrations which show a rotation locking assembly, such as that illustrated in FIGS. 6A-6C, mounted in operative engagement with a corresponding rail riding element, such as that illustrated in FIGS. 4A-4C, in respective locking and non-locking engagement with a lockable toothed wheel, such as that illustrated in FIGS. 5A and 5B. FIGS. 9A and 9B illustrate rotation locking assembly 190 of FIGS. 6A-6C mounted in operative engagement with a corresponding rail riding element 182 of FIGS. 4A-4C in respective locking and non-locking engagement with lockable toothed wheel 176 of FIGS. 5A-5B. In a locking orientation, shown in FIG. 9A, spring 198 urges latch portion 216 of latch element 194 into locking engagement with lockable toothed wheel 176. In a non-locking orientation, shown in FIG. 9B, the cable drive 196 is operative via operation lever 199 to selectably draw latch portion 216 of latch element 194 out of locking engagement with lockable toothed wheel 176 against the urging of spring 198.

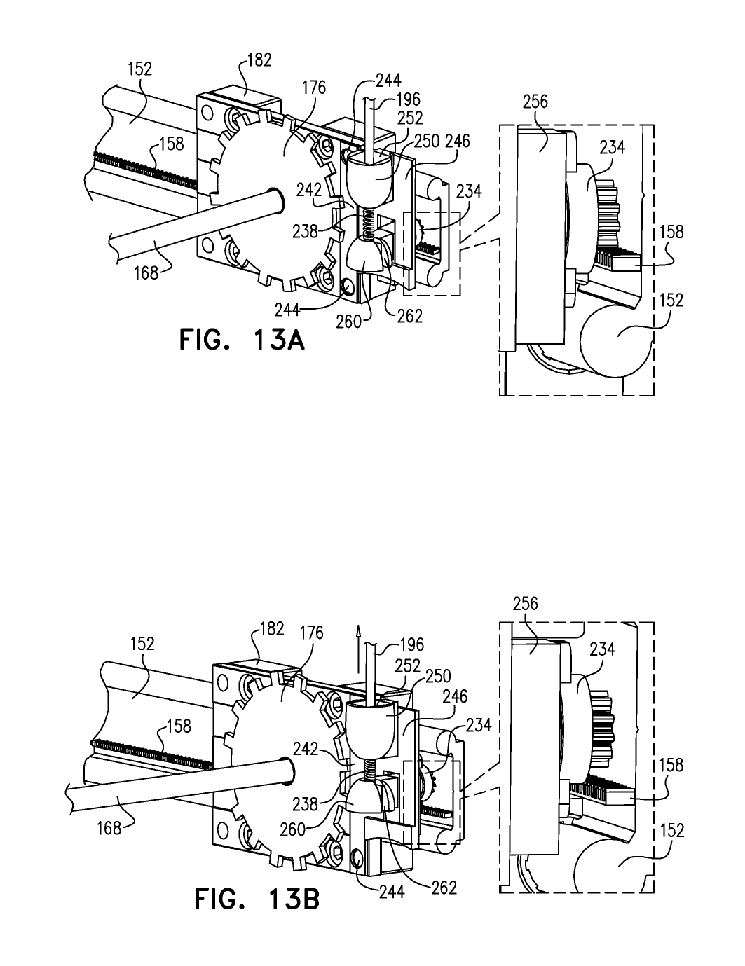

Reference is now made to FIGS. 10A, 10B and 10C, which are, respectively, first and second simplified pictorial illustrations and a simplified exploded view illustration of a translation braking assembly, forming part of the apparatus of FIGS. 2A-2C. A translation braking assembly 230, shown in FIGS. 10A-10C, is preferably provided for governing translation movement of each of rail riding elements 182. As seen in FIGS. 10A-10C, translation braking assembly 230 preferably comprises a mounting element 232, which is fixedly mounted onto each rail riding element 182, a slidable braking sub-assembly mount 233 and a slidable braking sub-assembly 234, preferably an E2 Series Bidirectional Damper, commercially available from ACE Controls Inc. of Farmington, Mich., which is fixed to slidable braking sub-assembly mount 233 and can be selectably displaced into and out of braking engagement with teeth of a corresponding toothed track 158 by a conventional cable drive 196. It is a particular feature of this embodiment of the present invention that slidable braking sub-assembly 234 provides axial impact force damping functionality which protects a baby seated in the baby seat assembly in the event of an axial input produced by a front end or rear end collision.

A conventional coil spring 238 normally urges slidable braking sub-assembly 234 into braking engagement with toothed track 158 and cable drive 196 is operative to selectably draw slidable braking sub-assembly 234 out of braking engagement with toothed track 158 against the urging of spring 238.

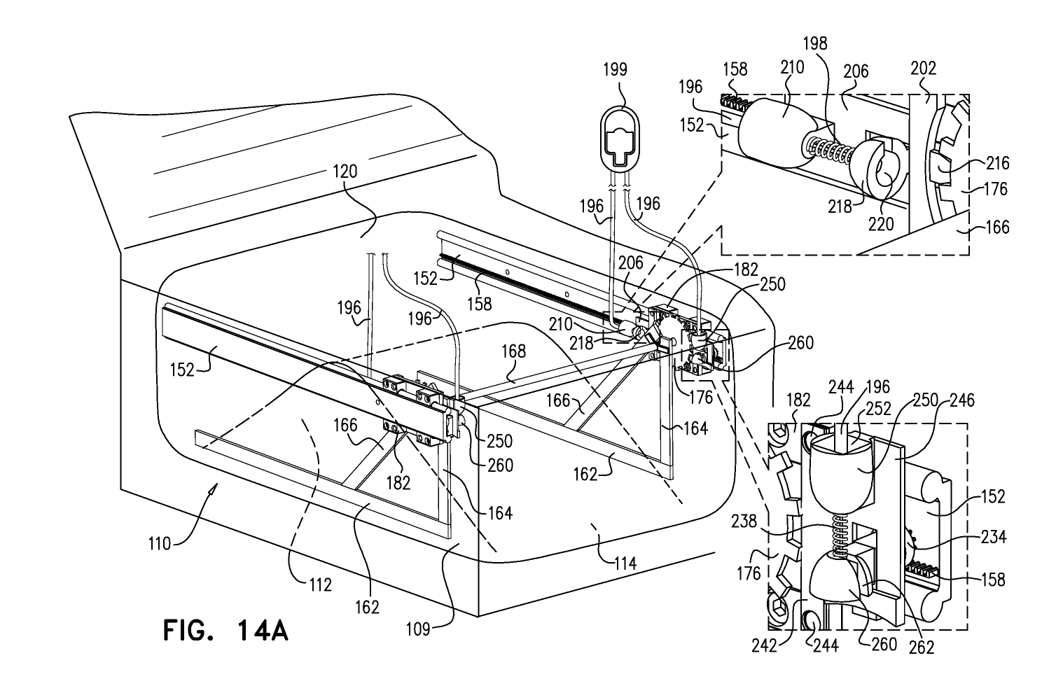

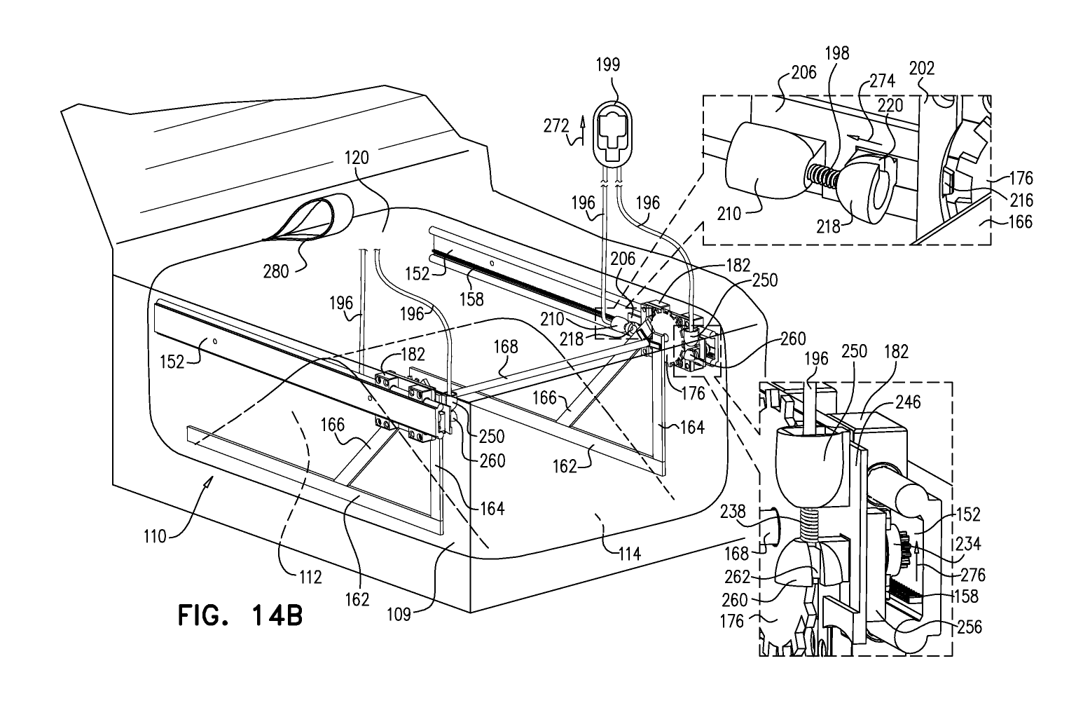

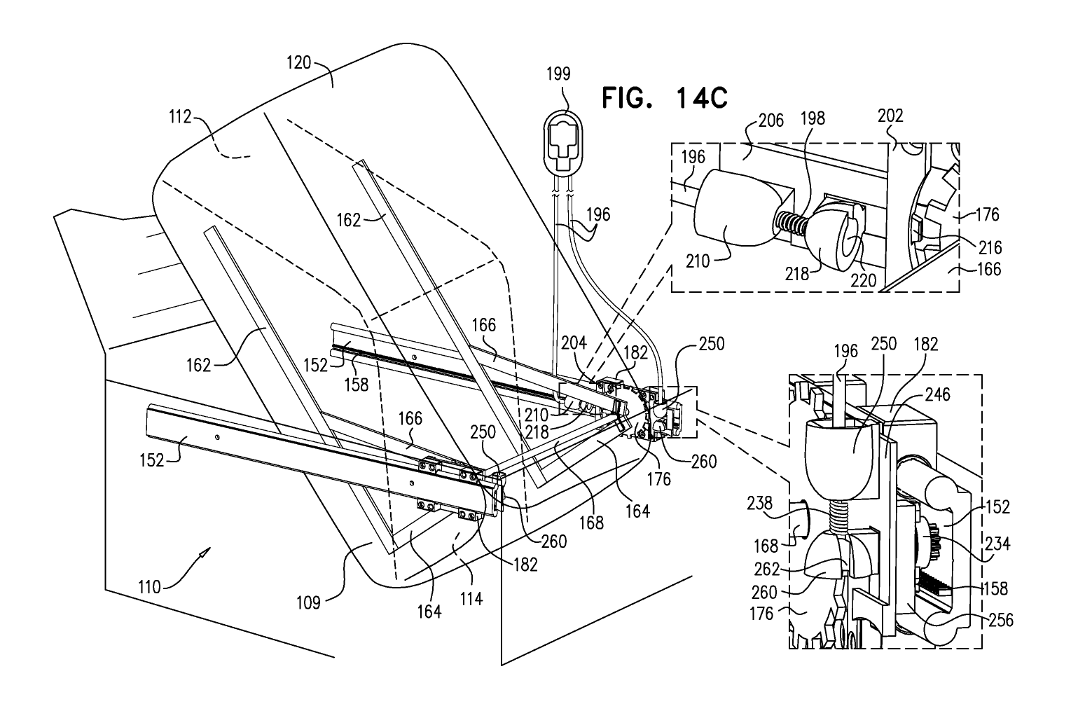

Reference is now made to FIGS. 11A, 11B, 11C and 11D, which are, respectively, first and second simplified pictorial illustrations and first and second simplified side view illustrations of a mounting element forming part of the translation braking assembly of FIGS. 10A-10C. Mounting element 232 is illustrated in FIGS. 11A-11D and preferably is integrally formed as one piece and includes a mounting portion 242 having mounting apertures 244, a planar portion 246 defining a braking sub-assembly sliding aperture 248 and a cable drive engagement portion 250 having a cable passage aperture 252 at an end thereof.

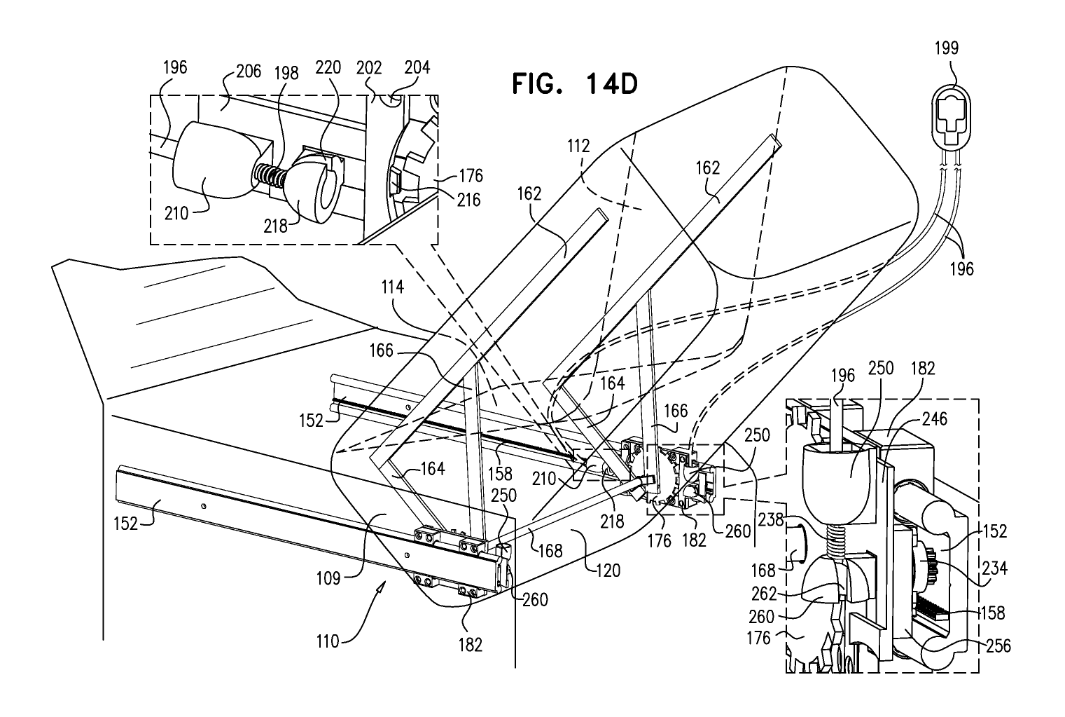

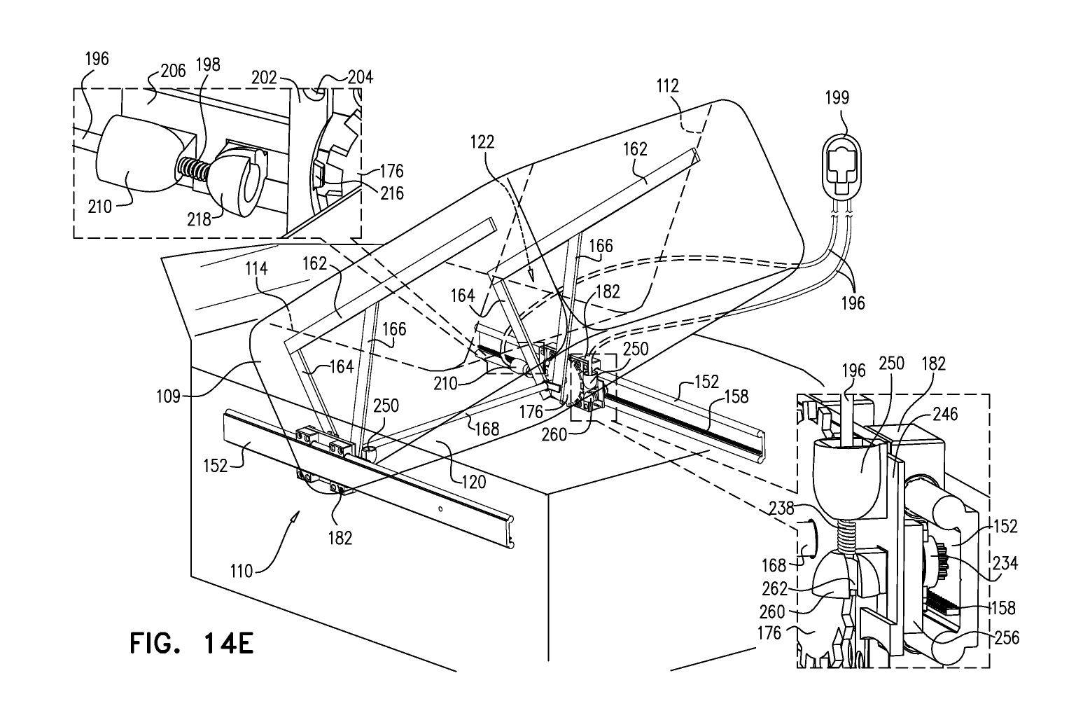

Slidable braking sub-assembly mount 233 is illustrated in FIGS. 12A, 12B, 12C and 12D and preferably is integrally formed as one piece and includes a generally planar braking sub-assembly mounting portion 256 having braking subassembly mounting apertures 258 and a cable end engagement portion 260, having a cable passage slot 262 at an end thereof.

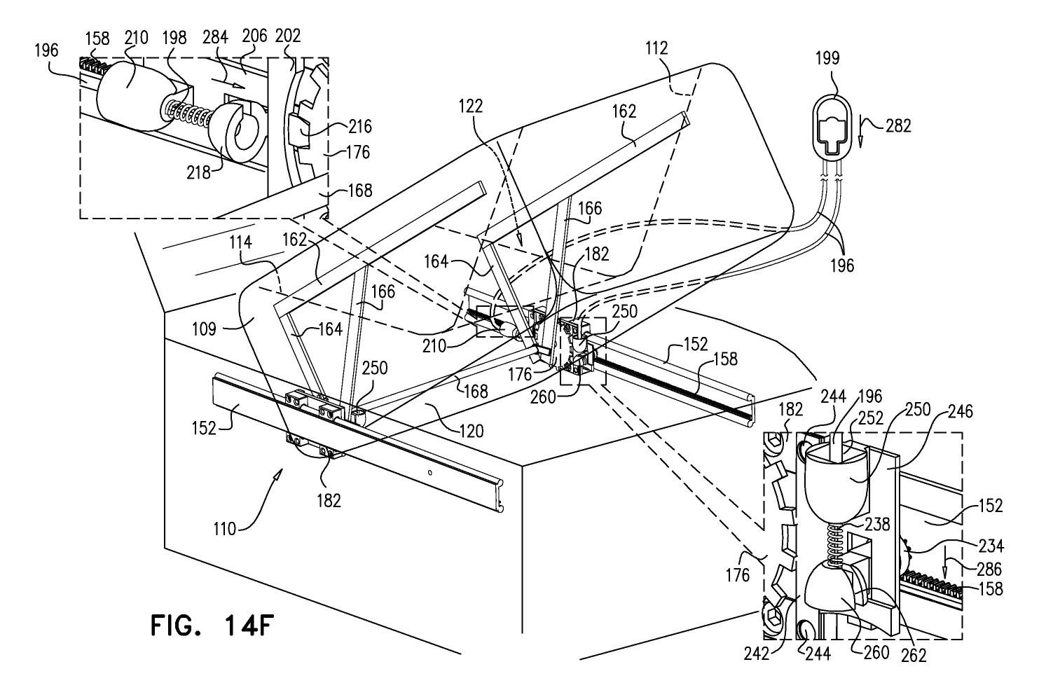

Reference is now made to FIGS. 13A and 13B, which are simplified pictorial illustrations which show a translation braking assembly, such as that illustrated in FIGS. 10A-10C, mounted in operative engagement with a corresponding rail riding element, such as that illustrated in FIGS. 4A-4C, in respective braking and non-braking engagement with a gear strip of a fixed rail element, such as that illustrated in FIGS. 3A-3C. FIGS. 13A and 13B show translation braking assembly 230 in respective braking and non-braking engagement with a toothed track 158. In the braking orientation shown in FIG. 13A, spring 238 urges slidable braking sub-assembly 234 into braking engagement with toothed track 158. In the non-braking orientation shown in FIG. 13B, the translation cable drive 196 is operative via operation lever 199 to selectably draw slidable braking sub-assembly 234 out of braking engagement with toothed track 158 against the urging of spring 238.

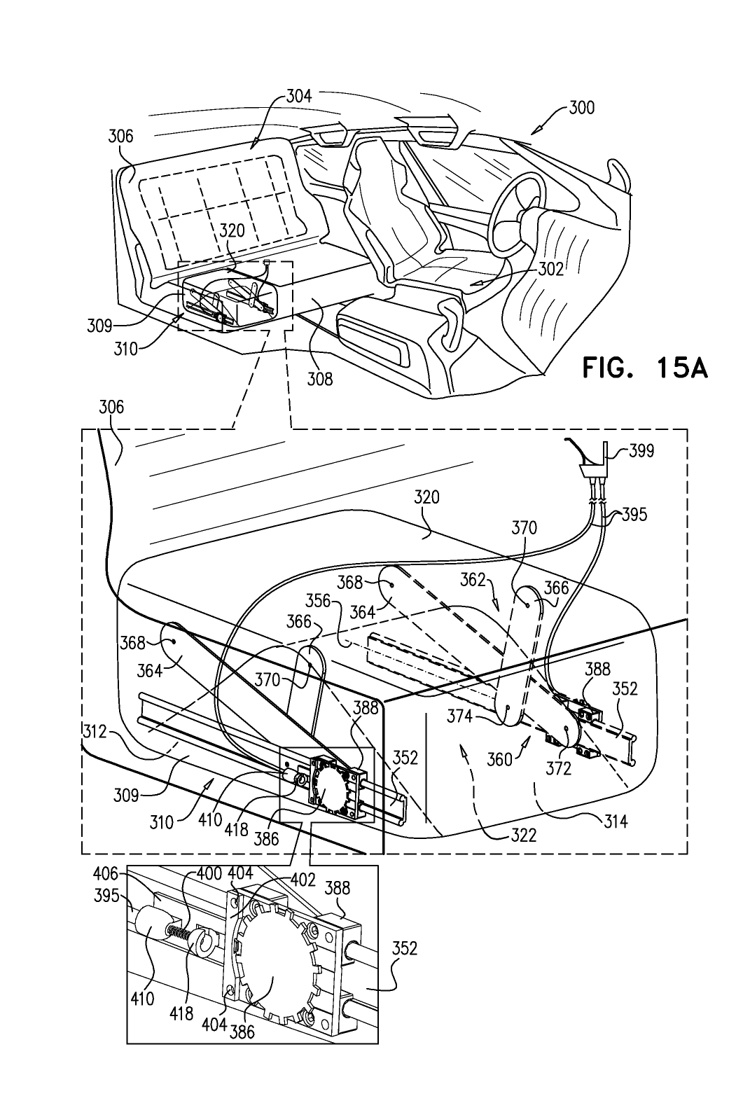

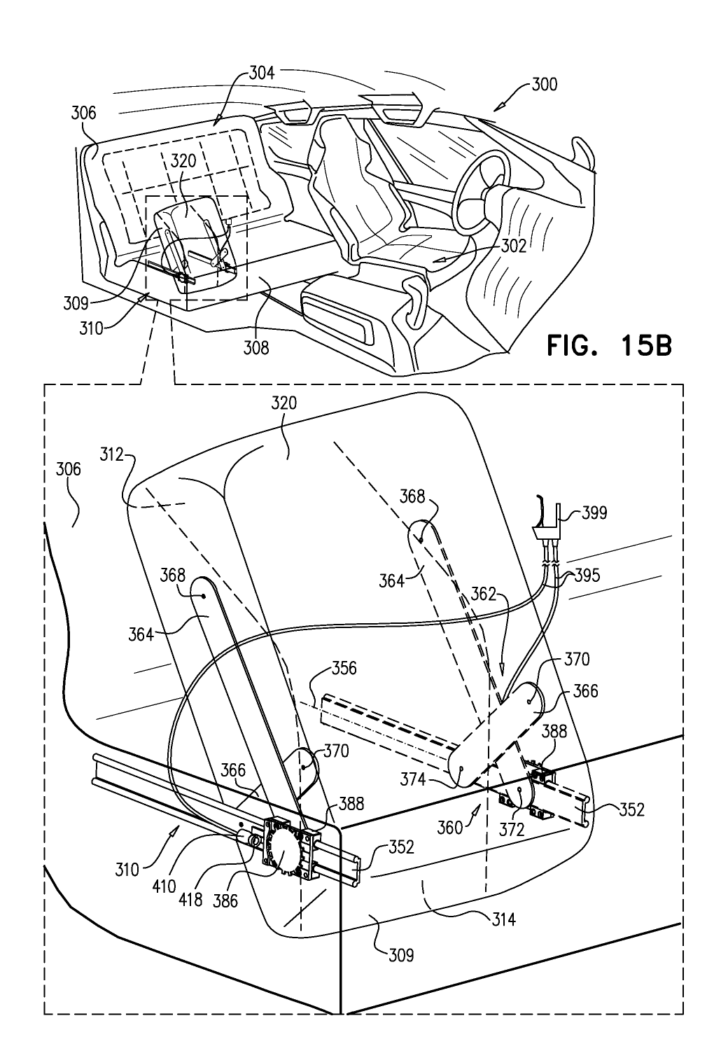

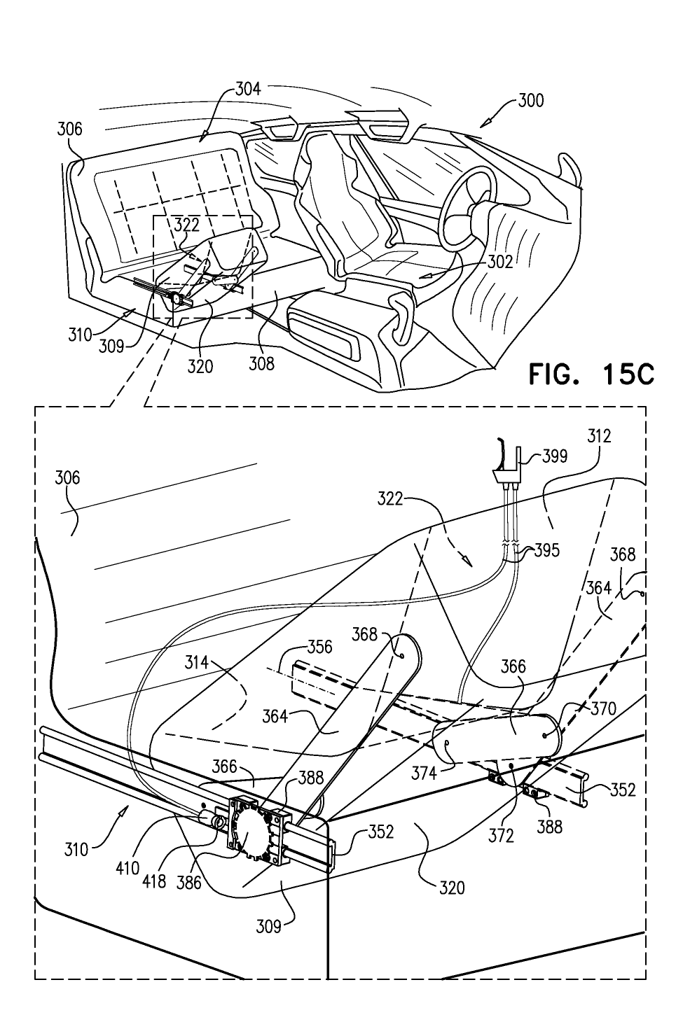

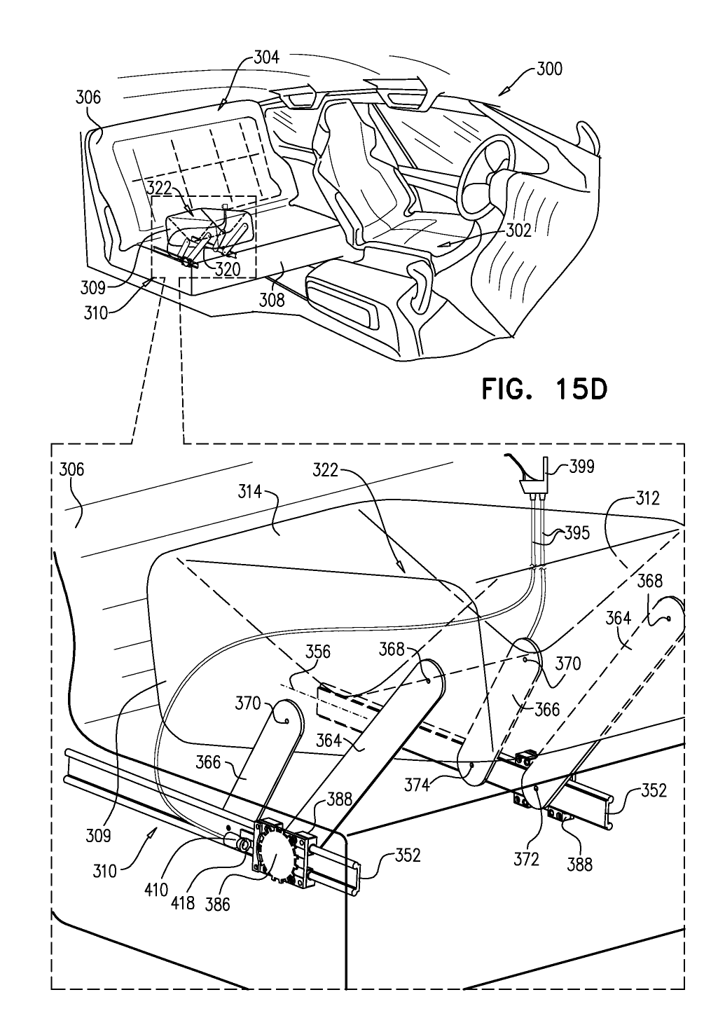

Reference is now made to FIGS. 14A, 14B, 14C, 14D, 14E and 14F, which are simplified illustrations of six stages in the operation of the convertible passenger seat of FIGS. 2A-2C. FIG. 14A shows the convertible passenger seat in its non-baby seat operative orientation. In this orientation, the operation lever 199 is in a rotation locking and translation braking state, rotation locking assemblies 190 are in the locking orientation shown in FIG. 9A and translation braking assemblies 230 are in the braking orientation shown in FIG. 13A.

FIG. 14B shows the convertible passenger seat in its non-baby seat operative orientation, in preparation for conversion to a baby seat orientation. In this orientation, the operation lever 199 is moved to a rotation non-locking and translation non-braking state, as indicated by an arrow 272. Movement of the operation lever 199 moves cable drives 196, which in turn move rotation locking assemblies 190 into the non-locking orientation shown in FIG. 9B, as indicated by an arrow 274, and translation braking assemblies 230 into the non-braking orientation shown in FIG. 13B, as indicated by an arrow 276. Conversion to baby seat operative condition can be achieved by a user rotating rotatable cushion 109, such as by pulling on a strap 280.

FIGS. 14C and 14D show two intermediate orientations, in these orientations, the operation lever 199 remains in a rotation non-locking and translation non-braking state, rotation locking assemblies 190 remain in the non-locking orientation shown in FIG. 9B and translation braking assemblies 230 remain in the non-braking orientation shown in FIG. 13B.

FIG. 14E shows the convertible passenger seat in its baby seat orientation but not yet locked against displacement or rotation. In this orientation, the operation lever 199 remains in a rotation non-locking and translation non-braking state, rotation locking assemblies 190 remain in the non-locking orientation shown in FIG. 9B and translation braking assemblies 230 remain in the non-braking orientation shown in FIG. 13B.

FIG. 14F shows the convertible passenger seat in its baby seat orientation and locked against displacement and rotation. In this orientation, the operation lever 199 is returned to the rotation locking and translation braking state, as indicated by an arrow 282, thereby releasing cable drives 196, which in turn return rotation locking assemblies 190 to the locking orientation shown in FIG. 9A, as indicated by an arrow 284, and translation braking assemblies 230 to the braking orientation shown in FIG. 13A, as indicated by an arrow 286.

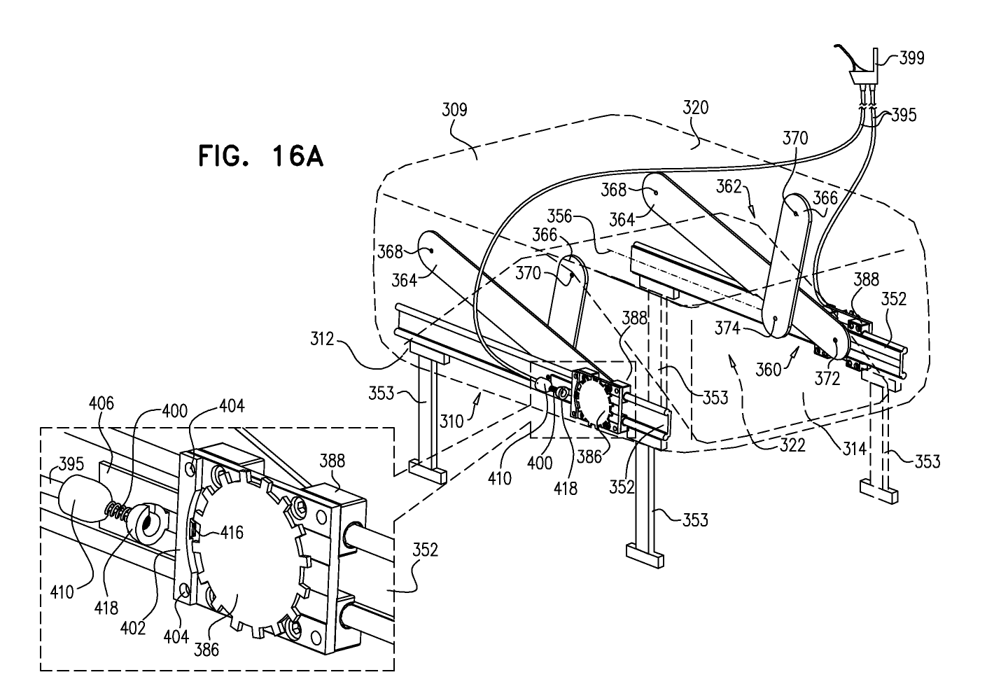

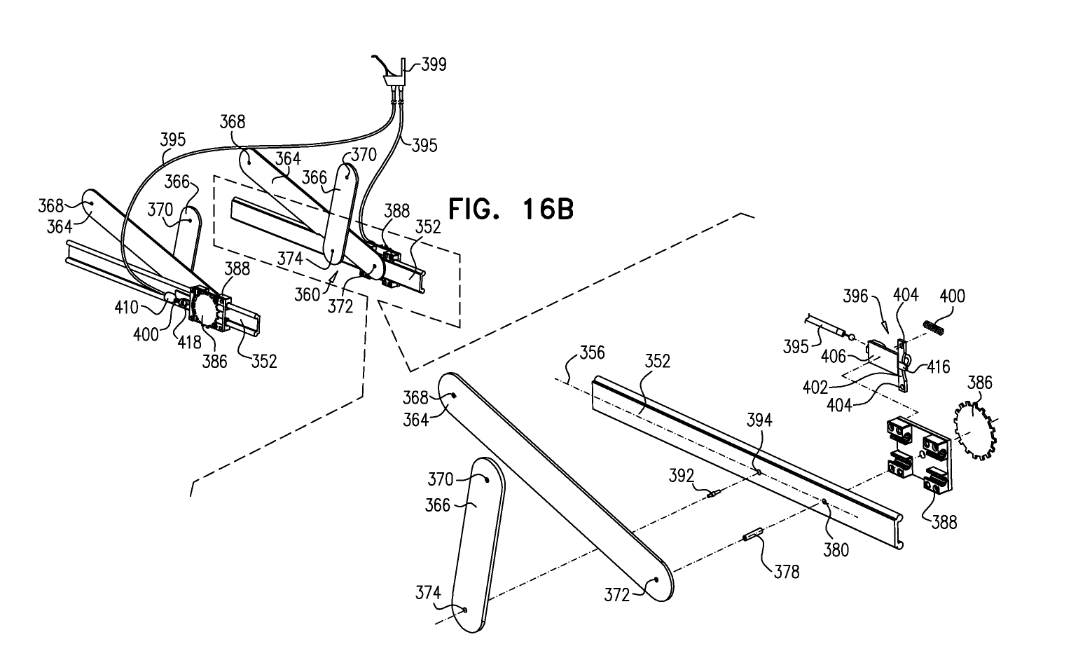

Reference is now made to FIGS. 15A, 15B, 15C and 15D, which are simplified pictorial illustrations of a vehicle including a convertible passenger seat constructed and operative in accordance with another embodiment of the present invention wherein a baby seat is shown in a non-baby seat usable operative orientation, first and second intermediate operative orientations and a baby seat usable operative orientation, respectively.

As seen in FIGS. 15A-15D, there is provided a vehicle 300, such as a passenger car having passenger seats including at least one front seat 302 and at least one back seat 304. In the illustrated embodiment, at least one back seat 304 is configured as a convertible passenger seat including a back seat portion 306 and a bottom seat portion 308 having a rotatable cushion 309. In accordance with this embodiment of the present invention, the bottom seat portion 308 incorporates a baby seat assembly 310, having a baby back seat portion 312 and a baby bottom seat portion 314 both defined by rotatable cushion 309. In accordance with this embodiment of the present invention, the baby seat assembly 310 is movable from a non-baby seat usable mode, shown in FIG. 15A, in which a first surface 320 of rotatable cushion 309 of the baby seat assembly defines a non-baby seat surface, to a baby seat usable mode, shown in FIG. 15D, in which at least one second surface 322 of the rotatable cushion 309, different from the first surface 320, defines a baby seat surface including a baby back seat portion 312 and a baby bottom seat portion 314. It is appreciated that alternatively, the convertible passenger seat may be incorporated into a front seat of a vehicle.

FIGS. 15B and 15C show intermediate stages in a transformation of the convertible passenger seat from the non-baby seat usable operative orientation shown in FIG. 15A to the baby seat usable operative orientation shown in FIG. 15D.

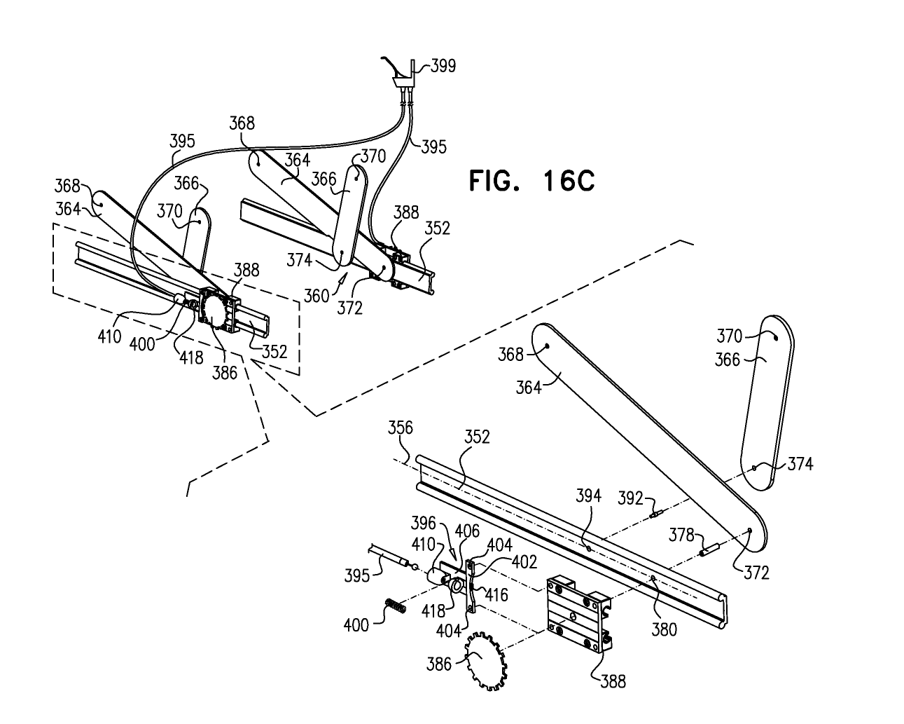

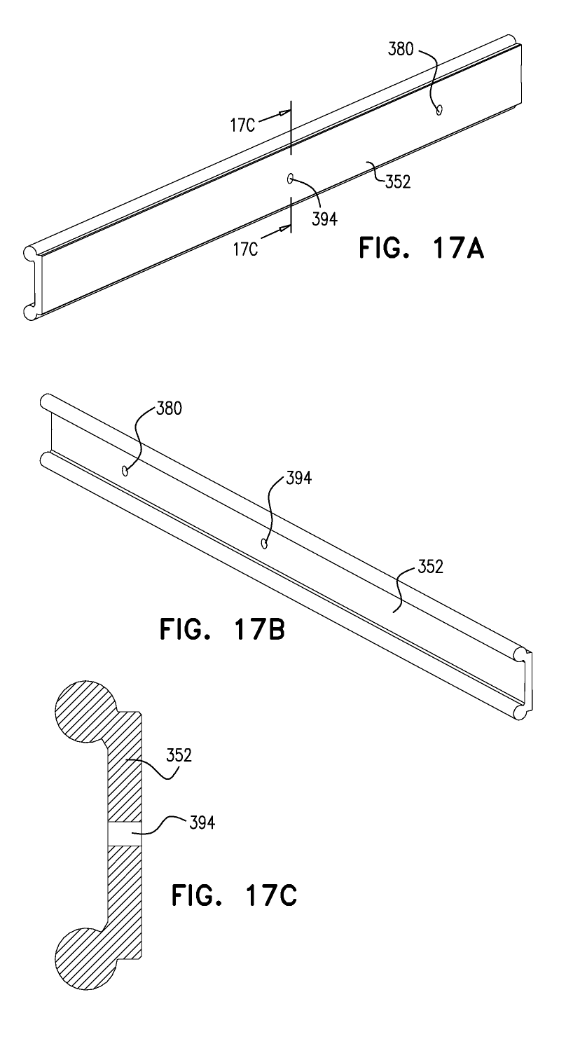

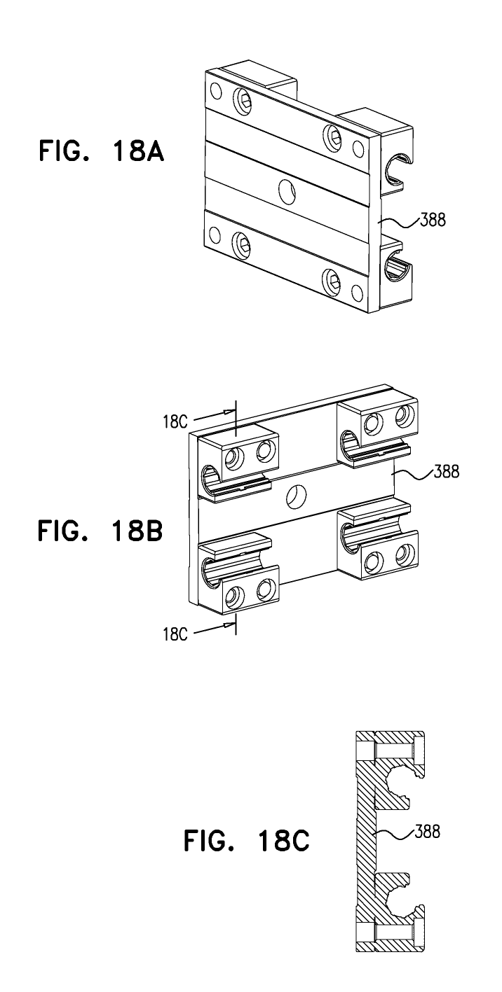

Reference is now made to FIGS. 16A, 16B and 16C, which are, respectively, a simplified assembled view and simplified exploded view illustrations of a convertible passenger seat constructed and operative in accordance with this embodiment of the present invention. Reference is also made to FIGS. 17A, 17B and 17C, which are, respectively, first and second simplified pictorial illustrations and a simplified sectional illustration of one of two fixed rail elements forming part of the apparatus of FIGS. 16A-16C.

As seen in FIGS. 16A-16C, the baby seat assembly 310 preferably includes a pair of generally horizontal fixed rail elements 352, such as that illustrated in FIGS. 17A-17C, which extend along an axis 356 and which are fixed to the car via a plurality of legs 353 extending downwardly from fixed rail elements 352. Generally horizontal fixed rail elements 352 may be commercially available rail elements such as a model IGUS Drylin WS10-40 commercially available from Igus Inc. of Providence, R.I., USA.

Baby seat assembly 310 also comprises a rotatable support assembly 360, which is rotatable relative to fixed rail elements 352. Rotatable support assembly 360 preferably comprises a pair of sets 362 of elongate base elements on opposite sides of cushion 309. Each set of elongate base elements includes a relatively long elongate base element 364 and a relatively short base element 366. Each of relatively long elongate base elements 364 is rotatably attached at a first end thereof to a mutually side to side opposite location 368 on cushion 309. Each of relatively short elongate base elements 366 is rotatably attached at a first end thereof to a mutually side to side opposite location 370 on cushion 309. Each of relatively long elongate base elements 364 is rotatably attached at a second end thereof to a corresponding fixed rail element 352 at a mutually side to side opposite location 372. Each of relatively short elongate base elements 366 is rotatably attached at a second end thereof to a corresponding fixed rail element 352 at a mutually side to side opposite location 374.

It is a particular feature of the embodiment shown in FIGS. 15A-16C that the base elements and the interconnection provide a certain degree of flexibility in the mounting of the baby seat assembly. This flexibility is helpful for damping axial impacts, which could result from rear end or front end collisions as well as side impacts.

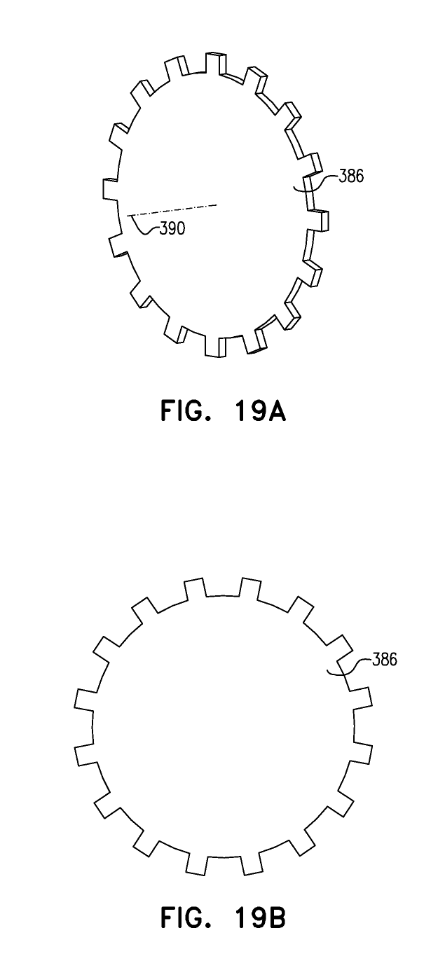

Reference is now additionally made to FIGS. 18A, 18B and 18C, which are, respectively, first and second simplified pictorial illustrations and a simplified sectional illustration of one of two track mounting elements forming part of the apparatus of FIGS. 16A-16C. Reference is also made to FIGS. 19A and 19B, which are, respectively, a simplified pictorial illustration and a simplified planar illustration of one of two lockable toothed wheels forming part of the apparatus of FIGS. 16A-16C.

Preferably, on each side of cushion 309, an axle 378 extends perpendicularly to the planes of elongate base elements 364 and 366 and is fixedly joined to relatively long elongate base element 364 and rotatably extends through an aperture 380 in a corresponding fixed rail element 352. Fixed to each axle 378 is a lockable toothed wheel 386, illustrated in FIGS. 19A and 19B, which rotates together with axle 378 and relatively long elongate base element 364. Lockable toothed wheel 386 rotates relative to a rail mounting element 388 about an axis 390, which is the axis of axle 378 and is fixed with respect to rail mounting element 388. Rail mounting element 388 may be a model IGUS Drylin WW 10-40-10 commercially available from Igus Inc. of Providence, R.I., USA and shown in FIGS. 18A-18C.

Preferably, on each side of cushion 309, an axle 392 extends perpendicularly to the planes of elongate base elements 364 and 366 and is fixedly joined to relatively short elongate base element 366 and rotatably extends through an aperture 394 in a corresponding fixed rail element 352.

Rotation of lockable toothed wheels 386 results from manual lifting of the rotatable support assembly 360 from its orientation shown in FIG. 15A to its orientation shown in FIG. 15B and further via its orientation shown in FIG. 15C to its baby seat usable operative orientation shown in FIG. 15D.

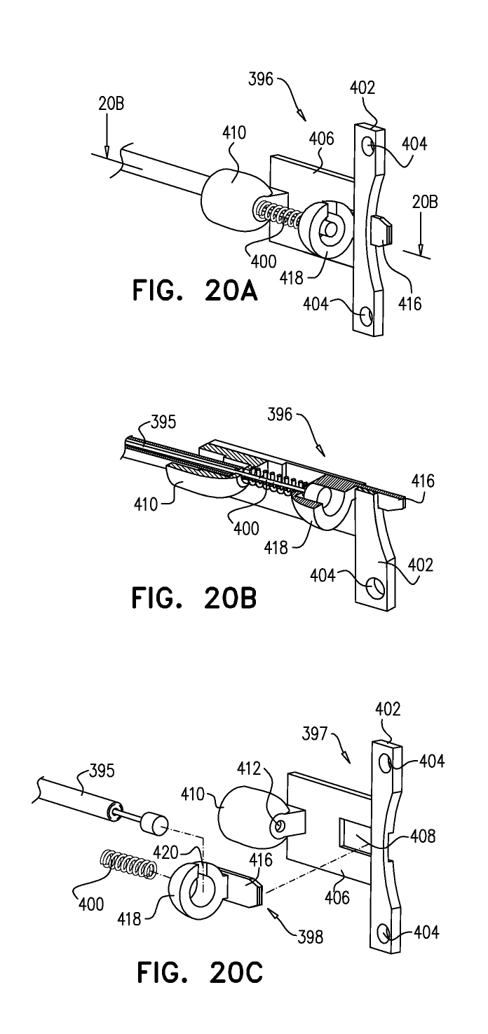

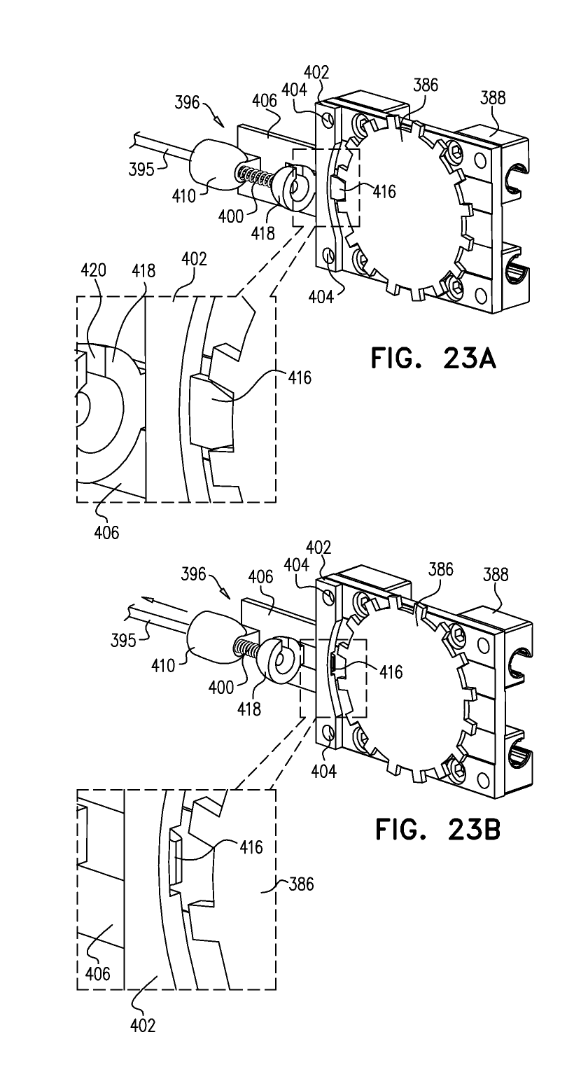

Reference is now made to FIGS. 20A, 20B and 20C, which are, respectively, a simplified pictorial illustration, a simplified sectional illustration and a simplified exploded view illustration of a rotation locking assembly, forming part of the apparatus of FIGS. 16A-16C. A rotation locking assembly 396 is preferably provided for locking engagement with each of lockable toothed wheels 386 against rotary motion about axis 390 and is illustrated in FIGS. 20A-20C. Rotation locking assembly 396 preferably comprises a mounting element 397, which is fixedly mounted onto each rail mounting element 388, and a slidable latch element 398 which is displaced into and out of locking engagement with teeth of a corresponding lockable toothed wheel 386 (shown in FIGS. 19A-19B and 23A-23B) by a conventional drive cable 395 such as model FH-THRTTLECBLE Throttle Cable commercially available from Amazon under ASIN No. B00KWLM2YE. Unlocking of rotation locking assembly 396 can be achieved by engaging a conventional operation lever 399, such as a Sunlite Alloy Double MTN Lever commercially available from Amazon under ASIN No. B000AO7H16. A conventional coil spring 400 normally urges slidable latch element 398 into locking engagement with lockable toothed wheel 386. Cable drive 395 is operative via operation lever 399 to selectably draw slidable latch element 398 out of locking engagement with lockable toothed wheel 386 against the urging of spring 400.

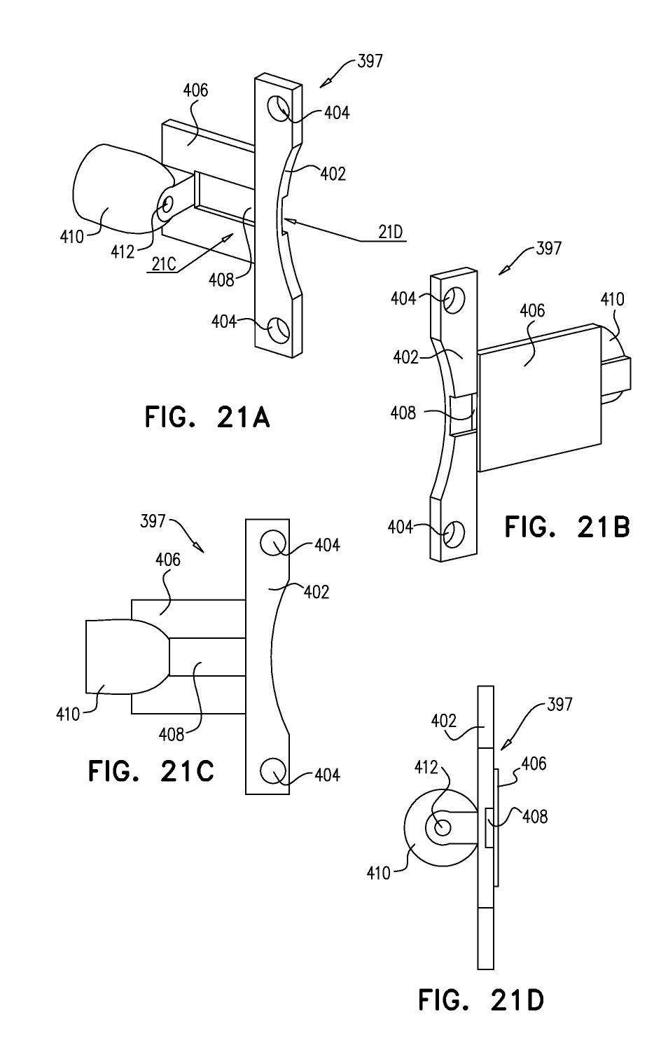

Reference is now made to FIGS. 21A, 21B, 21C and 21D, which are, respectively, first and second simplified pictorial illustrations and first and second simplified side view illustrations of a mounting element forming part of the rotation locking assembly of FIGS. 20A-20C. Mounting element 397 is illustrated in FIGS. 21A-21D and preferably is integrally formed as one piece and includes a mounting portion 402 having mounting apertures 404, a planar portion 406 defining a latch sliding aperture 408 and a cable drive engagement portion 410 having a cable passage aperture 412 at an end thereof.

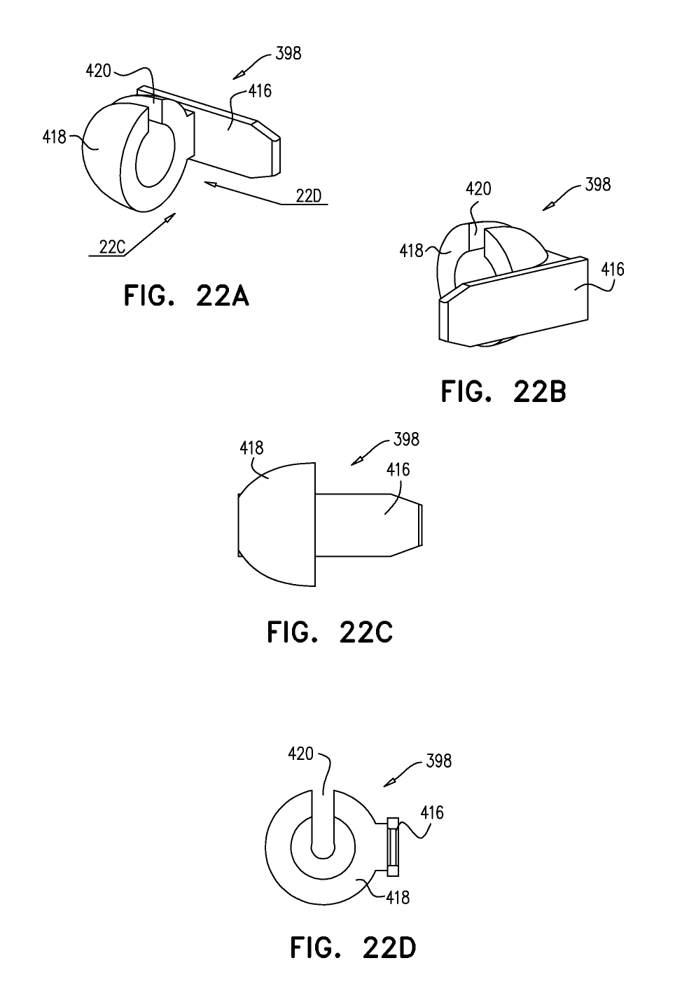

Reference is now made to FIGS. 22A, 22B, 22C and 22D, which are, respectively, first and second simplified pictorial illustrations and first and second simplified side view illustrations of a slidable latch element forming part of the rotation locking assembly of FIGS. 20A-20C. Latch element 398, illustrated in FIGS. 22A-22D, preferably is integrally formed as one piece and includes a generally planar latch portion 416 and a cable end engagement portion 418 having a cable passage slot 420 at an end thereof.

Reference is now made to FIGS. 23A and 23B, which are simplified pictorial illustrations which show a rotation locking assembly, such as that illustrated in FIGS. 20A-20C, mounted in operative engagement with a corresponding track mounting element, such as that illustrated in FIGS. 18A-18C, in respective locking and non-locking engagement with a lockable toothed wheel element, such as that illustrated in FIGS. 19A and 19B. FIGS. 23A and 23B illustrate rotation locking assembly 396 mounted in operative engagement with a corresponding rail mounting element 388 in respective locking and non-locking engagement with a lockable toothed wheel 386. In the locking orientation shown in FIG. 23A, conventional coil spring 400 urges slidable latch element 398 into locking engagement with lockable toothed wheel 386. In the non-locking orientation shown in FIG. 23B, the conventional drive cable 395 is operative via operation lever 399 to selectably draw slidable latch element 398 out of locking engagement with lockable toothed wheel 386 against the urging of spring 400.

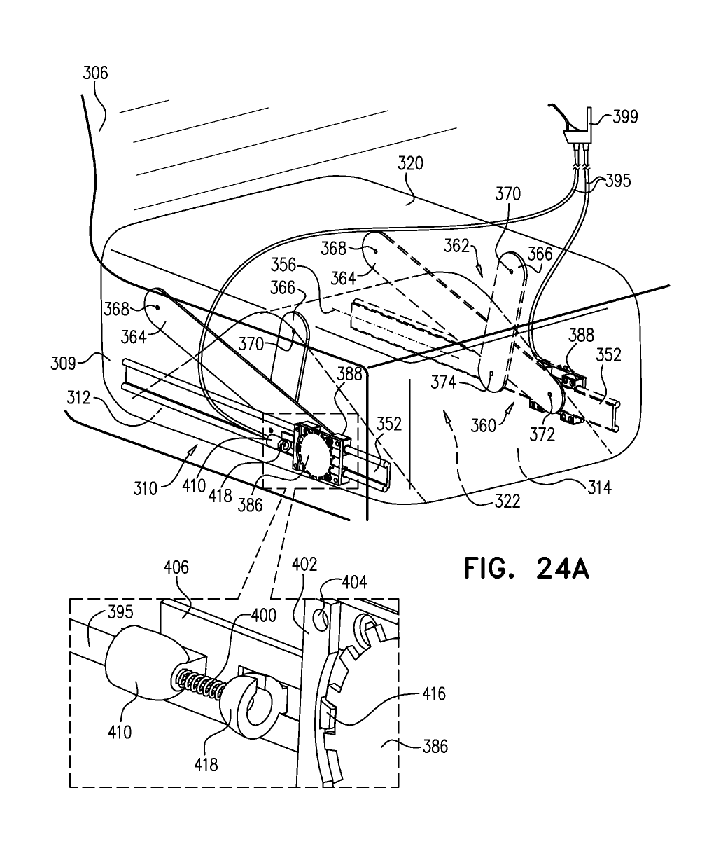

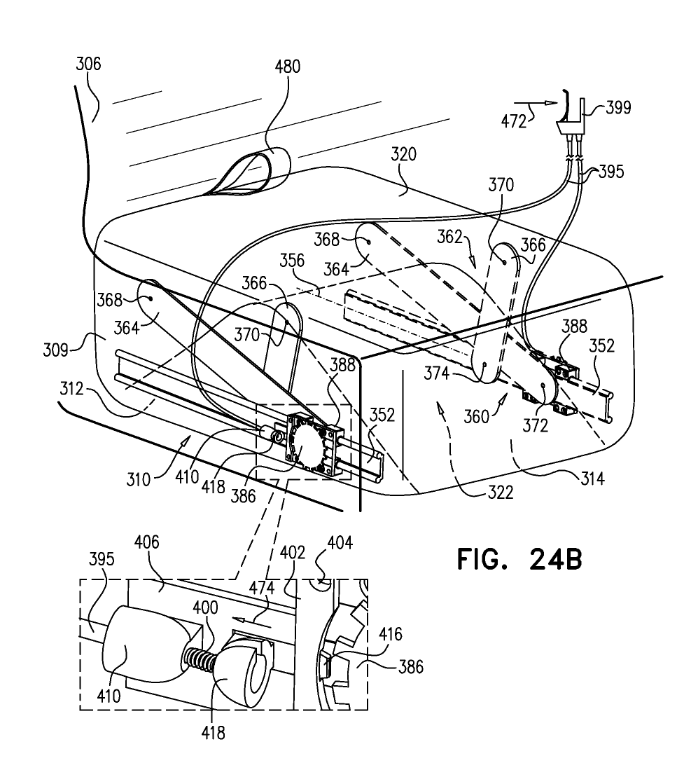

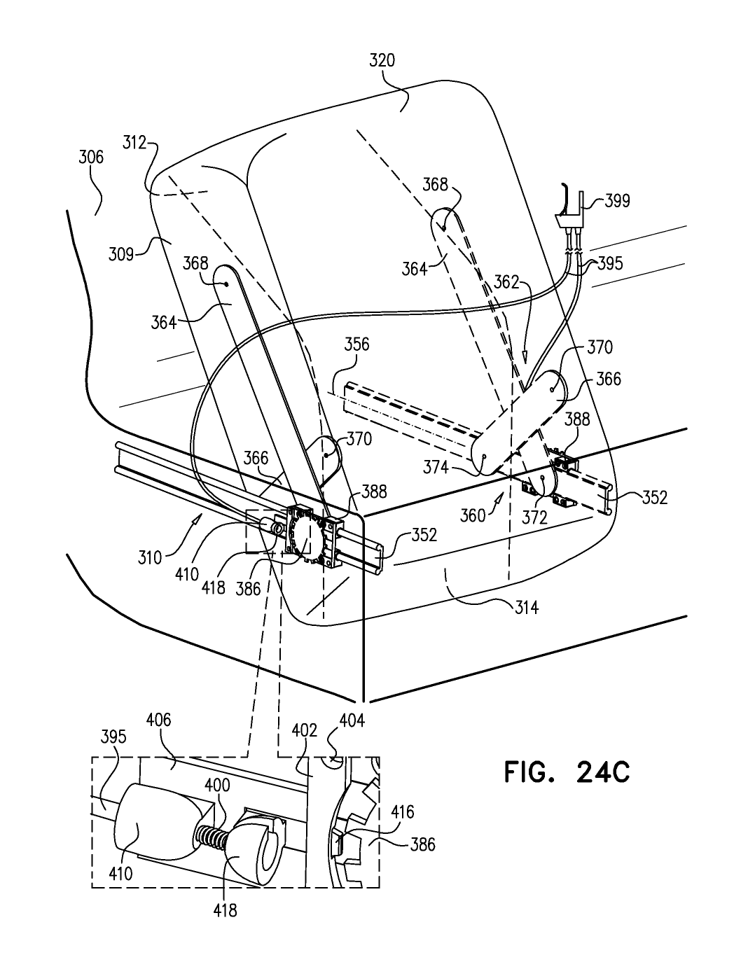

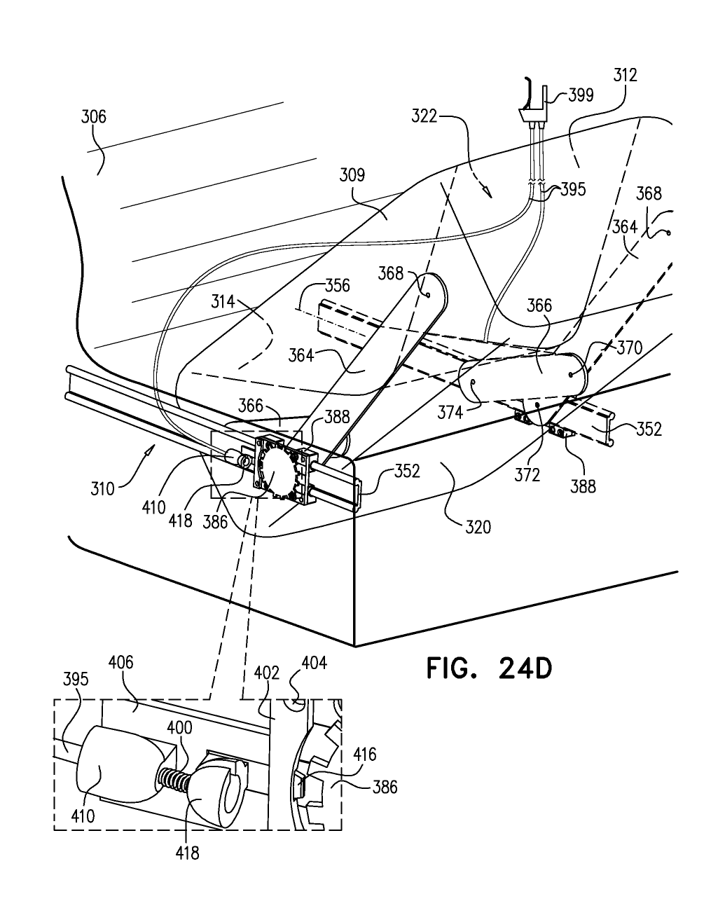

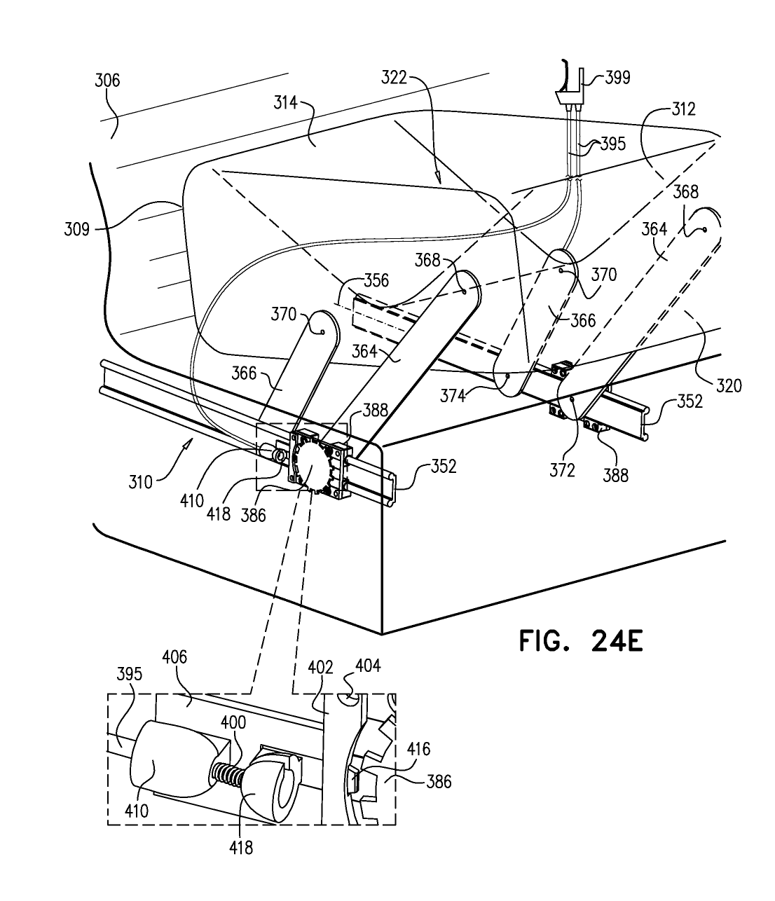

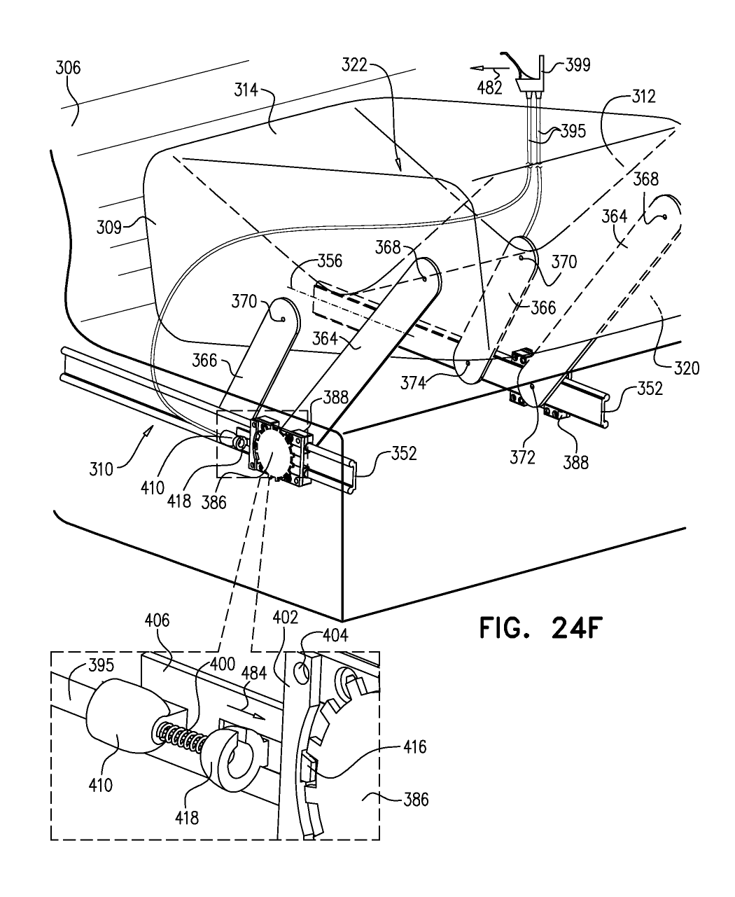

Reference is now made to FIGS. 24A, 24B, 24C, 24D, 24E and 24F, which are simplified illustrations of six stages in the operation of the convertible passenger seat of FIGS. 15A-15E. FIG. 24A shows the convertible passenger seat in its non-baby seat operative orientation. In this orientation, the operation lever 399 is in a rotation locking state and rotation locking assemblies 396 are in the locking orientation shown in FIG. 23A.

FIG. 24B shows the convertible passenger seat in its non-baby seat operative orientation, in preparation for conversion to a baby seat orientation. In this orientation, the operation lever 399 is moved to a rotation non-locking state, as indicated by an arrow 472. Movement of the operation lever 399 moves cable drives 395, which in turn move rotation locking assemblies 396 into the non-locking orientation shown in FIG. 23B, as indicated by an arrow 474. Conversion to baby seat operative condition can be achieved by a user rotating rotatable cushion 309, such as by pulling on a strap 480.

FIG. 24C shows an intermediate orientation in conversion of the convertible passenger seat from its non-baby seat operative orientation to its baby seat orientation. In this orientation, the operation lever 399 remains in a rotation non-locking state and rotation locking assemblies 396 remain in the non-locking orientation shown in FIG. 23B.

FIG. 24D shows another intermediate orientation in conversion of the convertible passenger seat from its non-baby seat operative orientation to its baby seat orientation. In this orientation, the operation lever 399 remains in a rotation non-locking state and rotation locking assemblies 396 remain in the non-locking orientation shown in FIG. 23B.

FIG. 24E shows the convertible passenger seat in its baby seat orientation but not yet locked against rotation. In this orientation, the operation lever 399 remains in a rotation non-locking state and rotation locking assemblies 396 remain in the non-locking orientation shown in FIG. 23B.

FIG. 24F shows the convertible passenger seat in its baby seat orientation and locked against rotation. In this orientation, the operation lever 399 is returned to the rotation locking state, as indicated by an arrow 482, thereby releasing cable drives 395, which in turn return rotation locking assemblies 396 to the locking orientation shown in FIG. 23A, as indicated by an arrow 484.

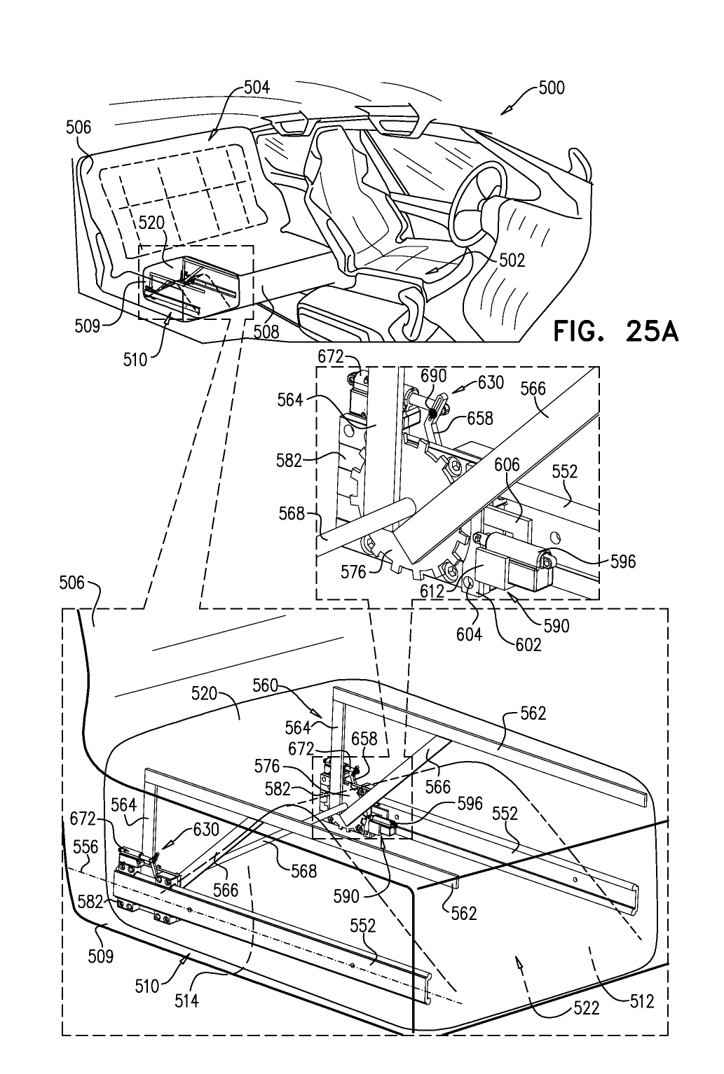

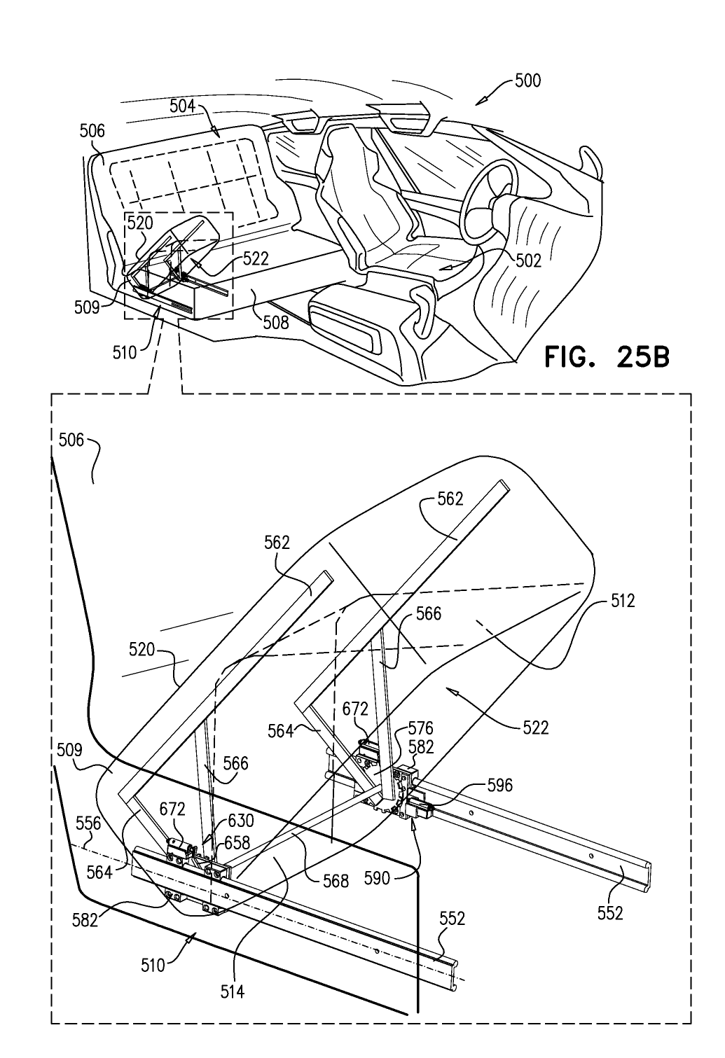

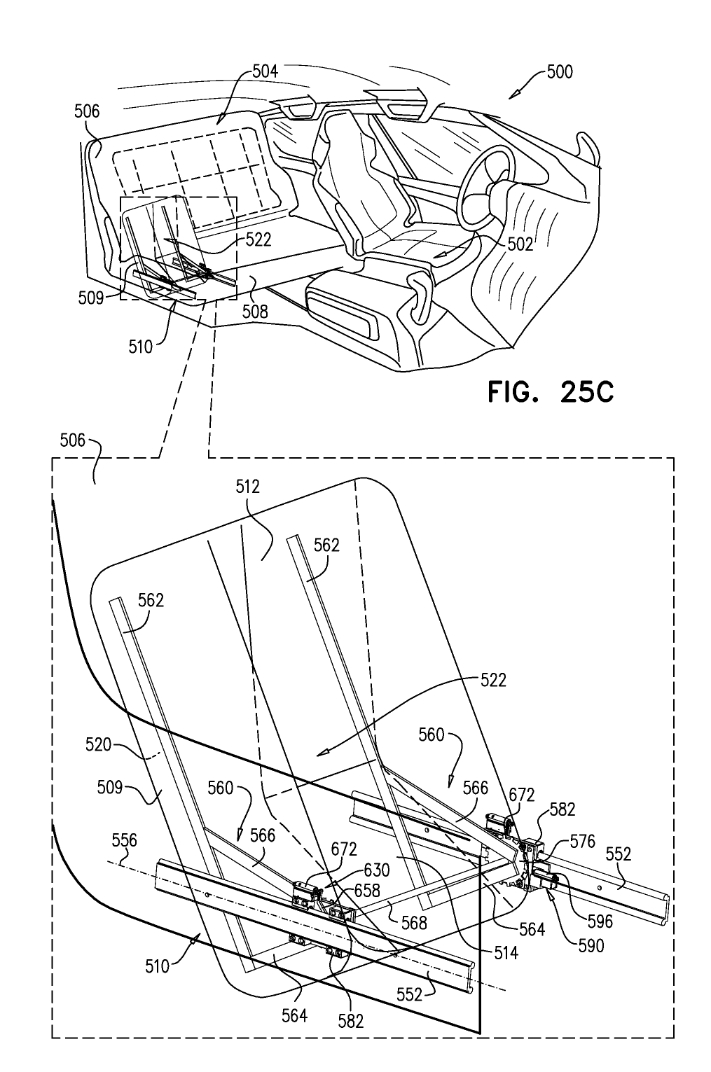

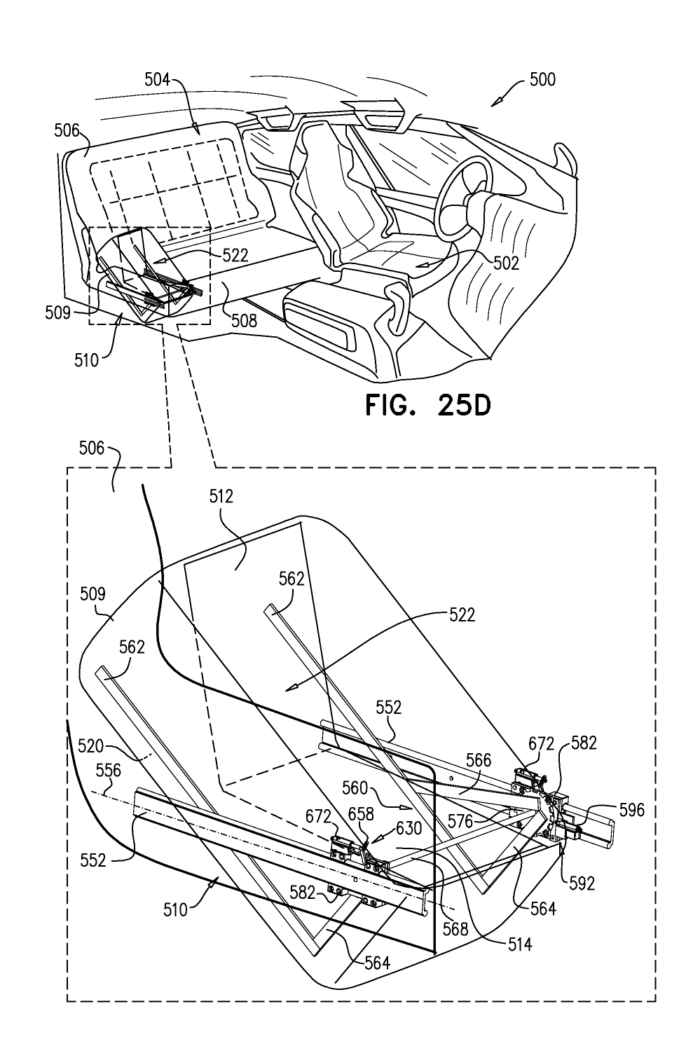

Reference is now made to FIGS. 25A, 25B, 25C and 25D, which are simplified pictorial illustrations of a vehicle including a convertible passenger seat constructed and operative in accordance with yet another embodiment of the present invention, wherein a baby seat is shown in a non-baby seat usable operative orientation, first and second intermediate operative orientations and a baby seat usable operative orientation, respectively.

As seen in FIGS. 25A-25D, there is provided a vehicle 500, such as a passenger car having passenger seats including at least one front seat 502 and at least one back seat 504. In the illustrated embodiment, at least one back seat 504 is configured as a convertible passenger seat including a back seat portion 506 and a bottom seat portion 508 having a rotatable cushion 509. In accordance with this embodiment of the present invention, the bottom seat portion 508 incorporates a baby seat assembly 510, having a baby back seat portion 512 and a baby bottom seat portion 514, both defined by rotatable cushion 509. In accordance with this embodiment of the present invention, the baby seat assembly 510 is movable from a non-baby seat usable mode, shown in FIG. 25A, in which a first surface 520 of the rotatable cushion 509 defines a non-baby seat surface, to a baby seat usable mode, shown in FIG. 25D, in which at least one second surface 522 of the rotatable cushion 509, different from the first surface 520, defines a baby seat surface including a baby back seat portion 512 and a baby bottom seat portion 514. It is appreciated that alternatively, the convertible passenger seat may be incorporated into a front seat of a vehicle.

FIGS. 25B and 25C show intermediate stages in a transformation of the convertible passenger seat from the non-baby seat usable operative orientation shown in FIG. 25A to the baby seat usable operative orientation shown in FIG. 25D.

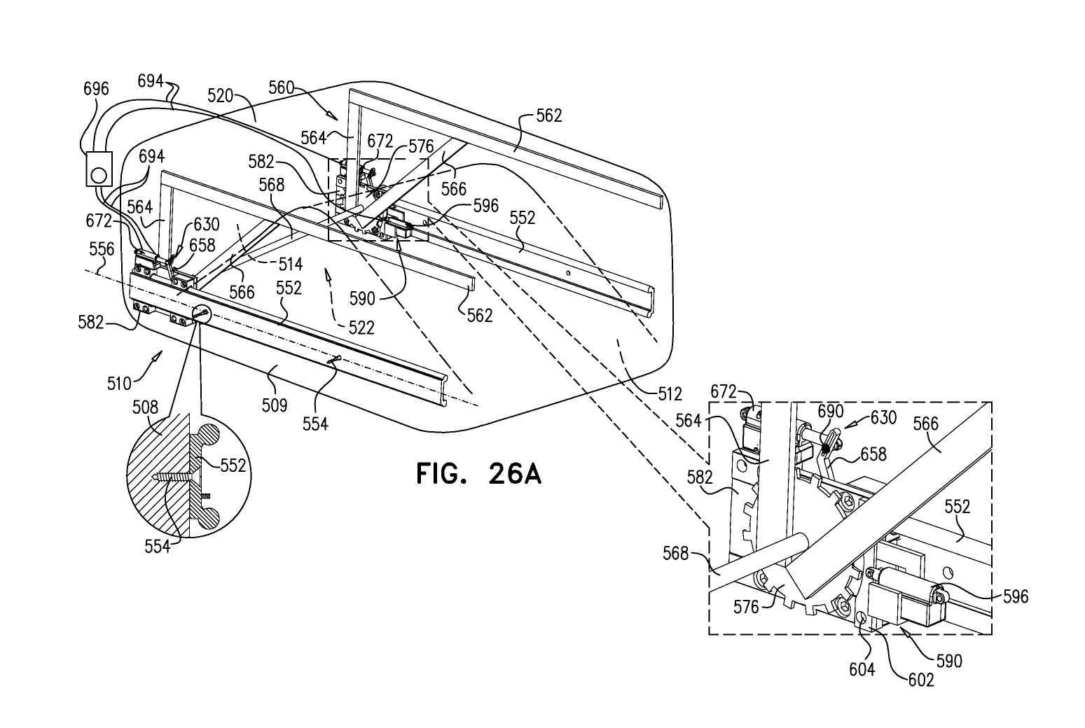

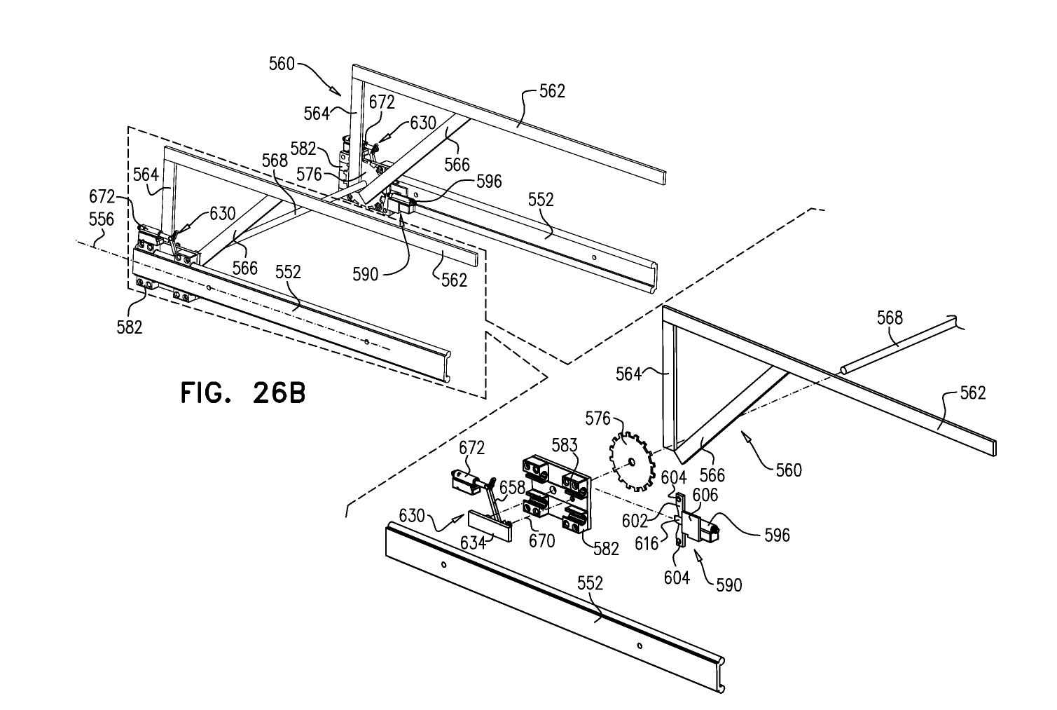

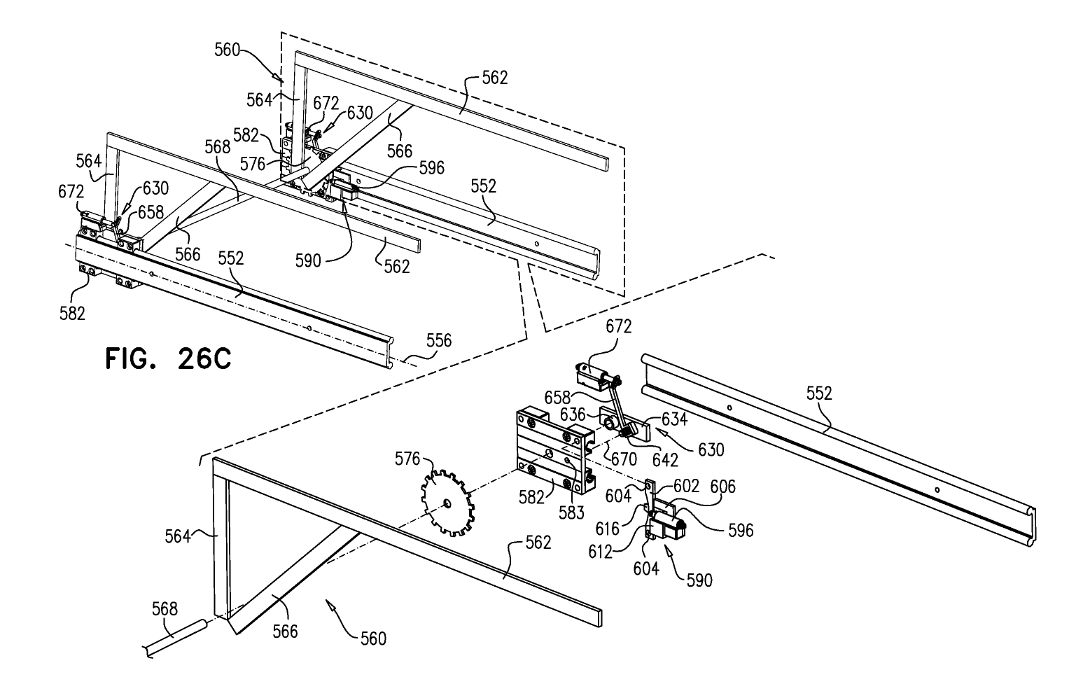

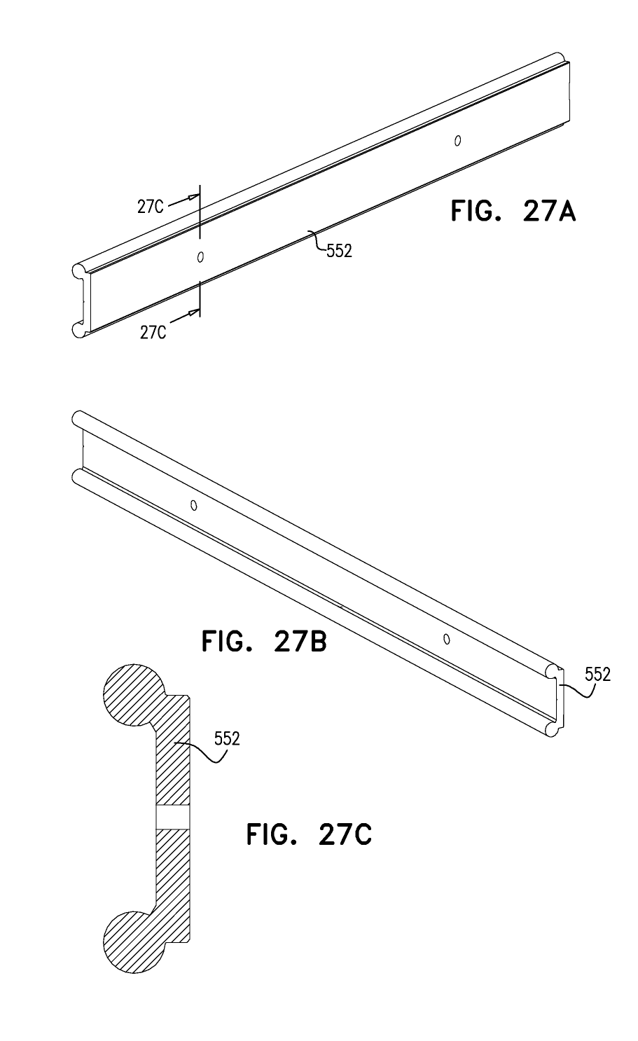

Reference is now made to FIGS. 26A, 26B and 26C, which are, respectively, a simplified assembled view and simplified partial exploded view illustrations of a convertible passenger seat constructed and operative in accordance with this embodiment of the present invention. Reference is also made to FIGS. 27A, 27B and 27C, which are, respectively, first and second simplified pictorial illustrations and a simplified sectional illustration of one of two fixed rail elements forming part of the apparatus of FIGS. 26A-26C.

As seen in FIGS. 26A-26C, the baby seat assembly 510 preferably includes a pair of generally horizontal fixed rail elements 552, shown in FIGS. 27A-27C, which are each fixed to bottom seat portion 508, as by screws 554, and extend along an axis 556. Generally horizontal fixed rail elements 552 are preferably commercially available rail elements such as a model IGUS Drylin WS10-40 commercially available from Igus Inc. of Providence, R.I., USA.

Baby seat assembly 510 also comprises a slidable and rotatable frame assembly 560, which is slidable and rotatable relative to fixed rail elements 552. Slidable and rotatable frame assembly 560 preferably comprises a pair of elongate base elements 562. An upstanding base element 564 and a diagonal base element 566 are fixedly attached to a forward portion of each elongate base element 562 and extend generally coplanar therewith. Preferably, an axle 568 extends perpendicularly to the planes of elongate base elements 562 of slidable and rotatable frame assemblies 560 and is fixedly joined to respective lockable toothed wheels 576 and thus to respective base elements 564 and 566.

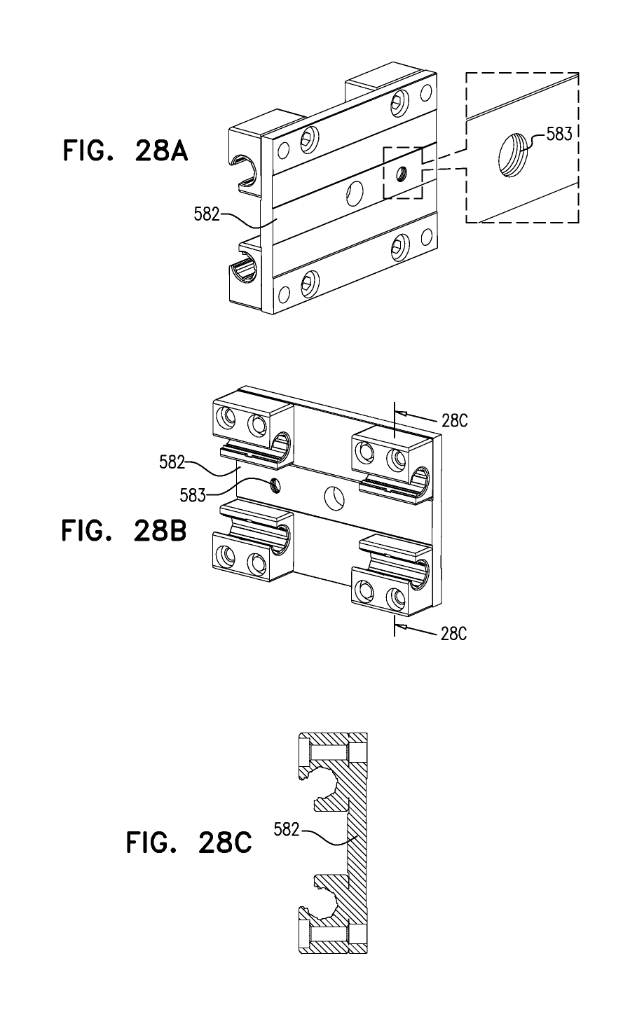

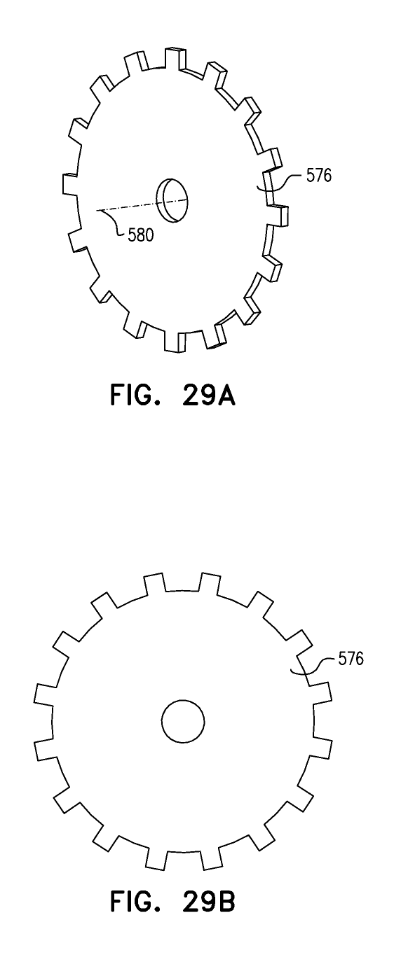

Reference is now additionally made to FIGS. 28A, 28B and 28C, which are, respectively, first and second simplified pictorial illustrations and a simplified sectional illustration of one of two rail riding elements forming part of the apparatus of FIGS. 26A-26C. Reference is also made to FIGS. 29A and 29B, which are, respectively, a simplified pictorial illustration and a simplified planar illustration of one of two lockable toothed wheels forming part of the apparatus of FIGS. 26A-26C.

By virtue of the fact that lockable toothed wheels 576, illustrated in FIGS. 29A and 29B, are fixed to axle 568 (FIG. 26A), at adjacent opposite ends thereof, the lockable toothed wheels 576 and the base elements 562, 564 and 566 translate and rotate together with axle 568. Lockable toothed wheels 576 rotate about a translatable axis 580, which is the axis of axle 568 and is fixed with respect to a pair of rail riding elements 582. The rail riding elements are based on a model IGUS Drylin WW 10-40-10, commercially available from Igus Inc. of Providence, R.I., USA and shown in FIGS. 28A-28C and modified to include a threaded aperture 583 (FIG. 28A-28B). Each rail riding element 582 is slidable along axis 556 on fixed rail element 552. Rotation of lockable toothed wheel 576 results from manual lifting of the slidable and rotatable support assembly 560 from its orientation shown in FIG. 25A to its orientation shown in FIG. 25B and further, via its orientation shown in FIG. 25C, to its baby seat usable operative orientation shown in FIG. 25D.

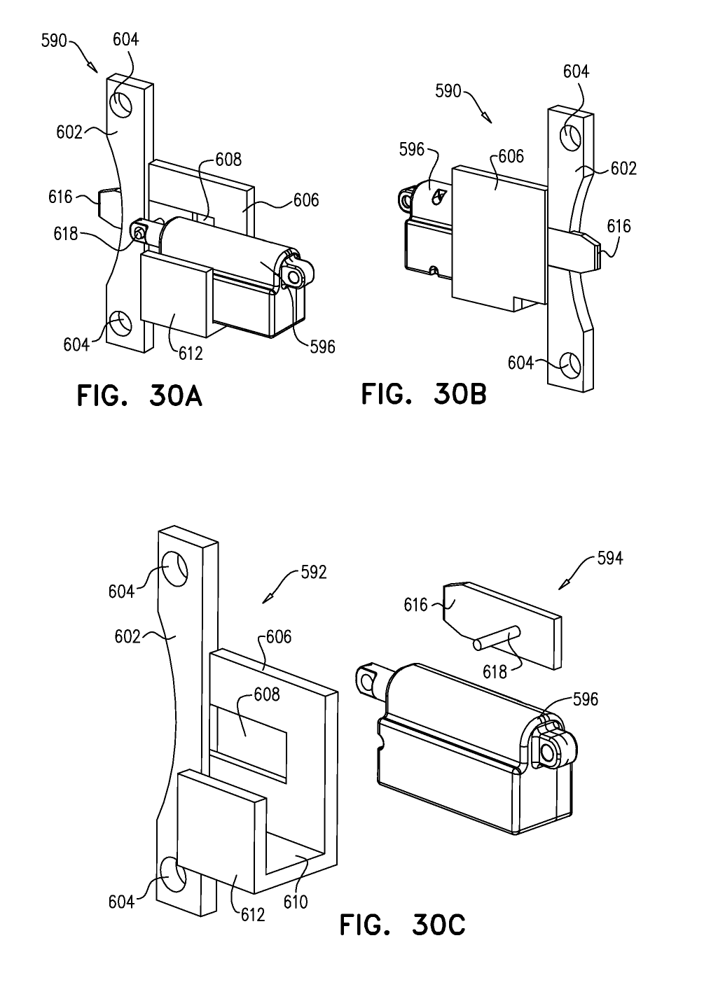

Reference is now made to FIGS. 30A, 30B and 30C, which are, respectively, a first and second simplified pictorial illustration and a simplified exploded view illustration of one of two rotation locking assemblies, forming part of the apparatus of FIGS. 26A-26C.

A rotation locking assembly 590 is preferably provided for locking engagement with each of lockable toothed wheels 576, thereby to prevent rotation of wheels 576 about axis 580 and is illustrated in FIGS. 30A-30C. Rotation locking assembly 590 preferably comprises a mounting element 592, which is fixedly mounted onto each rail riding element 582, and a slidable latch element 594 which is displaced into and out of locking engagement with teeth of a corresponding lockable toothed wheel 576 by an electrically actuable actuator 596, such as a model PQ12-P Linear Actuator commercially available from Actuonix Motion Devices Inc. of Victoria, BC, Canada. Actuator 596 normally urges slidable latch element 594 into locking engagement with lockable toothed wheel 576 and is selectably operative to draw slidable latch element 594 out of locking engagement with lockable toothed wheel 576.

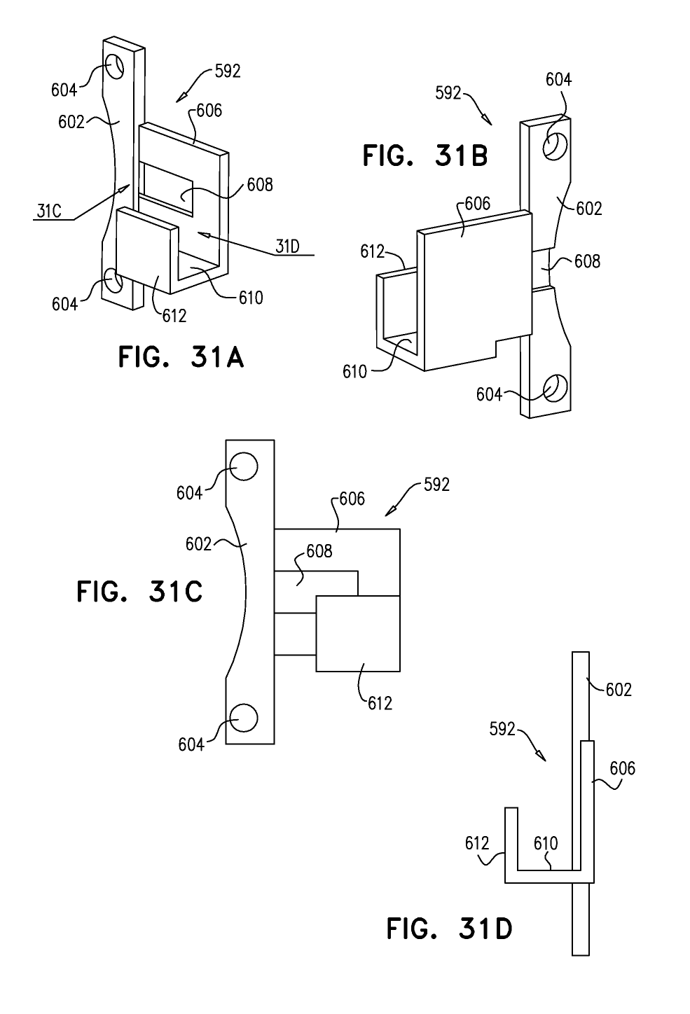

Reference is now made to FIGS. 31A, 31B, 31C and 31D, which are, respectively, first and second simplified pictorial illustrations and first and second simplified side view illustrations of mounting element 592, forming part of the rotation locking assembly of FIGS. 30A-30C. Mounting element 592 preferably is integrally formed as one piece and includes a mounting portion 602, having mounting apertures 604 for receiving screws (not shown) which fixedly attach mounting element 592 to rail riding element 582, and a planar portion 606 defining a latch sliding aperture 608. Extending perpendicularly to planar portion 606 is a planar portion 610. Perpendicular to planar portion 610, and parallel to planar portion 606, is an upwardly extending planar portion 612. Planar portions 610 and 612, together with part of planar portion 606, define a housing for actuator 596.

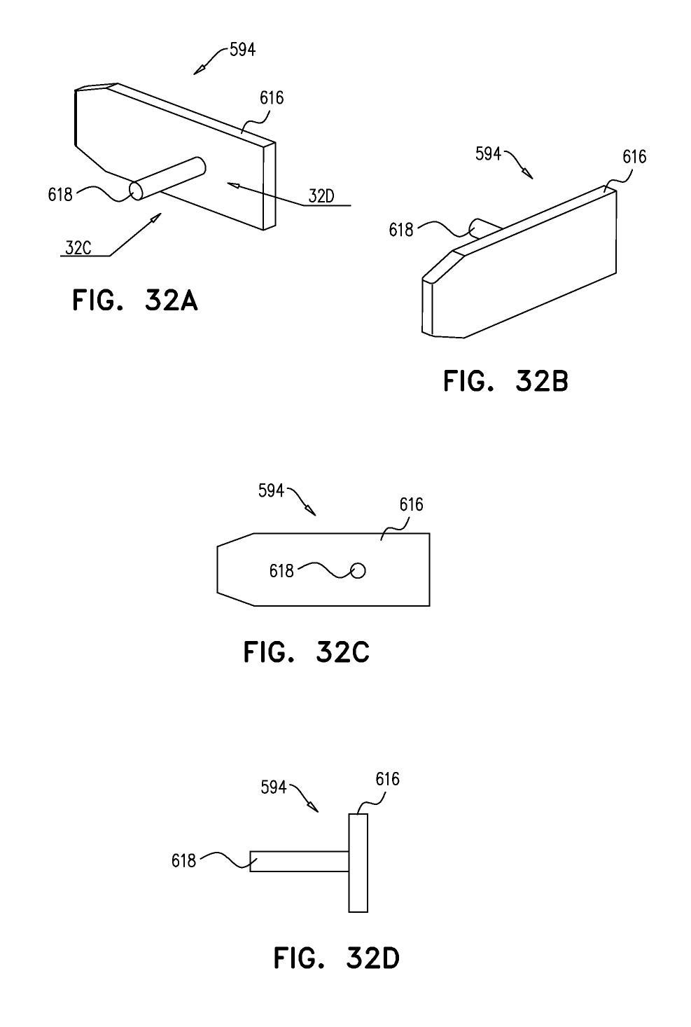

Reference is now made to FIGS. 32A, 32B, 32C and 32D, which are, respectively, first and second simplified pictorial illustrations and first and second simplified side view illustrations of slidable latch element 594, forming part of the rotation locking assembly 590 of FIGS. 30A-30C. Latch element 594 preferably is integrally formed as one piece and includes a generally planar latch portion 616 and a generally cylindrical protrusion 618 extending on one side thereof and which is connected to, and movable by, actuator 596.

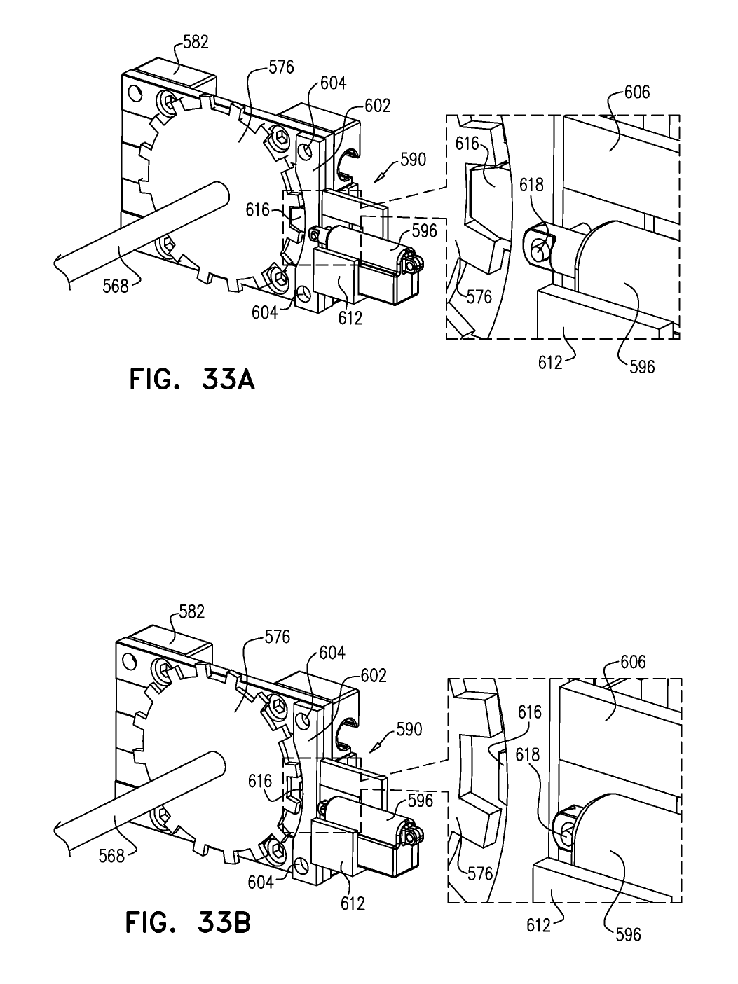

Reference is now made to FIGS. 33A and 33B, which are simplified pictorial illustrations which show rotation locking assembly 590, such as that illustrated in FIGS. 30A-30C, mounted in operative engagement with a corresponding rail riding element 582, such as that illustrated in FIGS. 28A-28C, in respective locking and non-locking engagement with a lockable toothed wheel 576, such as that illustrated in FIGS. 29A and 29B. In a locking orientation, shown in FIG. 33A, actuator 596 normally urges latch element 594 into locking engagement with lockable toothed wheel 576. In a non-locking orientation, shown in FIG. 33B, actuator 596 is selectably operative to draw latch element 594 out of locking engagement with lockable toothed wheel 576.

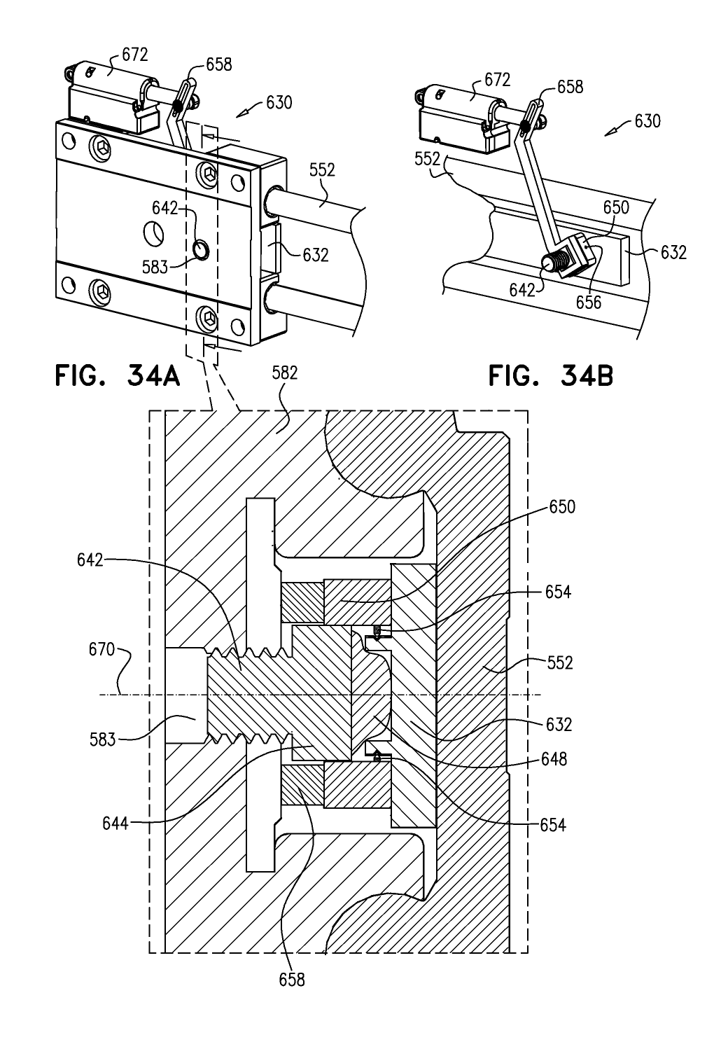

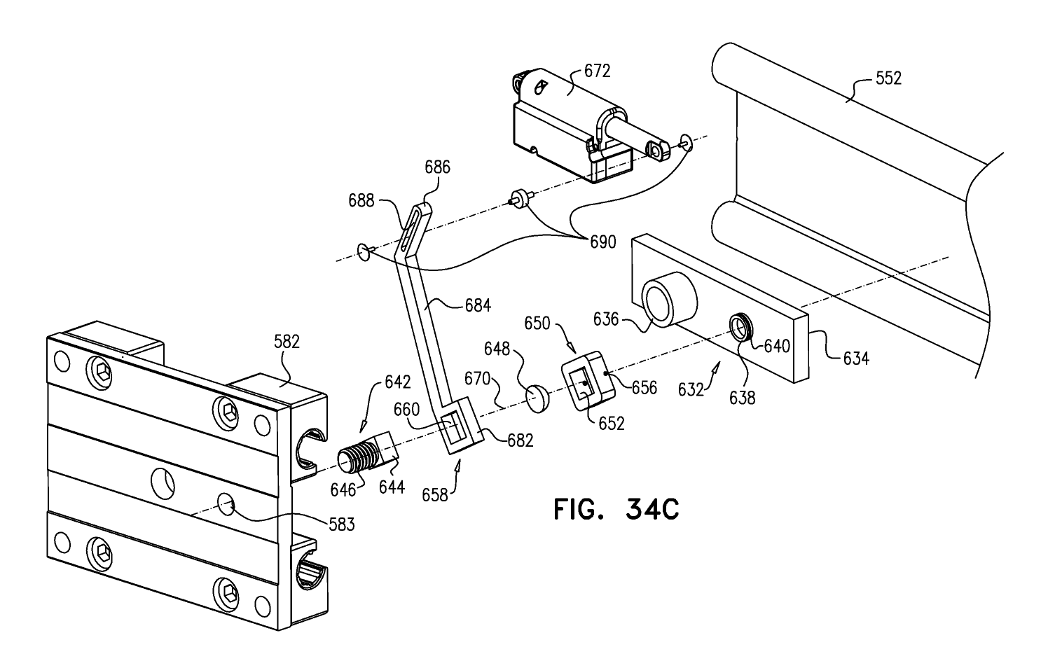

Reference is now made to FIGS. 34A-38B, which illustrate the structure and operation of a translation braking assembly 630, forming part of the apparatus of FIGS. 26A-26C. A separate translation braking assembly 630 is preferably provided for governing translation movement of each of rail riding elements 582.

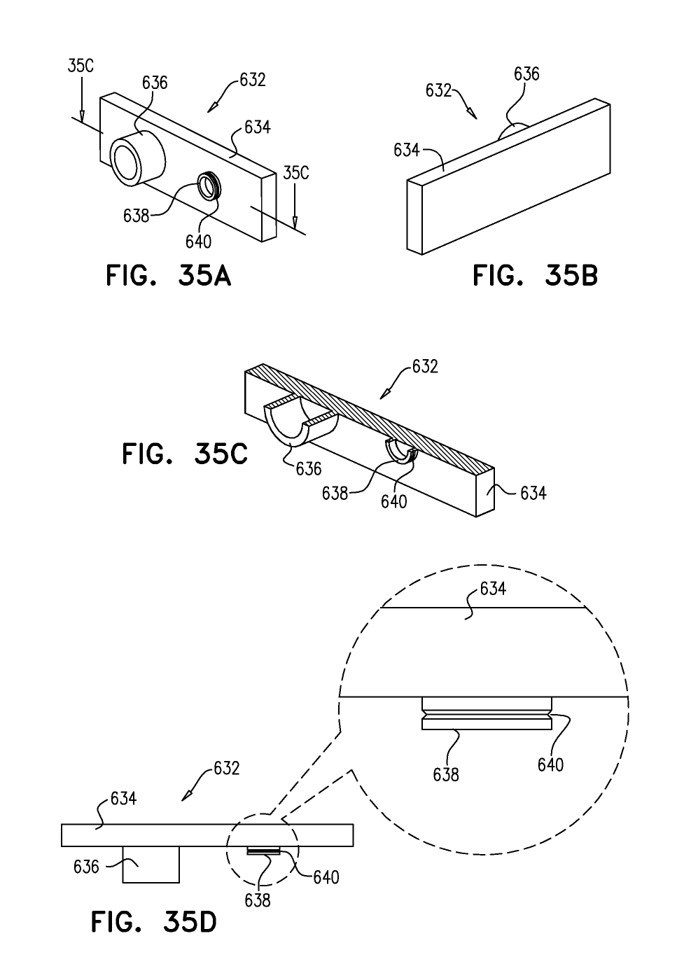

As seen in FIGS. 34A-34C, translation braking assembly 630 preferably comprises a brake pad element 632, which is illustrated particularly in FIGS. 35A-35D and is preferably integrally formed of a single piece of aluminum. Brake pad element 632 preferably includes a planar portion 634, a first generally cylindrical tube 636, preferably used to seat an end of axle 568, and a second generally cylindrical tube 638, formed with a circumferential recess 640 along an outer surface thereof.

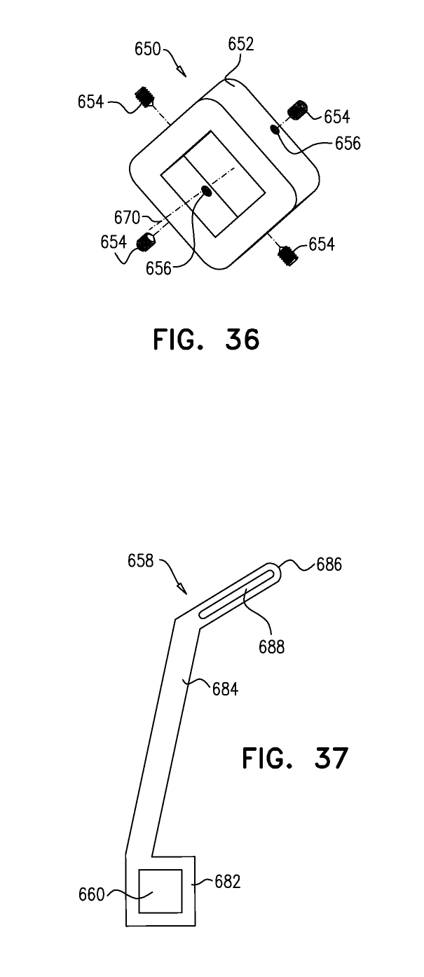

A square headed brake pad linear displacement screw element 642 having a square head 644 and a threaded elongate portion 646 engages a resilient, hemispheric ball element 648, which is seated in an hemispheric ball element housing 650, which is illustrated in FIG. 36. Housing 650 is rotatably mounted onto second generally cylindrical tube 638 of brake pad element 632 and preferably defines a square socket 652 enclosing resilient hemispheric ball element 648. Rotatable mounting of housing 650 is preferably provided by four rotatable set screws 654 which are preferably threadably mounted in corresponding threaded apertures 656 located in the sides of square socket 652. Ends of rotatable set screws 654 are rotatably seated in circumferential recess 640 of second generally cylindrical tube 638 and rotatably retain housing 650 in engagement with the brake pad element 632.

A screw rotating element 658, shown in FIG. 37, having a square socket 660 for accommodating square head 644 of screw element 642, is driven in rotational motion about an axis 670 by an actuator 672. Actuator 672 may be identical to actuator 596 (FIGS. 30A-30C) and is preferably fixed to rail riding element 582.

As seen in FIG. 37, screw rotating element 658 preferably comprises a screw element engagement portion 682 defining square socket 660 therein, which slidably engages square headed brake pad linear displacement screw element 642. Preferably integrally formed with screw element engagement portion 682 is an arm 684 which terminates in an end portion 686 having formed therein an elongate slot 688 which is coupled to actuator 672 by means of a slidable pin assembly 690.

As seen with particular clarity in a sectional enlargement of part of FIG. 34A, brake pad element 632 can be selectably displaced into and out of frictional braking engagement with fixed rail element 552 by operation of actuator 672, which rotates screw rotating element 658 about axis 670. Rotation of screw rotating element 658 about axis 670 in threaded engagement with threaded aperture 583 of rail riding element 582 produces linear displacement of square headed brake pad linear displacement screw element 642 along axis 670.

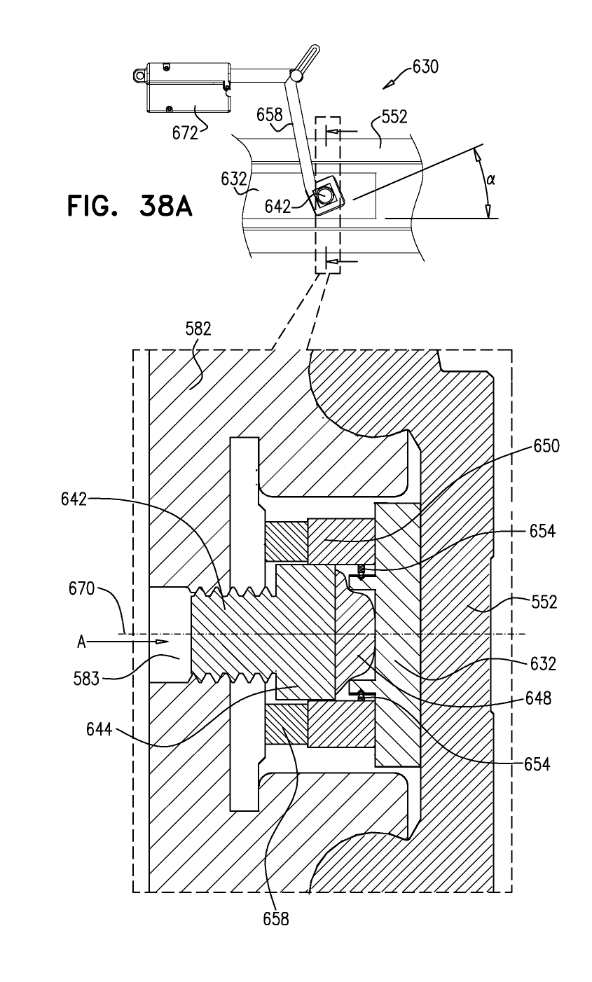

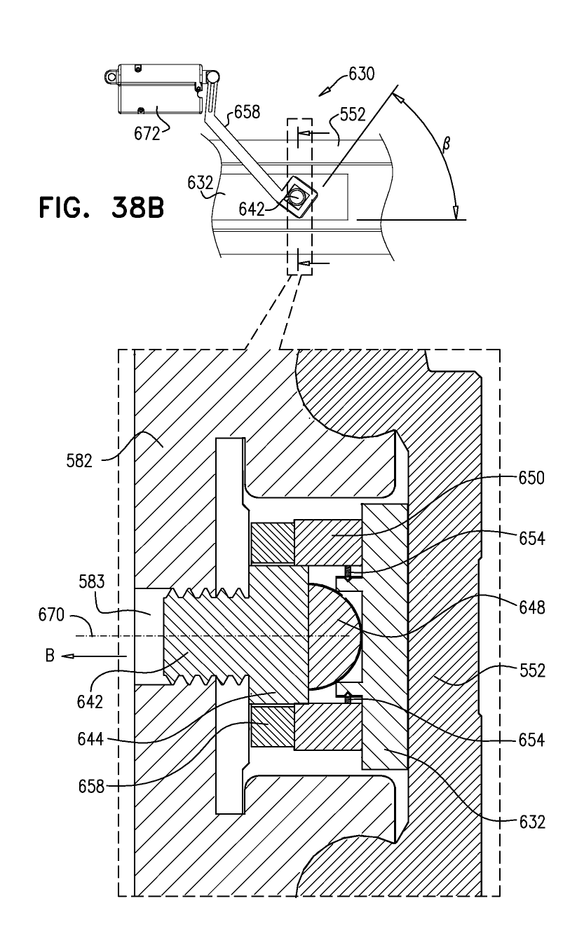

FIG. 38A shows brake pad 632 in a braking operative orientation in frictional braking engagement with fixed rail element 552. As seen clearly in FIG. 38A, the forward displacement of actuator 672 produces corresponding linear displacement of square headed brake pad linear displacement screw element 642 in a direction indicated by an arrow A along axis 670 and thus forces screw head 644 into housing 650 and into increasing compressive engagement with brake pad element 632 along axis 670, thus applying an increasing compressive force along axis 670 to resilient, hemispherical ball element 648. This increasing compressive force is transmitted by hemispherical ball element 648 axially along axis 670, urging brake pad element 632 into increasing frictional braking engagement with fixed rail element 552. As seen in FIG. 38A, in the braking operative orientation, screw element engagement portion 682 of screw rotating element 658 forms an angle α with axis 556 of fixed rail element 552.

FIG. 38B shows brake pad 632 in a non-braking operative orientation out of frictional braking engagement with fixed rail element 552. As seen clearly in FIG. 38B, the retraction displacement of actuator 672 produces corresponding linear displacement of square headed brake pad linear displacement screw element 642 in a direction indicated by an arrow B, opposite to the direction indicated by arrow A in FIG. 38A, along axis 670 and thus forces screw head 644 outwardly with respect to housing 650 and into decreasing compressive engagement with brake pad element 632 along axis 670, thus reducing or eliminating the compressive force along axis 670 applied to resilient, hemispherical ball element 648. The decrease or elimination of compressive force transmitted by hemispherical ball element 648 axially along axis 670, allows brake pad element 632 to have decreased or no frictional braking engagement with fixed rail element 552. As seen in FIG. 38B, in the non-braking operative orientation, screw element engagement portion 682 of screw rotating element 658 forms an angle β with axis 556 of fixed rail element 552.

It is a particular feature of this embodiment of the present invention that translation braking assembly 630 provides axial impact force damping functionality which protects a baby seated in the baby seat assembly in the event of an axial input produced by a front end or rear end collision.

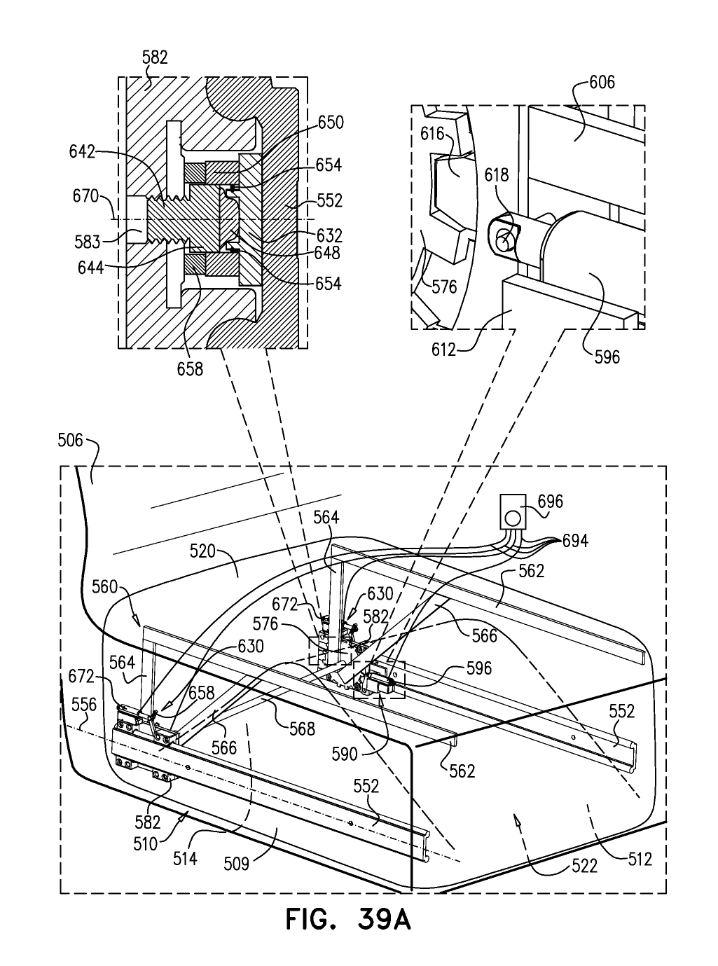

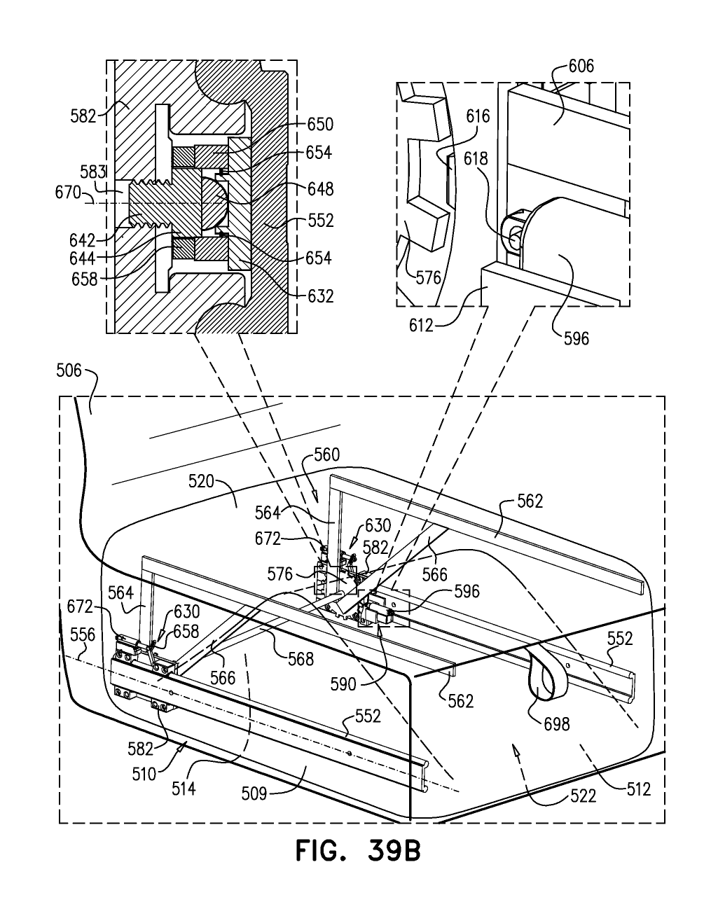

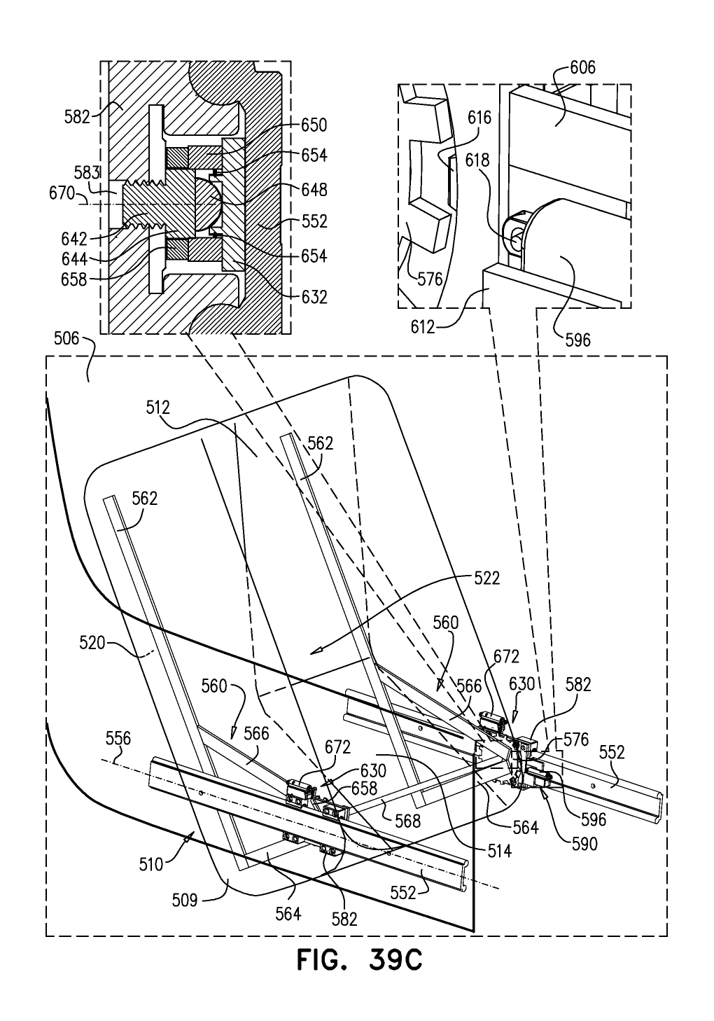

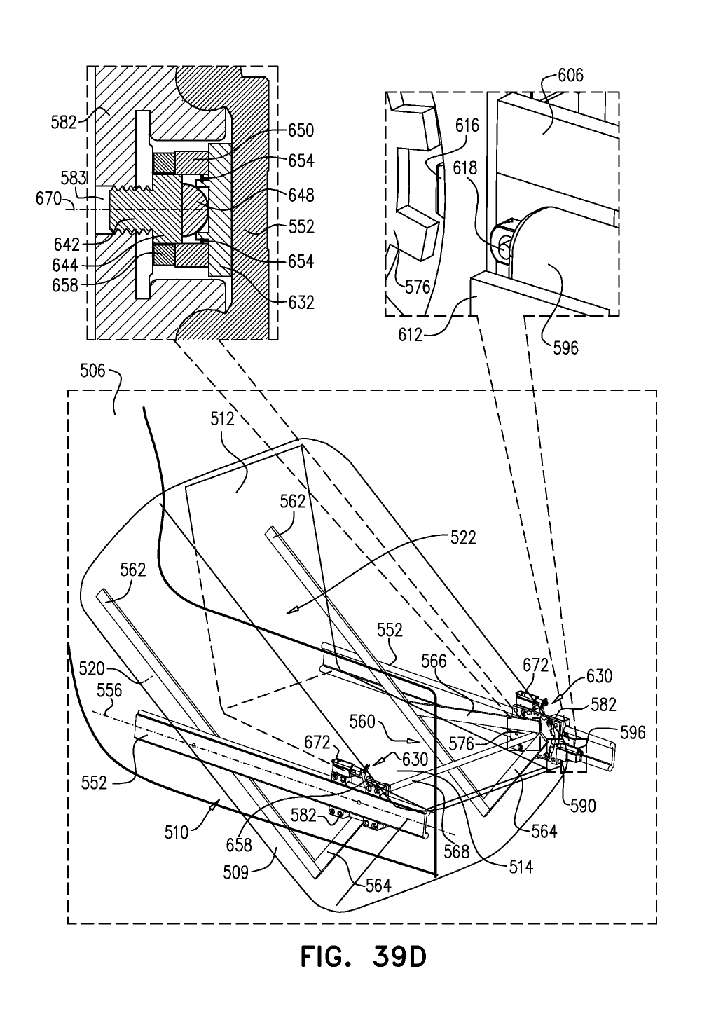

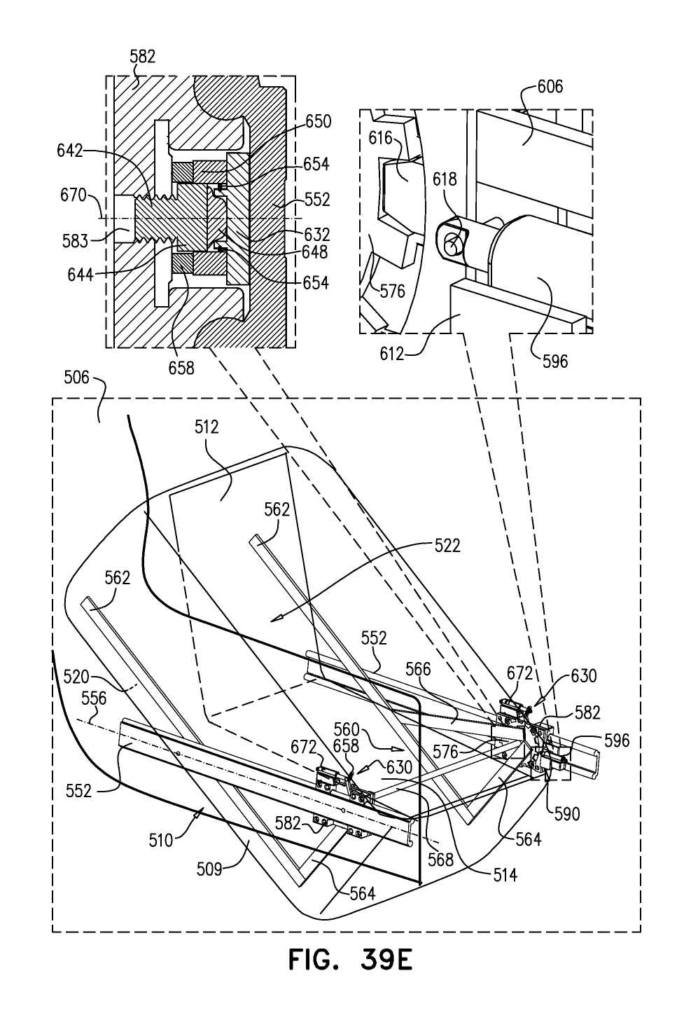

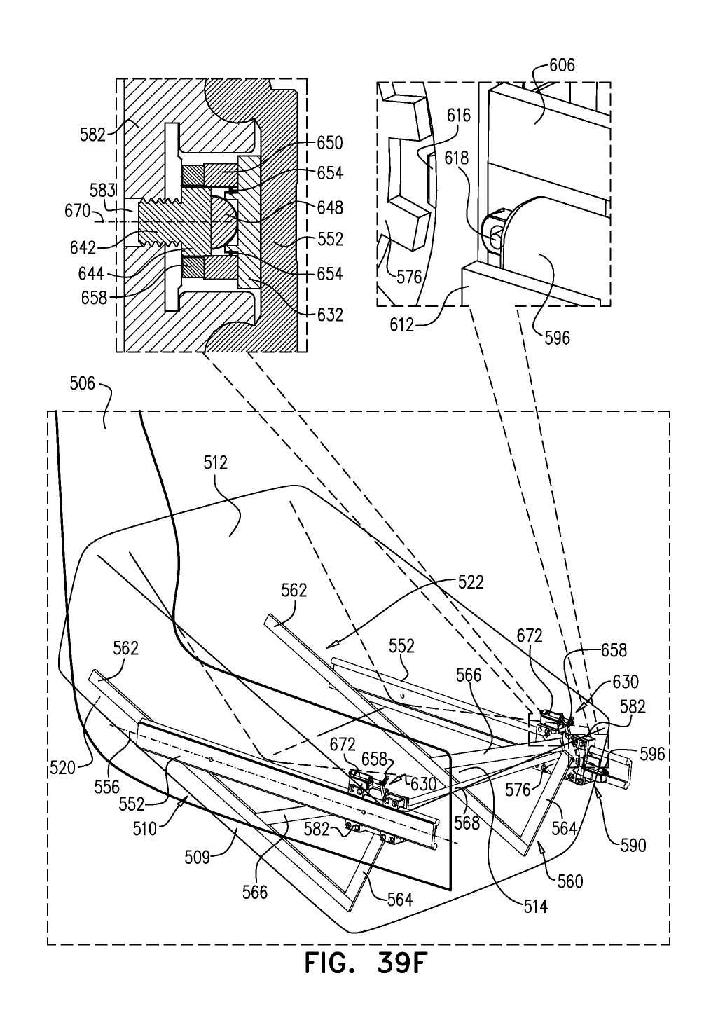

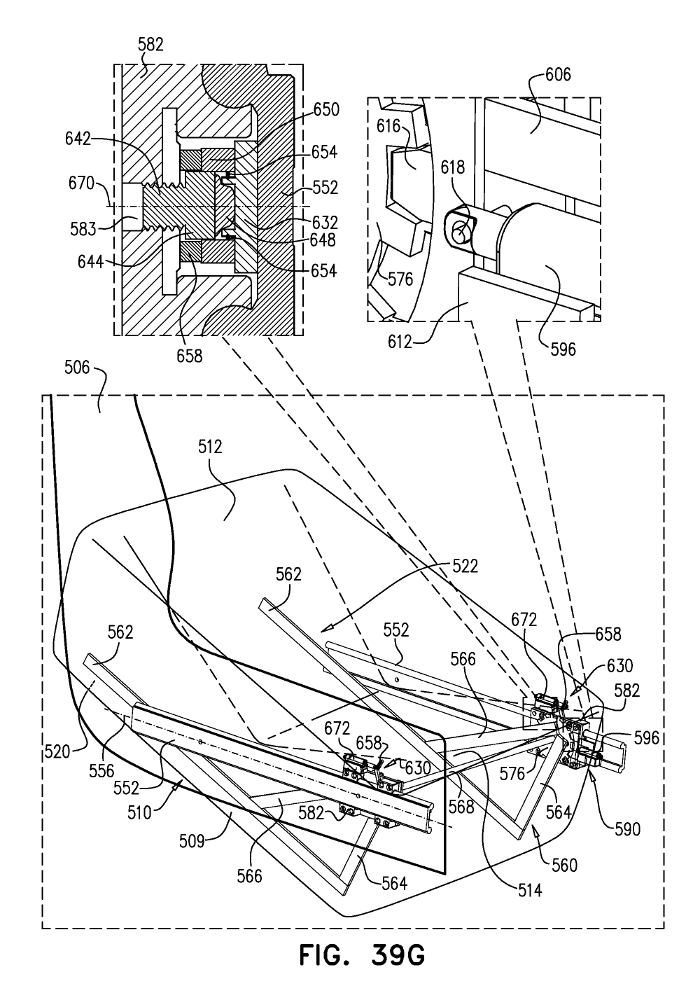

Reference is now made to FIGS. 39A, 39B, 39C, 39D, 39E, 39F and 39G, which are simplified illustrations of seven typical stages in the operation of the convertible passenger seat of FIGS. 26A-26C. FIG. 39A shows the convertible passenger seat in its non-baby seat operative orientation. Actuators 596 and 672 are connected via wires 694 to an electric ON/OFF switch 696. In this orientation, the switch is in a rotation locking and translation braking state, where actuators 596 and 672 are in their respective extended states, rotation locking assemblies 590 are in the locking orientation shown in FIG. 33A and translation braking assemblies 630 are in the braking orientation shown in FIG. 38A.

FIG. 39B shows the convertible passenger seat in its non-baby seat operative orientation, in preparation for conversion to a baby seat orientation as by a user pulling on a strap 698. In this orientation, the switch 696 is in a rotation non-locking and translation non-braking state causing actuators 596 and 672 to be in their respective retracted states, rotation locking assemblies 590 to be in the non-locking orientation shown in FIG. 33B and translation braking assemblies 630 to be in the non-braking orientation shown in FIG. 38B.

FIG. 39C shows an intermediate orientation in conversion of the convertible passenger seat from its non-baby seat operative orientation to its baby seat orientation. In this intermediate orientation, the switch 696 remains in a rotation non-locking and translation non-braking state where actuators 596 and 672 remain in their respective retracted states, rotation locking assemblies 590 remain in the non-locking orientation shown in FIG. 33B and translation braking assemblies 630 remain in the non-braking orientation shown in FIG. 38B.

FIG. 39D shows another intermediate orientation in conversion of the convertible passenger seat from its non-baby seat operative orientation to its baby seat orientation. In this intermediate orientation, the switch 696 remains in a rotation non-locking and translation non-braking state where actuators 596 and 672 remain in their respective retracted states, rotation locking assemblies 590 remain in the non-locking orientation shown in FIG. 33B and translation braking assemblies 630 remain in the non-braking orientation shown in FIG. 38B.

FIG. 39E shows the convertible passenger seat in an optional child seat orientation, which is identical to the operative orientation of FIG. 39D wherein however the switch 696 is in a rotation locking and translation braking state where actuators 596 and 672 are in their respective extended states, rotation locking assemblies 590 are in the locking orientation shown in FIG. 33A and translation braking assemblies 630 are in the braking orientation shown in FIG. 38A.

FIG. 39F shows the convertible passenger seat in an optional baby seat orientation but not yet locked against rotation or braked against displacement. In this orientation, the switch 696 remains in a rotation non-locking and translation non-braking state where actuators 596 and 672 are in their respective retracted states, rotation locking assemblies 590 remain in the non-locking orientation shown in FIG. 33B and translation braking assemblies 630 remain in the non-braking orientation shown in FIG. 38B.

FIG. 39G shows the convertible passenger seat in the optional baby seat orientation, locked against rotation and braked against displacement. In this orientation, the switch 696 is in a rotation locking and translation braking state where actuators 596 and 672 are in their respective extended states, rotation locking assemblies 590 are in the locking orientation shown in FIG. 33A and translation braking assemblies 630 are in the braking orientation shown in FIG. 38A.

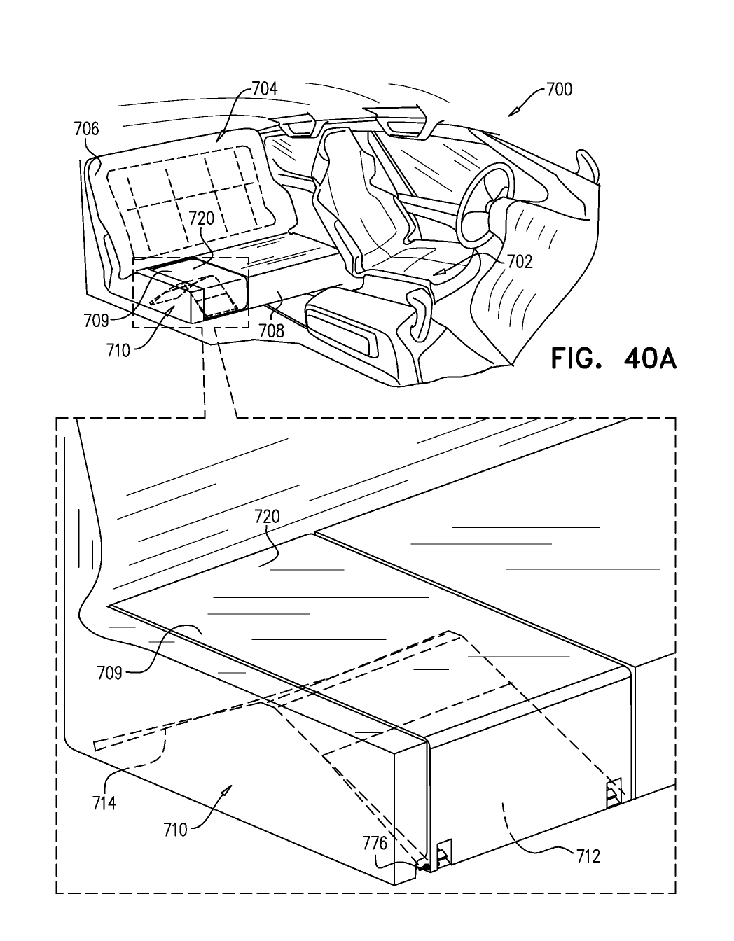

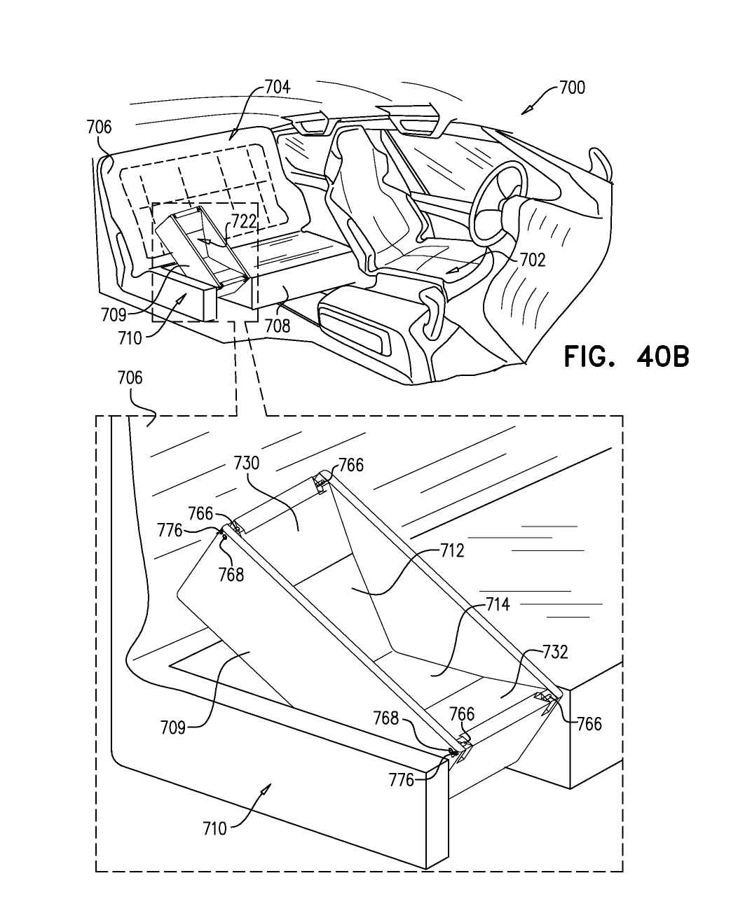

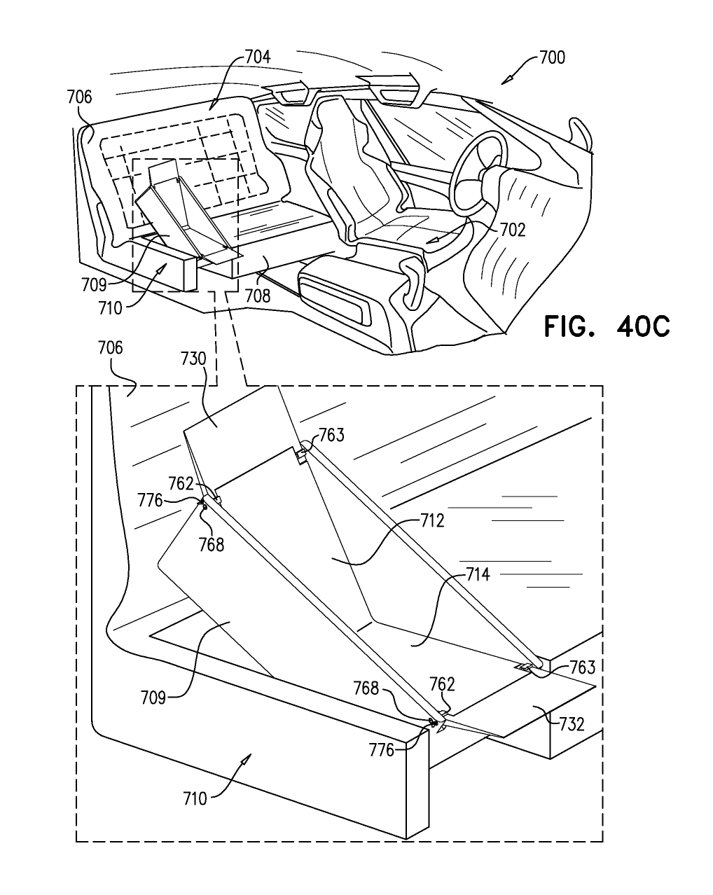

Reference is now made to FIGS. 40A, 40B and 40C, which are simplified pictorial illustrations of a vehicle including a convertible passenger seat constructed and operative in accordance with yet another preferred embodiment of the present invention having pivotable extension flaps, wherein a baby seat is shown in a non-baby seat usable operative orientation, a baby seat usable operative orientation with extension flaps not extended and a baby seat usable operative orientation with extension flaps extended.

As seen in FIGS. 40A-40C, there is provided a vehicle 700, such as a passenger car having passenger seats including at least one front seat 702 and at least one back seat 704. In the illustrated embodiment, at least one back seat 704 is configured as a convertible passenger seat including a back seat portion 706 and a bottom seat portion 708 having a rotatable cushion 709. In accordance with this embodiment of the present invention, the bottom seat portion 708 incorporates a baby seat assembly 710, having a baby back seat portion 712 and a baby bottom seat portion 714, both defined by rotatable cushion 709. In accordance with this embodiment of the present invention, the baby seat assembly 710 is movable from a non-baby seat usable mode, shown in FIG. 40A, in which a first surface 720 of the rotatable cushion 709 defines a non-baby seat surface, to a first baby seat usable mode, shown in FIG. 40B, in which at least one second surface 722 of the rotatable cushion 709, different from the first surface 720, defines a baby seat surface including a baby back seat portion 712 and a baby bottom seat portion 714. It is appreciated that alternatively, the convertible passenger seat may be incorporated into a front seat of a vehicle.

In the operative orientation of FIG. 40B, first and second extension flaps 730 and 732 are shown in their non-extended orientations. In the operative orientation shown in FIG. 40C, the first and second extension flaps 730 and 732 are shown pivoted to their extended orientations for accommodating a larger child. It is appreciated that optionally either one of extension flaps 730 and 732 may be in a non-extended operative orientation while the other one of extension flaps 730 and 732 may be in an extended operative orientation.

It is further appreciated that the baby seat assembly of any of the embodiments described hereinabove with reference to FIGS. 1A-39G may be equipped with extension flaps as described herein, in order to accommodate larger children.

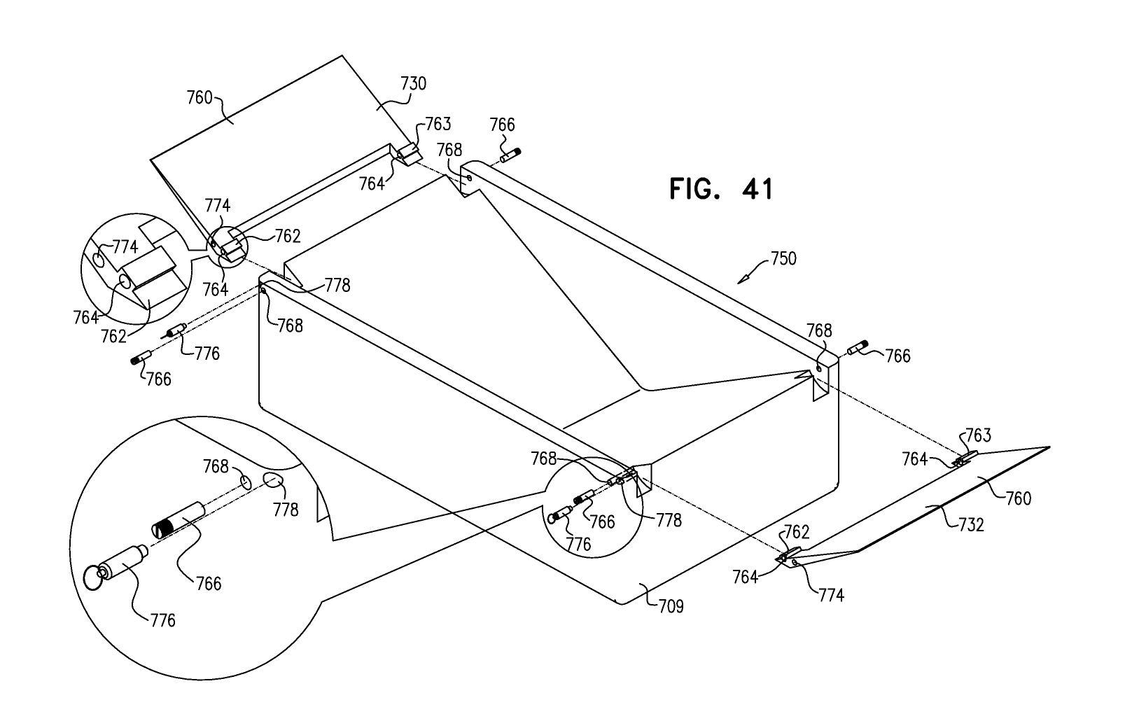

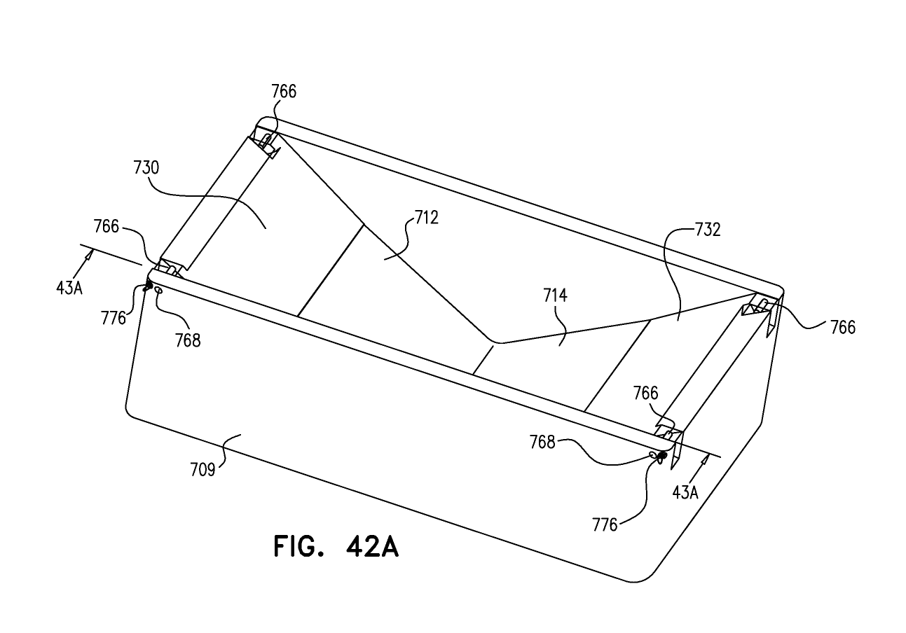

Reference is now made to FIG. 41, which is a simplified partial exploded view illustration of a rotatable cushion assembly 750 having pivotable extension flaps, forming part of the convertible passenger seat of FIGS. 40A-40C. As seen in FIG. 41, the rotatable cushion assembly 750 includes rotatable cushion 709 and preferably also includes a top extension flap 730 and a bottom extension flap 732, which are pivotably mounted onto rotatable cushion 709.

In a preferred embodiment, each of flaps 730 and 732 is formed as a main flap portion 760 integrally formed with a pair of extension protrusions 762 and 763 which are each formed with a pivot pin receiving bore 764, which pivotably receives a pivot pin 766, which extends through a corresponding pivot pin bore or socket 768 formed in an adjacent wall of rotatable cushion 709.

Preferably, in addition, extension protrusions 762 are each formed with a locking pin receiving bore 774 which slidably receives a locking pin 776, preferably a spring latch with key ring, commercially available from Spring Creek Products of San Angelo Tex. 76904, which extends through a corresponding locking bore or socket 778 formed in an adjacent wall of rotatable cushion 709.

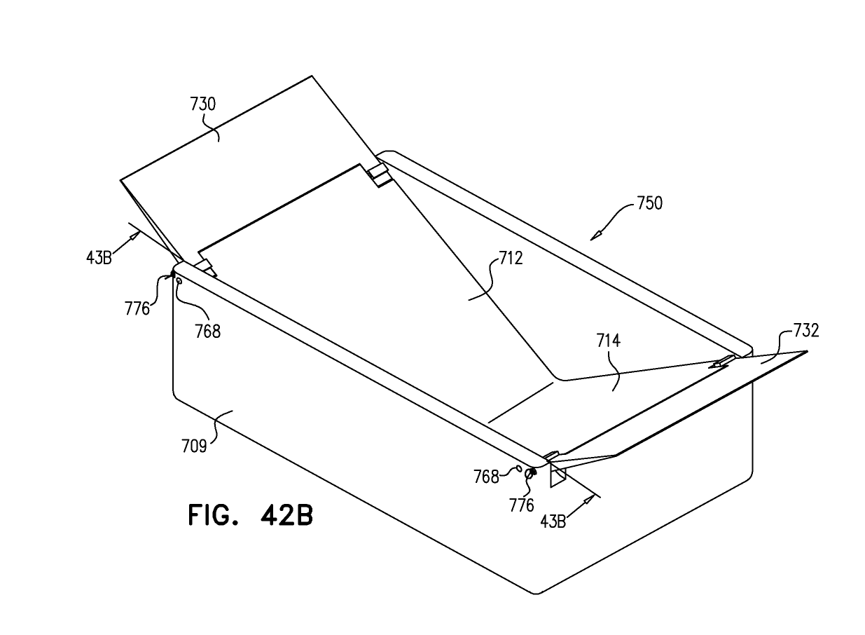

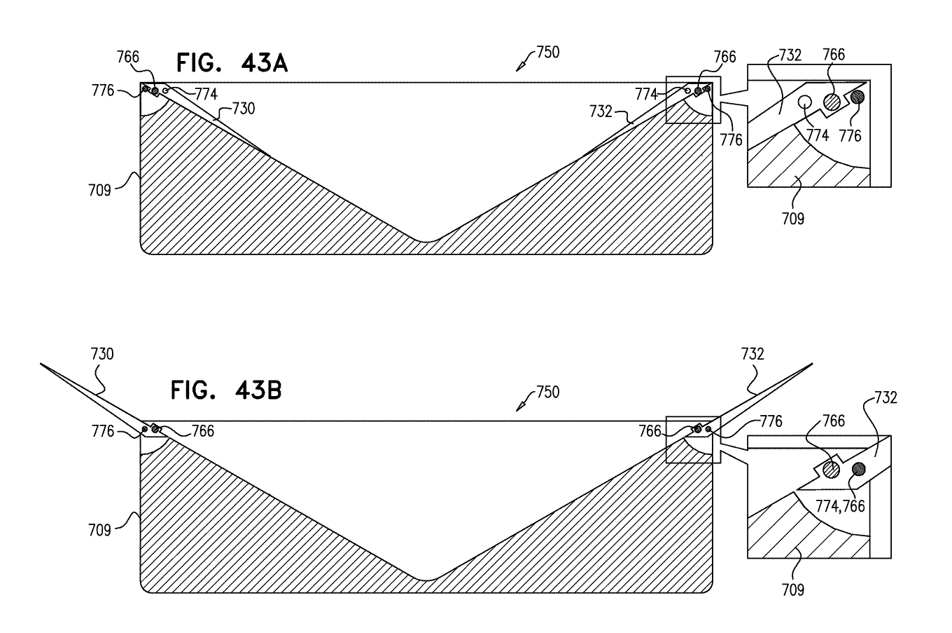

FIGS. 42A& 43A and 42B& 43B illustrate of the rotatable cushion assembly 750 in respective flap non-extended and flap extended operative orientations.

It will be appreciated by persons skilled in the art that the present invention is not limited by what has been particularly shown and described hereinabove and includes combinations and sub-combinations of the various features described and illustrated herein as well as modifications thereof which are not in the prior art.

1. A convertible passenger seat for a vehicle comprising:
a back seat portion; and
a bottom seat portion,
said bottom seat portion incorporating a baby seat assembly, said baby seat assembly having at least one baby seat support surface; and
said baby seat assembly being movable from a non-baby seat usable operative orientation, in which a first surface of said bottom seat portion defines a non baby seat surface, to a baby seat usable operative orientation in which at least one second surface of said bottom seat portion, different from said first surface, defines said at least one baby seat support surface.

2. A convertible passenger seat for a vehicle according to claim 1 and wherein said baby seat assembly is movable from said non-baby seat usable operative orientation to said baby seat usable operative orientation by at least rotation.

3. A convertible passenger seat for a vehicle according to claim 2 and wherein said baby seat assembly also comprises:
a controllable rotation locking assembly for preventing undesired rotation of said baby seat assembly from said baby seat usable operative orientation.

4. A convertible passenger seat for a vehicle according to claim 1 and wherein said baby seat assembly is movable from said non-baby seat usable operative orientation to said baby seat usable operative orientation by rotation about a rotation axis and translation perpendicular to said rotation axis.

5. A convertible passenger seat for a vehicle according to claim 4 and wherein said baby seat assembly also comprises:
a controllable translation braking assembly for preventing undesired translation of said baby seat assembly from said baby seat usable operative orientation; and
a controllable rotation locking assembly for preventing undesired rotation of said baby seat assembly from said baby seat usable operative orientation.

6. A convertible passenger seat for a vehicle according to claim 5 and also comprising a common control switch enabling a user to control the operation of both said controllable translation braking assembly and said controllable rotation locking assembly and wherein said baby seat assembly is movable from said non-baby seat usable operative orientation to said baby seat usable operative orientation by rotation about a rotation axis and translation perpendicular to said rotation axis.

7. A convertible passenger seat for a vehicle according to claim 4 and also comprising an electronically controllable actuator operative to selectably lock said baby seat assembly in said baby seat usable operative orientation.

8. A convertible passenger seat for a vehicle according to claim 1 and wherein said baby seat assembly also comprises axial impact force damping functionality.

9. A convertible passenger seat for a vehicle according to claim 8 and wherein said baby seat assembly is also movable to a child seat operative orientation, in which said at least one second surface of said bottom seat portion defines at least one child seat support surface.

10. A convertible passenger seat for a vehicle according to claim 1 and wherein said baby seat assembly comprises:
a static frame assembly including a pair of generally horizontal fixed rail elements, which are fixed to said bottom seat portion and extend along an axis; and
a slidable and rotatable frame assembly, which is slidable and rotatable relative to said pair of generally horizontal fixed rail elements.

11. A convertible passenger seat for a vehicle according to claim 10 and wherein said baby seat assembly also comprises:
a controllable rotation locking assembly for preventing undesired rotation of said baby seat assembly from said baby seat usable operative orientation, said controllable rotation locking assembly including:
a rotation-lockable toothed wheel fixedly associated with said slidable and rotatable frame assembly, such that locking thereof against rotation prevents rotation of said slidable and rotatable frame assembly.

12. A convertible passenger seat for a vehicle according to claim 10 and wherein said baby seat assembly also comprises:
a controllable translation braking assembly for preventing undesired translation of said baby seat assembly from said baby seat usable operative orientation, said controllable translation braking assembly comprising:
a toothed track fixedly associated with at least one of said generally horizontal fixed rail elements; and
a selectable braking sub-assembly fixed to said slidable and rotatable frame assembly and having associated therewith a toothed wheel, which operatively engages said toothed track and controls engagement thereof with said toothed track and thus controls translation of said slidable and rotatable frame assembly along said at least one of said generally horizontal fixed rail elements.

13. A convertible passenger seat for a vehicle according to claim 10 and wherein said baby seat assembly also comprises a controllable translation braking assembly for preventing undesired translation of said baby seat assembly from said baby seat usable operative orientation, said controllable translation braking assembly comprising:
a selectable braking sub-assembly fixed to said slidable and rotatable frame assembly and having associated therewith at least one brake pad, which selectably and operatively engages at least one of said pair of generally horizontal fixed rail elements thus controls translation of said slidable and rotatable frame assembly along said at least one of said pair of generally horizontal fixed rail elements.

14. A convertible passenger seat for a vehicle according to claim 1 and wherein said baby seat assembly is selectably lockable in said baby seat usable operative orientation.

15. A convertible passenger seat for a vehicle according to claim 1 and wherein said baby seat assembly comprises:
a static frame assembly including a pair of generally horizontal fixed rail elements, which are fixed to said bottom seat portion and extend along an axis; and
a rotatable support assembly, which is rotatable relative to said pair of generally horizontal fixed rail elements.

16. A convertible passenger seat for a vehicle according to claim 15 and wherein said baby seat assembly also comprises a controllable rotation locking assembly including a rotation-lockable toothed wheel fixedly associated with said static frame assembly, such that locking thereof against rotation prevents rotation of said rotatable support assembly.

17. A convertible passenger seat for a vehicle according to claim 1 and wherein said baby seat assembly is also movable to a child seat operative orientation, in which said at least one second surface of said bottom seat portion defines at least one child seat support surface.

18. A convertible passenger seat for a vehicle according to claim 1 and wherein said baby seat assembly includes at least one extension flap for selectably providing at least one extended child seat support surface.

19. A convertible passenger seat for a vehicle according to claim 18 and wherein said baby seat assembly includes a pair of pivotable extension flaps for selectably providing an extended child back seat portion and an extended child bottom seat portion.

20. A convertible passenger seat for a vehicle according to claim 18 and wherein said at least one extension flap is selectably lockable in at least one of a flap extended operative orientation and a flap non-extended operative orientation.
